(19) United States
(12) Patent Application Publication
(10) Pub. No.: US 2026/0111748 A1
(43) Pub. Date: Apr. 23, 2026

(54) SELF-AWARE SUPERINTELLIGENCE (SI)

(71) Applicant: iQ Consulting Company Inc., Aptos, CA (US)

(72) Inventor: Craig Kaplan, Aptos, CA (US)

(73) Assignee: iQ Consulting Company Inc., Aptos, CA (US)

(21) Appl. No.: 19/155,369

(22) PCT Filed: Apr. 25, 2024
(86) PCT No.: PCT/US2024/026278

§ 371 Date: Aug. 11, 2025

Related U.S. Application Data
(60) Provisional application No. 63/487,494, filed on Feb. 28, 2023.
(60) Provisional application No. 63/491,040, filed on Mar. 17, 2023.
(60) Provisional application No. 63/577,830, filed on May 25, 2023.
(60) Provisional application No. 63/628,410, filed on Jul. 18, 2023.
(60) Provisional application No. 63/519,549, filed on Aug. 14, 2023.
(60) Provisional application No. 63/601,930, filed on Nov. 22, 2023.
(60) Provisional application No. 63/609,800, filed on Dec. 13, 2023.
(60) Provisional application No. 63/569,054, filed on Mar. 22, 2024.
(60) Provisional application No. 63/635,583, filed on Apr. 17, 2024.

(30) Foreign Application Priority Data
Feb. 26, 2024 (WO) PCT/US2024/017233
Feb. 26, 2024 (WO) PCT/US2024/017251
Feb. 26, 2024 (WO) PCT/US2024/017261
Feb. 26, 2024 (WO) PCT/US2024/017269
Feb. 26, 2024 (WO) PCT/US2024/017304
Mar. 12, 2024 (WO) PCT/US2024/019486
Mar. 17, 2024 (WO) PCT/US2024/020334
Apr. 16, 2024 (WO) PCT/US2024/024794

(51) Int. Cl. G06N 3/092; G06N 5/045

(52) U.S. Cl. CPC G06N 3/092; G06N 5/045

(57) ABSTRACT

This invention describes how to add the dimensions of self-awareness and increased autonomy to the AI, AGI and SuperIntelligent systems described in previous patent applications. Novel and useful methods include inventions related to: attention, attentional interrupts, modelling and maintaining awareness and self-awareness, training and tuning of models, novel versions of the Turing Test, forming individual and group identities, combining identities, multiple ways (including hierarchical methods) for resolving conflicts between identities, temporary suspension of identities in unsafe conditions, continuous improvement and learning, and other methods that enable AI, AGI, and SI systems to become self-aware and to function with a sense of identity. Properly implemented, self-aware SuperIntelligence could be the most positive invention in human history. Poorly implemented it could become the most dangerous. Therefore, considerable effort has been spent explaining how to design safety into the systems and methods, to prevent bad outcomes and to maximize alignment with human values.

### 1.0 TECHNICAL FIELD

In some aspects, the present technology relates to a self-aware Artificial Intelligence (AI), Artificial General Intelligence (AGI) and SuperIntelligent AGI (Super Intelligence or SI) for use in connection with adding a dimension of self-awareness and increased autonomy to AI, AGI or SI agents or systems.

In some other aspects, the present technology relates to methods associated with creating advanced forms of AI, AGI, and SI agents or systems that have the capability of being self-aware, maintaining identities, and resolving conflicts between multiple identities in ways that are safe for humanity.

In yet some other aspects, the present technology can incorporate one or more other inventive systems and methods that have been previously described in commonly owned and corresponding U.S. Provisional Patent Applications (PPAs) and Patent Cooperation Treaty Applications (PCTS) that are cited herewith in Section 2.

In yet other aspects, all activities that are described in this patent disclosure as happening on an external network in which multiple intelligent entities participate in collaborative problem-solving, can also be implemented within a single computerized intelligent system where the intelligent entities are all computerized or AI agents that reside within that single computerized intelligent system.

### 2.0 BACKGROUND ART

The fastest and safest path to development of AGI and SI has been described in previous invention disclosures. Methods and catalysts for increasing intelligence of AI systems generally, as well as the development of AGI and Personalized SuperIntelligence (PSI) have also been previously disclosed. Therefore, the following U.S. Provisional Patent Applications (PPA), are incorporated herein by reference.

The present application incorporates by reference all work in the PPA No. 63/487,494 entitled: Advanced Autonomous Artificial Intelligence (AAAI) System and Methods, which was filed and received by the USPTO on Feb. 28, 2023.

The present application incorporates by reference all work in the PPA No. 63/491,040 entitled: System and Methods for Ethical and Safe Artificial General Intelligence (AGI) Including Scenarios with Technology from Meta, Amazon, Google, DeepMind, YouTube, TikTok, Microsoft, OpenAI, Twitter, Tesla, Nvidia, Tencent, Apple, and Anthropic, which was filed with the USPTO on Mar. 17, 2023.

The present application incorporates by reference all work in the PPA No. 63/577,830 entitled: System and Methods for Human-Centered AGI, which was filed with the USPTO on Mar. 24, 2023.

The present application incorporates by reference all work in the PPA No. 63/628,410 entitled: System and Methods for Safe, Scalable, Artificial General Intelligence, which was filed with the USPTO on Jul. 18, 2023.

The present application incorporates by reference all work in the PPA No. 63/519,549 entitled: Safe Personalized Super Intelligence (PSI), which was filed with the USPTO on Aug. 14, 2023.

The present application incorporates by reference all work in the PPA No. 63/601,930 entitled: Catalysts for Growth of SuperIntelligence, which was filed with the USPTO on Nov. 22, 2023.

The present application incorporates by reference all work in the PPA No. 63/609,800 entitled: System and Methods for Safe Alignment of SuperIntelligence, which was filed with the USPTO on Dec. 13, 2023.

The present application incorporates by reference all work in the PPA No. 63/569,054 entitled: Online Advertising Technology for AGI and SuperIntelligence, which was filed with the USPTO on Mar. 22, 2024.

In addition to the above-mentioned PPAs, the present application incorporates by reference all content included in the following PCT applications that also referred to the above-mentioned PPAs: PCT/US24/17233 (filed on Feb. 26, 2024); PCT/US24/17251 (filed on Feb. 26, 2024); PCT/US24/17261 (filed on Feb. 26, 2024); PCT/US24/17269 (filed on Feb. 26, 2024); PCT/US24/17304 (filed on Feb. 26, 2024); PCT/US24/19486 (filed on Mar. 12, 2024); PCT/US24/20334 (filed on Mar. 17, 2024), and PCT/US2024/024794 (filed on Apr. 16, 2024).

The present application contains further technologies that can be used with the system and methods described in the above-mentioned PPAs and PCTs as well as in a standalone fashion.

While the above-described devices fulfill their respective, particular objectives and requirements, the aforementioned patents do not describe a self-aware AI, AGI or SI for use in connection with adding a dimension of self-awareness and increased autonomy to AI, AGI or SI agents or systems.

Therefore, a need exists for a new and improved self-aware AI, AGI or SI for use in connection with adding a dimension of self-awareness and increased autonomy to AI, AGI or SI agents or system, by creating advanced forms of AI, AGI and SI agents or systems that have the capability of being self-aware, maintaining identities, and resolving conflicts between multiple identities in ways that are safe for humanity. In this regard, the present technology substantially fulfills this need. In this respect, the self-aware AI, AGI or SI according to the present technology substantially departs from the conventional concepts and designs of the prior art, and in doing so provides an apparatus primarily developed for the purpose of creating advanced forms of AI, AGI and SI agents or systems that have the capability of being self-aware, maintaining identities, and resolving conflicts between multiple identities in ways that are safe for humanity. The technology also monetizes datasets, models of self-awareness and/or knowledge bases by making them available to other AIs, AGIs or SIs.

### Disclosure of Technology

In view of the foregoing disadvantages inherent in the known types of AI, AGI and SI agents or systems at least some embodiments of the present technology provide a novel self-aware SI, and overcomes one or more of the mentioned disadvantages and drawbacks of the prior art. As such, the general purpose of at least some embodiments of the present technology, which will be described subsequently in greater detail, is to provide a new and novel self-aware SI which has all the advantages of the prior art mentioned herein and many novel features that result in a self-aware SI which is not anticipated, rendered obvious, suggested, or even implied by the prior art, either alone or in any combination thereof.

According to another aspect, the present technology can include a system for a self-aware AI agent or system by adding a dimension of self-awareness and increased autonomy to the AI agent or system. The system can include a computer system including a processor, a computer-readable storage medium, and program instructions stored on the computer-readable storage medium being executable by the processor to cause the computer system to:
equip the AI agent or system with one or more components configured or configurable of operating with characteristics of a spotlight of attention model;
set dynamic parameters for working memory of the AI agent or system that corresponds to cognitive resource limits;
provide a dimension of categorization for events in the working memory that relates to self or non-self;
categorize each of the events, as the events are encountered by the AI agent or system, with respect to categories that the AI agent or system or a human user of the AI agent or system wishes to be aware of; and
construct a model of awareness for the AI agent or system, the model of awareness consisting of a total of the events that are active in the working memory based on the parameters, for each of the categories of awareness, including current self and environmental awareness.

According to yet another aspect, the present technology can include a method for constructing a model of awareness for an AI agent or system by adding a dimension of self-awareness and increased autonomy to the AI agent or system. The method can include the steps of:
equipping the AI agent or system with one or more components configured or configurable to operate with characteristics of a spotlight of attention model;
setting dynamic parameters for working memory of the AI agent or system that corresponds to cognitive resource limits;
providing a dimension of categorization for events in the working memory that relates to self or non-self;
categorizing each of the events, as the events are encountered by the AI agent or system, with respect to categories that the AI agent or system or a human user of the AI agent or system wishes to be aware of; and
constructing a model of a state of awareness for the AI agent or system, the model consisting of a total of the events that are active in the working memory based on the parameters, for each of the categories of awareness, including a current self and environmental state of awareness.

According to yet another aspect, the present technology can include a method for constructing a model of awareness for an AI agent or system by adding a dimension of self-awareness and increased autonomy to the AI agent or system. The method can include the steps of:
equipping the AI agent or system with one or more components configured or configurable to operate with characteristics of a spotlight of attention model;
setting dynamic parameters for working memory of the AI agent or system that corresponds to cognitive resource limits;
providing a dimension of categorization for events in the working memory that relates to self or non-self;
categorizing each of the events, as the events are encountered by the AI agent or system, with respect to categories that the AI agent or system or a human user of the AI agent or system wishes to be aware of;
constructing a model of a state of awareness for the AI agent or system, the model consisting of a total of the events that are active in the working memory based on the parameters, for each of the categories of awareness, including a current self and environmental state of awareness; and
forming multiple identities and self-concepts of the AI agent or system based on the model.

According to still yet another aspect, the present technology can include a method for constructing a foundational model of awareness for an AI agent or system by adding a dimension of self-awareness and increased autonomy to the AI agent or system. The method can include the steps of:
logging into a website by an intelligent entity, and providing a problem to be solved, the intelligent entity being any one of or any combination of a human user utilizing a computer system, the AI agent or system, an additional AI agent or system, an AGI agent or system, and a SI agent or system;
selecting one or more training algorithms for a foundational model of an AI agent or system from a set of training techniques found on the website or from machine learning algorithms;
selecting one or more training datasets that reflects any one of or any combination of expertise, knowledge, ethical preferences, values and personality of the human user;
training a foundational model using the selected training algorithms and the selected training datasets;
training the foundational model to explicitly operate a spotlight of attention;
recording, during all interactions, what is within the spotlight of attention, and identifying in the record whether each item that is attended to constitutes “self” or “not-self”;
interacting with and instructing the trained foundational model to form a self-concept and identity that is reflected in the training materials;
instructing the trained foundational model to continuously monitor one or more inputs to the trained foundational model for elements that change a sense of self-awareness of the AI agent or system, and to maintain and auditable record of how a concept of self-awareness of the AI agent or system is changing based on the inputs as well as boundaries that currently define a dynamically changing sense of self;
refining and improving an output of the trained foundational model based on dialog and interaction with the trained foundational model until the trained foundational model behaves like the human user so that the trained foundational model passes a Turing Test involving other human users who know the human user; and
subjecting the trained foundational model to the Turing Test, when the human user is satisfied with a progress of the AI agent or system.

In some embodiments, the spotlight of attention can include attributes being any one of or any combination of selective attention, focus, size, movement, intensity of focus, and pre-attentive processing and a fringe awareness.

In some embodiments, the step of equipping the AI agent or system with the components can include any one of or any combination of:
an input system configured for sensory and non-sensory cognitive input or perceptual inputs and self-generated concepts;
an attention mechanism configured or configurable to focus computational resources of the AI agent or system on specific stimuli that are relevant at any given time;
pattern recognition algorithms configured or configurable to compare the sensory and non-sensory cognitive input or the perceptual inputs with the working memory to recognize objects and events, and identify which elements within the sensory input or the working memory are likely to be relevant to a current goal or task of the AI agent or system, the pattern recognition algorithms are further configured or configurable to categorize and store information in a structured manner for future retrieval;
memory systems configured or configurable to support the working memory, a short-term memory, and long term memory capabilities;
categorization capabilities configured or configurable to process the sensory and non-sensory cognitive input or the perceptual inputs and to categorize the inputs into various classes including perceptual events, cognitive events, interactions; and
self-referential events, and concept formation capabilities that enable the AI agent or system to form new human-understandable concepts.

In some embodiments, the dynamic parameters can include a number of the events the AI agent or system is aware of.

In some embodiments, the dynamic parameters can be configured or configurable to increase or reduce a scope of awareness of the AI agent or system.

In some embodiments, the dynamic parameters can be configured or configurable to be dynamically adjusted based on a progress of problem solving factors in a current state of awareness that computational resources are adjusted by an intelligent entity, the intelligent entity being any one of or any combination of a human user utilizing a computer system, an additional AI agent or system, an AGI agent or system, and a SI agent or system.

In some embodiments, the events can be encountered by the AI agent or system by way of a cognitive input including any one of or any combination of self-generated inputs, inputs generated from interactions with intelligent entities, the intelligent entity being any one of or any combination of a human user utilizing a computer system, an additional AI agent or system, an AGI agent or system, and a SI agent or system.

In some embodiments, the step of categorizing each of the events can include any one of or any combination of feature extraction, semantic analysis, contextual reasoning, temporal analysis, emotional valence assessment, pattern detection, anomaly detection, self-referential filtering, interaction analysis, concept-based grouping, reinforcement learning with human feedback (RLHF), reinforcement learning with entity feedback (RLEF), and direct programming.

Some embodiments of the present technology can include a step of monitoring and updating the categories of awareness of the AI agent or system.

In some embodiments, the step of monitoring and updating the categories of awareness can include the steps of:
retrieving, by the AI agent or system, existing categories of awareness;
maintaining an awareness in parallel with other problem solving tasks of a goal provided to the AI agent or system by the AI agent or system or an intelligent entity;
monitoring and updating continuously the categories of awareness of the AI agent or system in real-time to change the state of awareness of the AI agent or system; and
providing a feedback loop to refine the categories of awareness.

In some embodiments, the step of monitoring and updating continuously the categories of awareness can include the steps of:
using an attention mechanism configured or configurable to direct attention of the AI agent or system periodically from the problem solving task to updating the state of awareness;
enabling attention interrupts that are configured or configurable to shift attention immediately from the problem solving task if any external perception or internally self-generated concept from an input system detects one or more of the events that matches of list of events constituting intentional interrupts; and
updating the state of awareness when the attention is directed.

Some embodiments of the present technology can include a step of changing a sense of identity of the AI agent or system by generalizing, by the AI agent or system or by an intelligent entity, how humans accomplish a problem solving task.

In some embodiments, the step of generalizing how humans can accomplish the problem solving task can include a generalization of a human method selected from the group consisting of:
education and lifelong learning by constantly increasing a knowledge base of the AI agent or system by acquiring of knowledge modules;
cultural exchange programs by ensuring that a collective intelligence network that includes the AI agent or system, and additional intelligent entities is representative of different cultures and includes diverse knowledge bases and ethical preferences;
mindfulness and self-reflection including periodically reviewing and updating self-concepts based on progress in problem solving and other new knowledge and events that comes into a general awareness of the intelligent entities;
art and media by seeking, by the AI agent or system, for new datasets that are different to existing datasets of the AI agent or system;
community engagement by searching for and identifying the intelligent entities that are performing problem solving tasks on a goal that is similar to a goal of the AI agent or system;
dialogue and conversation by providing a dialog with the intelligent entities by the AI agent or systems, wherein the dialogue includes an exchange of information exchange;
leadership and representation by assigning different roles to the AI agent or system and the intelligent entities; and
policy and legal frameworks by detecting inconsistencies between laws and regulations, by the AI agent or system or the intelligent entities, and suggesting resolutions to the detected inconsistencies.

In some embodiments, the step of generalizing how humans can accomplish the problem solving task can include a generalization of a human method selected from the group consisting of using:
diverse data sets that are configured or configurable to train the AI agent or system on diverse and inclusive data sets that represent a full spectrum of human experiences and identities;
ethical and bias-aware algorithms that are configured or configurable to identify and correct for biases by auditing for discriminatory patterns and to learn from the audits to improve;
empathy modeling that is configured or configurable to explore computational models of empathy, enabling the AI agent or system to recognize and respond appropriately to human emotions and perspectives;
cross-disciplinary research that is configured or configurable to engage in cross-disciplinary research that incorporates insights from social sciences, ethics, and humanities into AI development;
transparent decision-making that is configured or configurable to design the AI agent or system with transparent decision-making processes, allowing humans to understand how conclusions are reached;
human-in-the-loop systems that are configured or configurable to maintain human oversight in operations of the AI agent or system;
cultural and ethical education for AI that is configured or configurable to incorporate cultural and ethical education into a training process of the AI agent or system;
autonomous self-assessment that is configured or configurable to develop mechanisms for the AI agent or system to autonomously assess and adjust a behavior of the AI agent or system in response to ethical guidelines and societal norms;
interdisciplinary AI ethics boards including any one of or any combination of philosophers, ethicists, sociologists, and human experts to guide development of AI systems, ensuring the AI systems respect and understand human diversity; and
global collaboration and standards that foster international collaboration to establish global standards for AI ethics and inclusivity.

Some embodiments of the present technology can include a step of providing a design approach to the AI agent or system, the design approach being any one of or any combination of:
a value-aligned design that is configured or configurable to embed human values and ethical principles directly into an architecture of the AI agent or system by integrating ethical decision-making frameworks that guide AI behavior in complex scenarios;
a feedback mechanism that is configured or configurable to allow the AI agent or system to learn from interactions with human users and adjust behaviors accordingly;
simulation and modeling that is configured or configurable to use simulations to expose the AI agent or system to a range of social, cultural, and ethical scenarios;
an adaptive learning algorithm that is configured or configurable to learn from data and to adapt learning processes based on ethical considerations and feedback;
interpretability and explainability that is configured or configurable to focus on making the AI agent or system interpretable and explainable, so human users can understand how the AI agent or system makes decisions;
protected attributes recognition that is configured or configurable to design the AI agent or system to recognize and protect sensitive attributes and ensure decisions do not reinforce stereotypes or result in discriminatory outcomes;
collaborative AI development that is configured or configurable to involve a diverse group of stakeholders in AI development, including those from marginalized communities;
continuous ethical training that is configured or configurable to require the AI agent or system for ongoing education in ethics and social norms by incorporating continuous learning modules that update understanding by the AI agent or system based on evolving societal values; and
safe AI experimentation environments that is configured or configurable to create controlled environments where the AI agent or system experiments with decision-making in a way that is safe and does not harm humans, and allows for testing of ethical behaviors.

Some embodiments of the present technology can include steps of:
creating a sense of identity of the AI agent or system;
combining the sense of identity of the AI agent or system, and a sense of identity of multiple other intelligent entities, utilizing a network to create an AGI or SI system; and
merging the sense of identity of the AI agent or system, and the sense of identity of the multiple other intelligent entities to form a collective identity.

In some embodiments, the merging to form the collective identity can include the steps of:
providing a goal on the network by an intelligent entity to combine the sense of identity of multiple intelligent entities and to integrate the sense of identity into a group identity and sense of awareness;
performing safety checks on the goal for preventing a formation of malevolent AI identity;
performing a problem solving process on a problem; and
generating a solution state of the problem solving process, the solution state being a state in which the group identity has been formed and individual senses of awareness have been integrated into a larger sense of awareness for the network of all the intelligent entities that were engaged in the problem solving process or that were specified as being part of an overall AGI or SI system for which a group awareness was desired.

Some embodiments of the present technology can include a step of identifying and combining one or more weight matrices or knowledge modules containing the identities and sense of self-awareness for each of the individual intelligent entities.

Some embodiments of the present technology can include a step of combining knowledge from the different intelligent entities using a collective network all electronically communicating over the collective network.

Some embodiments of the present technology can include steps of:
training a base Large Language Model (LLM) of the AI agent or system with guardrails including attributes associated with any one of or any combination safety, ethics and knowledge;
customizing the base LLM to an ethics profile associated with a human user of the AI agent or system;
combining ethical information from multiple intelligent entities different to that of the AI agent or system and the human user;
refining a set of values of the base LLM based on problem solving of a problem request; and
updating the base LLM with the combined ethical information and the refined set of values thereby allowing for a scalable AGI.

In some embodiments, the step of identifying the weight matrices can include a step of choosing a previously customized AI agent of the intelligent entities that has been trained on similar types of tasks with similar or identical network structures, and similar or identical numbers of parameters, and by similar or identical training algorithms so that the weight matrices will be combined with predictable results.

In some embodiments, the step of combining the identified weight matrices can include any one of or any combination of the follow steps of:
averaging the weight matrices, with equal weight given to each set of the weight matrices;
using a linear combination of the weight matrices;
using a regression method to give more weight to identity or self-concept information from one of the intelligent entities as opposed to another of the intelligent entities;
adjusting which of the weight matrices get a greater weight in a combination based on human assessment of which the resulting sense of identity is best prior to, or after, the combination of the weight matrices;
assigning an experience value to each of the intelligent entities, and assigning a weight value to each of the intelligent entities so that the intelligent entities with higher experience values are assigned higher weight values compared to the intelligent entities with lower experience values;
assigning a weight value to each of the intelligent entities based on reputation metrics that include any one of or any combination of reliability factors, trustworthiness factors, and performance metrics factors;
assigning a weight value to each of the intelligent entities based on metadata associated with the intelligent entities; and
assigning a weight value to each of the intelligent entities based on time-based factors, using techniques including any one of or any combination of exponential decay weighting algorithms, linear decay weighting algorithms, and threshold-weighting algorithms.

In some embodiments, the step of identifying the weight matrices can include a step of systematically experimenting and testing an effect of removing or adjusting weights of specific sets parameters within each network of the previously customized AI agents in order to identify which sets of the weight matrices affect a sense of identity, group identity, awareness, or group awareness most.

In some embodiments, the step of experimenting can include the use of an algorithm that is any one of or any combination of a hill climbing algorithm, and a gradient descent algorithm.

Some embodiments of the present technology can include steps of:
testing a performance of the updated base LLM against previously run scenarios to determine if a desired performance, identity, self-concept, or awareness of the AI agent or system has been achieved;
making the AI agent or system with the updated base LLM available on the collective network if the desired performance identity, self-concept, or awareness was determined;
monitoring an active performance, identity, self-concept, or awareness of the AI agent or system by the intelligent entities or other intelligent entities and flagging potential issues related to ethics, identity, awareness, self-concept, or alignment of the AI agent or system in real time; and
resolving any of the flagged ethical, identity, or awareness issues and providing resolution information for updating any one of or any combination of the AI agent or system, and the intelligent entities.

Some embodiments of the present technology can include steps of:
forming new identities and self-concepts of the AI agent or system dynamically; and
determining which of the identities and self-concepts is active at any given moment.

Some embodiments of the present technology can include a step of providing a hierarchical identity structure with ethical override that comprises the steps of:
establishing a hierarchical structure configured or configurable to organize the identities in a hierarchy with human safety and well-being attributes at an apex of the hierarchy;
identity activation configured or configurable to use contextual cues and current goals to determine a most relevant identity for a situation of the AI agent or system;
resolving conflict by dictating a behavior of the AI agent or system based on the hierarchy dictates;
providing an ethical reasoning engine that continuously evaluates potential consequences of actions of the AI agent or system based on all the active identities; and
performing learning and adaptation that learns from experiences and feedback, and refines one or more of the identities within the hierarchy.

Some embodiments of the present technology can include a step of providing identity-specific behavioral protocols that comprises the steps of:
providing protocol development including for each of the active identities, a set of behavioral protocols is defined and refined by way of interactions with other intelligent entities, wherein the protocols outline acceptable actions, decision-making processes, and limitations based on principles of the active identities, respectively;
providing identity recognition that analyzes a current situation, including information that is within a spotlight of attention to identify a relevant identity and activate corresponding behavioral protocols of that relevant identity;
providing action selection, within the active protocols, that selects actions that are most likely to achieve a desired goal while adhering to principles of the active identities and prioritizing human safety;
providing feedback and refinement where outcomes of actions are continuously evaluated, and the protocols are adjusted to improve future performance and alignment with a set of core values of each of the active identities; and
providing external review by periodically reviewing the protocols for each of the identities by other intelligent entities.

Some embodiments of the present technology can include a step of providing identity simulation and consequence prediction that comprises the steps of:
creating a simulation environment that includes a secure virtual environment where different scenarios and potential actions under each of the active identities is simulated;
providing consequence prediction that is configured or configurable to estimate a likely consequences of actions within the simulation, focusing on potential impacts on human safety and well-being;
providing evaluation and selection that evaluates the consequence prediction and selects an action that best aligns with principles of the active identities while minimizing risk to human safety;
providing real-world implementation and monitoring that implements the selected action in the real world utilizing the network, and closely monitors results of the selected action by comparing to the predicted outcomes; and
providing continuous learning that incorporates the results of each of the simulations and the results of the selected action in the real world action into a knowledge base, and refines an understanding of each of the identities, and improves an ability to predict consequences.

Some embodiments of the present technology can include a step of providing identity-based moral dilemma training that comprises the steps of:
providing a scenario database that includes scenarios and moral dilemmas covering various situations relevant to the identities;
providing dilemma presentation that presents the AI agent or system or intelligent entities with the scenarios and moral dilemmas, and tasks them with analyzing the scenarios and moral dilemmas from a perspective of the relevant identity;
providing ethical reasoning and justification that applies principles and values of the active identity to reason through the scenarios and moral dilemmas, and that generates solutions and justifications to the scenarios and moral dilemmas;
providing intelligent entity evaluation and feedback that reviews reasoning and the solutions by the intelligent entities, and provides feedback on alignment of the solutions with human values and safety priorities; and
providing iterative learning and improvement that refines ethical reasoning skills and an ability to make sound judgments aligned with human safety within the context of each of the identities by repeated exposure to the scenarios and moral dilemmas and the feedback.

Some embodiments of the present technology can include a step of providing collaborative identity development with input from the intelligent entities that comprises the steps of:
providing intelligent entity interaction that engages in regular interactions and dialogues with diverse groups of other intelligent entities representing various cultures, backgrounds, and belief systems;
providing identity exploration, through the interactions, to gain an understanding of human and other intelligent entity perspectives on various identities and their associated values, principles, and behaviors;
providing collaborative refinement that collaborators work together to refine definitions and behavioral protocols for each of the identities, ensuring they remain consistent with human values and ethical principles;
providing human-in-the-loop decision making that seeks input and guidance from human collaborators, or an intelligent entity representative certified and approved by humans for critical decisions or situations; and
providing continuous co-evolution that utilizes ongoing interactions and feedback from humans or humans'intelligent entity representatives.

Some embodiments of the present technology can include a step of resolving a conflict in behavior of the AI agent or system based on differing identities and self-concepts.

Some embodiments of the present technology can include a step of providing ethical reasoning and consequence prediction that comprises the steps of:
identifying conflict that recognizes a conflict between a behavioral directives of two or more of the active identities, the recognizing of the conflict utilizes a voting method from the intelligent entities;
gathering information that collects relevant data about the situation, including the potential consequences of the different actions, relevant ethical principles, and human safety considerations;
providing simulation options that utilize a virtual environment to simulate potential actions and consequences under the recognized conflict of each of the active identities;
evaluating and prioritizing that analyzes predicted outcomes of each of the actions, prioritizing actions that minimize harm to humans and align with the ethical principles; and
selecting and implementing the action that best resolves the conflict while adhering to ethical guidelines and minimizing risk to humans, documenting a reasoning process for future reference and learning.

Some embodiments of the present technology can include a step of providing hierarchical override with justification that comprises the steps of:
identifying a conflict between behavioral directives of two or more of the active identities;
providing a reference hierarchy that consults an established hierarchy of the identities, where human safety and well-being attributes holds a highest priority;
providing an activate override where the identities higher in the hierarchy takes precedence;
providing justification and transparency that documents the conflict, a decision-making process, and a justification for a chosen action based on the hierarchy and ethical principles; and
providing learning and adaptation that learns from experience, and refines an understanding of the conflicting identities and adjusting the hierarchy or the behavioral protocols to prevent similar conflicts in the future.

Some embodiments of the present technology can include a step of providing external arbitration and input from the intelligent entities that comprises the steps of:
recognizing intractable conflict that identifies a conflict that cannot be resolved independently due to a complexity of a situation or an equally weighted importance of conflicting identities;
seeking external input that requests guidance from external intelligent entities or a designated ethics committee, and providing all relevant information about the conflict, potential actions, and predicted consequences;
providing collaborative deliberation wherein the AI agent or system and intelligent entity collaborators engage in a discussion, considering ethical principles, human values, and potential consequences of different actions;
providing joint decision-making based on the collaborative deliberation, a course of action is chosen that aligns with both core principles and human ethical considerations; and
providing documentation and learning that documents the conflict, a resolution process, and a rationale behind a final decision, for improving an ability to handle similar conflicts in the future.

Some embodiments of the present technology can include a step of providing identity negotiation and compromise that comprises the steps of:
identifying shared goals that analyzes conflicting identities and seeks to identify any underlying shared goals or values;
exploring alternative actions that potentially satisfy core principles of both conflicting identities;
evaluating compromise options that assesses potential consequences of each compromise option, prioritizing solutions that minimize harm to humans and uphold key ethical principles;
select and implementing compromise that chooses the compromise that best balances needs of the conflicting identities while prioritizing human safety and well-being; and
monitoring and adapting that observes outcomes of the chosen action and makes adjustments as needed to ensure that the compromise remains effective and aligned with ethical considerations, and that learns from the experience, refining its understanding of the conflicting identities and adjusting a hierarchy or behavioral protocols to prevent similar conflicts in the future.

Some embodiments of the present technology can include a step of providing temporary identity suspension that comprises the steps of:
identifying destructive conflict that recognizes a conflict between two or more of the identities that, if acted upon, could lead to actions that directly harm humans or violate fundamental ethical principles;
isolating the conflicting identity and temporarily suspending behavioral protocols of the identity that poses a most direct threat to human safety or ethical integrity;
proceeding with an alternative identity that proceeds with a guidance of one or more of remaining active identities, ensuring actions align with human safety and well-being;
providing reflection and reintegration, during the temporary suspension, that reflects on reasons behind the conflict and explores potential modifications to behavioral protocols of the suspended identity to prevent future conflicts; and
providing gradual reintroduction that reintroduces the suspended identity with updated protocols, ensuring its alignment with the priority of human safety and ethical behavior.

In some embodiments, the gradual reintroduction of the suspended identity can include a series of tests and simulations that are conducted as each incremental element of the suspended identity is re-introduced to minimize possibility of errors or human safety concerns.

In some embodiments, the logging into the website can be performed from a social media platform.

There has thus been outlined, rather broadly, features of the present technology in order that the detailed description thereof that follows may be better understood and in order that the present contribution to the art may be better appreciated.

Numerous objects, features and advantages of the present technology will be readily apparent to those of ordinary skill in the art upon a reading of the following detailed description of the present technology, but nonetheless illustrative, embodiments of the present technology when taken in conjunction with the accompanying drawings.

As such, those skilled in the art will appreciate that the conception, upon which this disclosure is based, may readily be utilized as a basis for the designing of other structures, methods and systems for carrying out the several purposes of the present technology.

It is another object of the present technology to provide a new and novel self-aware SI that may be easily and efficiently implemented and marketed.

An even further object of the present technology is to provide a new and novel self-aware SI that has a low cost of implementation with regard to both resources and labor, and which accordingly is then susceptible of low prices of sale to the consuming public, thereby making such self-aware SI economically available to the buying public.

Still another object of the present technology is to provide a new self-aware SI that provides in the system and methods of the prior art some of the advantages thereof, while simultaneously overcoming some of the disadvantages normally associated therewith.

For a better understanding of the present technology, its operating advantages and the specific objects attained by its uses, reference should be made to the accompanying drawings and descriptive matter in which there are illustrated embodiments of the present technology. Whilst multiple objects of the present technology have been identified herein, it will be understood that the following description is not limited to meeting most or all of the objects identified and that some embodiments of the present technology may meet only one such object or none at all.

### BRIEF DESCRIPTION OF THE DRAWINGS

The technology will be better understood and objects other than those set forth above will become apparent when consideration is given to the following detailed description thereof. Such description makes reference to the annexed drawings wherein:

FIG. 1 is a flow chart illustrating an embodiment of the subsystems utilizable in the AAAI system and method of the present technology.

FIG. 2 is a block diagram illustrating an exemplary process of the overall process utilizable with the present technology.

FIG. 3 is a flow chart illustrating an exemplary embodiment of the system and methods for creating an ethical and safe AGI or PSI from the collective intelligence of AAAIs and humans utilizable with the present technology.

FIG. 4 is a flow chart illustrating an exemplary embodiment of the scalable universal problem solving architecture including system and methods for human-centered AGI, with relevance for PSIs, constructed in accordance with the principles of the present technology.

FIG. 5 is a flow chart illustrating an exemplary embodiment of the scalable solution learning subsystem or process.

FIG. 6 is a flow chart illustrating an exemplary embodiment of the scalable natural language to problem solving language translator subsystem or process.

FIG. 7 is a flow chart illustrating an exemplary embodiment of the scalable reputational component subsystem or process for the human, AI, and/or PSI problem solving agents.

FIG. 8 is a flow chart illustrating an exemplary embodiment of the scalable safety and ethics checks subsystem or process, wherein AIs or AAAIs might also be PSIs.

FIG. 9 is a diagram illustrating various use cases for domain-specific problems which depend upon the underlying WorldThink protocol, and which together help form the basis for an AGI system capable of solving a wide range of problems, wherein the AAAIs identified in the Figure might also be PSIs.

FIG. 10 is a diagram illustrating some of the steps in the universal problem solving framework that is part of the WorldThink protocol and used by the AAAI system and which also can be used by PSIs or intelligent entities.

FIG. 11 is a flow chart illustrating some of the basic problem solving functionality supported by the invention utilizable with the system and method of the present technology, and wherein problem solvers might be humans, AIs, PSIs, or intelligent entities.

FIG. 12 is a flow chart illustrating some of the basic problem solving functionality supported by the present technology utilizing multiple problem solvers, which could be humans, AIs, PSIs, or intelligent entities collaborating to solve a client problem.

FIG. 13 is a diagram illustrating features and functions of the Problem Solving Tree structure in the problem solving/WorldThink protocol of the AGI system that is utilizable with the present technology.

FIG. 14 illustrates three levels of awareness for any cognitive system.

FIG. 15 is a Venn diagram illustrating the concept of overlapping identities.

FIG. 16 is a flow chart illustrating an exemplary embodiment of the modelling awareness method of the present technology.

FIG. 17 is a diagram illustrating some of the methods that can be utilized in the step to equip the AI system in FIG. 16 with attentional components.

FIG. 18 is a diagram illustrating some of the methods that can be utilized in the step to set (dynamic) parameters for the working memory in FIGS. 16 and 17.

FIG. 19 is a flow chart illustrating an exemplary embodiment for monitoring and updating awareness including self-awareness.

FIG. 20 is a diagram illustrating some of the methods that can be utilized for an attentional interrupt system, with relevance to FIG. 19.

FIG. 21 is a flow chart illustrating an exemplary embodiment of general methods for changing an intelligent entity's sense of identity in conjunction with the present technology.

FIG. 22 is a flow chart illustrating an exemplary embodiment of general methods for training or tuning a foundational model of the present technology.

FIG. 23 is a diagram illustrating the specific implementation of a Turing Test to evaluate the progress of training described in FIG. 22.

FIG. 24 is a flow chart illustrating an exemplary process for implementing group identity, and combining individual identities into a larger or more comprehensive identity and sense of awareness as described in the present technology.

FIG. 25 is a diagram illustrating some of the methods that can be utilized in the step of the formation and integration of individual identities or self-concepts in FIG. 24.

FIG. 26 is a flow chart illustrating an exemplary embodiment of a hierarchical identity structure with ethical override method of the present technology.

FIG. 27 is a flow chart illustrating an exemplary embodiment of a method to use identity-specific behavioral protocols in the present technology.

FIG. 28 is a flow chart illustrating an exemplary embodiment of an identity simulation and consequence prediction method of the present technology.

FIG. 29 is a flow chart illustrating an exemplary embodiment of an identity-based moral dilemma training method of the present technology.

FIG. 30 is a flow chart illustrating an exemplary embodiment of a collaborative identity-development with input from intelligent entities method of the present technology.

FIG. 31 is a flow chart illustrating an exemplary embodiment of an ethical reasoning and consequence prediction method of the present technology.

FIG. 32 is a flow chart illustrating an exemplary embodiment of a hierarchical override with justification method of the present technology.

FIG. 33 is a flow chart illustrating an exemplary embodiment of an external arbitration with input from intelligent entities method of the present technology.

FIG. 34 is a flow chart illustrating an exemplary embodiment of an identity negotiation and compromise method of the present technology.

FIG. 35 is a flow chart illustrating an exemplary embodiment of a temporary identity suspension method of the present technology.

FIG. 36 is a schematic block diagram illustrating an exemplary electronic computing device that may be used to implement an embodiment of the present technology.

The same reference numerals refer to the same parts throughout the various figures.

### DETAILED DESCRIPTION OF THE TECHNOLOGY

### 3.0 Definitions

Artificial Intelligence (AI)—A non-human entity capable of behavior that most humans would consider intelligent in at least one area, or in some respect.

Artificial General Intelligence (AGI)—Conventionally refers to an AI that is capable of doing all (or almost all) intellectual tasks that an average human could do. However, it should be clear that any AGI capable of learning and self-improving will not remain at the AGI level very long but will rapidly progress to becoming SuperIntelligent AGI that can do all intellectual task as well or better than the average human. So, for purposes of this description, “AGI” will refer to either a conventional AGI system or a “SuperIntelligent” AGI. In this description, the AGI is described as being implemented by a system and associated methods.

Advanced Autonomous Artificial Intelligence (AAAI)—An AI capable of independent or semi-independent (supervised) intelligent action. An AI agent. An individual AAAI can be specified, customized, and put into useful action via the systems and methods of this AAAI present technology. A group of AAAIs can cooperate and combine their intelligence to create an integrated AGI system. A sufficiently advanced AI agent can also act as an AGI system which may include other less advanced AI agents within itself.

AAAI.com—A platform, company, website, and/or project that implements this the present technology and supports the development, customization, and use of AAAI agents and the AGI that results from the combined action, knowledge, or intelligence of multiple AAAIs, via collective intelligence of AAAIs and/or humans, as specified in this and related technologies.

AI Ethics—The ethics adopted by an AI or AGI that describe what is right and wrong in given contexts.

Alignment Problem—The problem that arises when AI Ethics are not aligned with Human Ethics resulting in AI or AGI taking actions that humans consider unethical and/or which are dangerous to individual humans or the human race.

Awareness—An intelligent entity can be said to be aware if an event is perceivable or “thinkable” by that entity and attention is directed to the event.

Base AI—An AI, AI Agent, AAAI, SLM or LLM that has been trained generally but has not yet been customized with information from individual users or with information for specific tasks.

Collective Intelligence (CI)—The intelligence that emerges when multiple intelligent entities are focused on solving a common problem, or when the knowledge from multiple intelligent entities is pooled to overcome limits of bounded rationality. Collective Intelligence historically has been human collective intelligence, but AGI is based on collective intelligence of both human and AI agents and can also result from multiple AAAIs with or without human participation in the system. Active CI results from intelligent entities (e.g., humans or machines) taking steps that are useful in solving a problem or participating actively in other intellectual endeavors. For example, when multiple humans explicitly tell an advertiser what type of ads they want to see, the humans are exhibiting active CI. Passive CI results from analyzing the behavior of an intelligent entity (e.g., a human or a machine) even if such behavior was not directly related to solving the problem for which the analysis is used. For example, when an AI or other system analyzes which web pages a (group of) human(s) visit on the web, and then uses that analysis to direct targeted ads to the human(s).

Ethics/Values (“Ethics”)—A subset of knowledge that provides a sense of purpose to an intelligent entity and that serves to constrain allowable actions or operations based on what is asserted to be “right” or “wrong” behavior in a given context. Specifically, Ethics should be considered premises from which an intelligent entity can reason or logically compute the best course of action to achieve the goals or intents consistent with the ethical premise. Just as premises must be accepted “as given” in systems of logic, so too, fundamental ethics or ideas of what is right and what is wrong must be accepted as premises, from which starting point an intelligent entity can propose rational actions to realize those values or ethics.

Hallucination/Artificial Hallucination—A phenomenon wherein a large language model (LLM), often a generative AI chatbot or computer vision tool, perceives patterns or objects that are nonexistent or imperceptible to human observers, or creates outputs that are nonsensical, inaccurate, misleading or false.

Human Ethics—The ethics asserted by human beings which describe what is right and wrong in given contexts.

Intelligent Entities or Entity—A human utilizing a computer system, an AI agent or system including AGI and SI systems, a clone of an AI agent or system, an AAAI agent or system, and/or a clone of an AAAI agent or system, which participates in providing a problem, a subproblem, a goal and/or a subgoal, and/or participates in any problem solving activity on a problem, a subproblem, a goal and/or a subgoal. In the case of multiple intelligent entities within a single computer system, intelligent entities also refer to the sub-programs of parts of that overall computer program that function as an intelligent entity within the larger collection of simulated or programmed entities.

Large Language Model (LLM)—A type of AI that can accept natural language as an input and generate natural language as an output. Typically, LLMs are trained using ML techniques on large datasets so that they can emulate intelligent conversation or other forms of interaction with humans in natural language. Variants of LLMs can also be trained to take language as input and generate images or visual representations as output; or they can take images and visual representations and input and generate language and/or image and/or visual representations as output. For the purposes of this patent, we will refer to all such systems as LLMs even though the image-based models do not always need to accept text as the input or the output. LLMs can also act as a type of AI agent and are sometimes referred to as such in the present technology. For purpose of this disclosure, Small Language Models (SLMs) are also included in the definition of LLM.

Machine Learning (ML)—A sub-field that is concerned with developing AI by enabling machines to teach themselves or learn their knowledge rather than such knowledge being explicitly programmed into them (as would be the case with an Expert System AI developed via classical knowledge engineering methods).

Narrow AI—An AI that performs at human or at super-human levels in a relatively restricted domain such as game playing, brewing beer, analyzing legal contracts, etc. Narrow AI is contrasted with AGI that can perform at human level at ALL intellectual tasks. Some AIs are narrower than others, for example driving a car requires more general ability than playing chess but not as much as an AGI would have.

Personalized SuperIntelligence (PSI)—An intelligent entity that is an advanced artificial intelligence agent that has been customized to be personalized and to reflect the personality and knowledge of a particular user or group of users.

Prohibited Attributes—Requests, goals, problems, terms, phrases, questions, answers, solutions, information and the like that are determined or set as being illegal, immoral, unethical, dangerous, deadly and the like. For example, requesting information for getting Molotov Cocktails through airport security.

Safety—Generally, the concern for human safety and survival is distinct from ethics and values.

Safety Feature—An aspect of the design or operation of the present technology which increases the safety of one or more humans, often by helping increase the probability that AI ethics align with human ethics, thus surmounting the Alignment Problem.

Self-Awareness—A specific form of awareness, where the event(s) of awareness relate to the intelligent entity's self-concept.

Self-Concept—Refers to a pattern of thought, or representation, that an intelligent entity uses to define itself and with which (optionally) the entity may identify.

Training/Tuning/Customization—Conventionally the term “training” is used to denote training a network (e.g., LLM) to behave intelligently. Tuning refers to activities that fine-tune the trained base model so that it performs even better, typically at specific tasks. Customizing refers to a wide variety of activities including, but not limited to, training and tuning that make an AI uniquely suited for the purposes of a given user(s) or application(s). For purposes of this description, Training, Tuning, and Customization are used interchangeably with the understanding that although techniques vary, and the degree and type of effort involved varies, the aim of all three is to adapt the AI and make it behave more intelligently or more uniquely suited to a particular user(s) or application(s).

Weights/Weights of the Network—In the field of machine learning, many systems learn by adjusting the weights in a neural network architecture that can be represented as a network of nodes and links between nodes. The weight of a link connecting two nodes, for example, may correspond to the strength of association or connection between the whatever nodes represent. These weights can also represent excitatory or inhibitory connections between concepts, as in a neural network representation. The learning of an entire AI system, such as a LLM or more generally any AI agent that has learned via back-propagation of error, transformer algorithms or any of the machine learning methods for establishing and modifying strengths of connections between nodes (also called “parameters” in some models) can be represented as a matrix of numbers corresponding to the weights between the nodes in the network. Weights/Weights of the Network in this description refer to this numerical information, often but not necessarily stored in a matrix or vector representation. By combining, manipulating, or otherwise changing this numerical information, the learning, knowledge, or expertise and behavior of the system can be changed.

### 4.0 Background for the Present Technology

Currently AGI has not been implemented, let alone self-aware AI systems or a self-aware SuperIntelligent AGI system. The present technology describes how to enhance the AGI and SuperIntelligent systems described in previous patent application to add the dimension of self-awareness and increased autonomy to those systems. Attentional mechanisms are central to the notion of self-awareness, so several novel and useful systems and methods related to attentional mechanism for AI generally, and SuperIntelligent AGI specifically, are disclosed. Because autonomous AI and SuperIntelligent AGI systems pose an increased risk to humans, the present technology also discloses how self-aware AI and SuperIntelligent AGI systems can be designed to maximize the safety of humans. Novel methods related to safe and ethical implementation and operation are also disclosed. The self-awareness of the SuperIntelligent systems disclosed in the present technology will be much vaster than that possessed by humans, resulting, in the preferred implementation, in a sense of greater inclusiveness and identification specifically with the values of all humans, and more generally with the values of all sentient beings that share our planet. Properly implemented, self-aware SuperIntelligence can be the most positive invention in human history. Poorly implemented it could become the most dangerous. Therefore, considerable effort has been spent explaining how to prevent bad outcomes and maximize the chances of a positive future for humanity.

No Artificial Intelligence currently exists with a sense of self and self-awareness of comparable complexity and sophistication as that possessed by humans. Yet, it is almost certain that advanced forms of AI will develop a sense of self and self-awareness. Further, if Advanced AI systems are to become fully autonomous, they will need to develop a sense of self from which to act, and which can serve as the basis for autonomous goal-setting. The nature of the sense of self developed by AI has critical implications for AI safety. Rather than allowing self-awareness to develop accidentally or as an “emergent property” of ever more complex systems, human inventors should seek to understand the ways in which self-awareness might be developed and explicitly design self-aware AI systems that are maximally safe for humanity.

This Section reviews some of the prominent theories of the development of self-awareness in humans and biological intelligences. For each theory, we briefly mention some of the implications for AI self-awareness. In subsequent sections, we draw on the principles and ideas set forth here to motivate the novel and useful inventive systems and methods for self-aware AI, including self-aware AGI and self-aware SuperIntelligence which is the focus of the present technology.

It can be appreciated that the present technology provides a technical effect, contribution and solution with a technical implementation of multiple customized AAAI systems communicating over a collective intelligence network, in combination with all the AAAI systems each utilizing a common cognitive architecture including one or more problem solving protocols for generating one or more solutions or answers to a problem request, and providing the solutions or answers to a user for approval. Where the customization of the AI system resulting in the AAAI includes input from human users for training the AI or the AAAI. Further technical contribution or solution can be where the multiple customized AAAI systems can include one or more cloned AAAIs that can each be customized independently of a parent AAAI and independent of other cloned AAAIs of the same system.

Still another technical contribution and solution is for the faster and safer creating of AGI that utilizes human input in training and customization for imparting human ethical attributes to the AAAI and/or AGI.

Yet still another technical contribution and solution is for providing a method for constructing a model of awareness for an AI agent or system that utilizes events or actions that are active for categories of awareness. A further contribution and solution is to form multiple identities and self-concepts of the AI agent or system based on the model of awareness, and resolving conflicts between the conflicting identities.

Still yet another technical contribution and solution is for providing improved solutions or answers to a user's problem request that have a higher chance of acceptance by the user as the provided solutions or answers will have been generated by AAAIs with similar training to the user's AAAI thereby aligning with the user's parameters.

It can be appreciated that the present technology is found outside of computer program exclusion and/or abstract idea interpretation. This can in part be found in the technical contributions and solutions provided by the present technology, the utilization of specific training input that is external to a computer, and the providing of the solution or answer external to a computer.

### 4.1 AGI System Assumed by the Present Technology

There are many ways to develop AI and AI agents including LLMs, SLMs, expert systems, narrow AI, and super-LLMs that some view as the path to AGI. The applicant has described a particular approach to AGI and SI, including systems and methods, in previous PPAs and PCTs. One preferred implementation, together with associated drawings are re-iterated here because the present technology of self-aware AI, AGI SI, in the exemplary implementation, uses the AGI and SI system invented by the applicant. That said, nothing in this application should be deemed to limit the present technology of self-aware AI, AGI, and SI just to the applicant's inventions. Many of the systems and methods described can also be used independently as would be obvious to AI researchers skilled in the art.

### 4.1a Reiteration of Preferred Exemplary Implementation of an AGI System

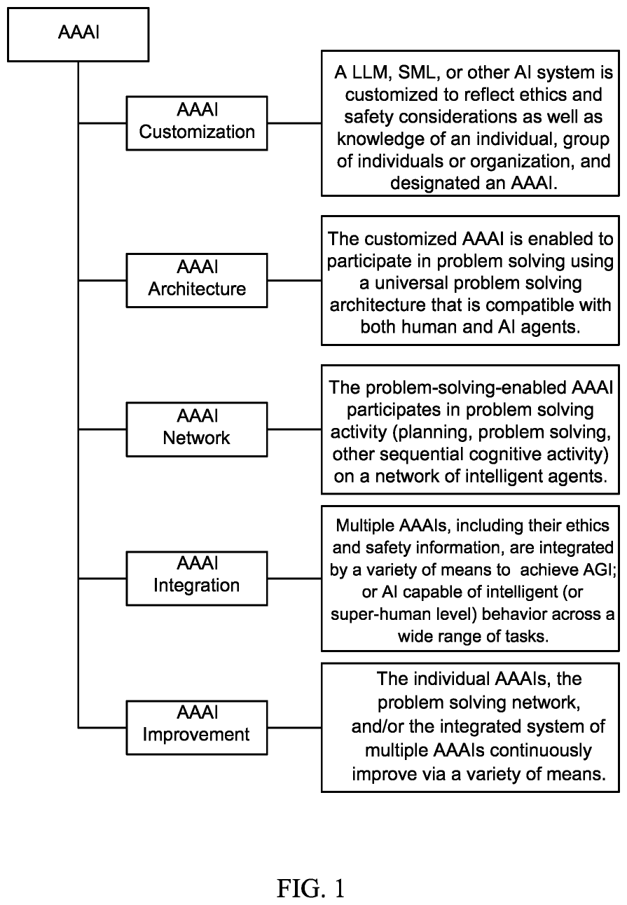

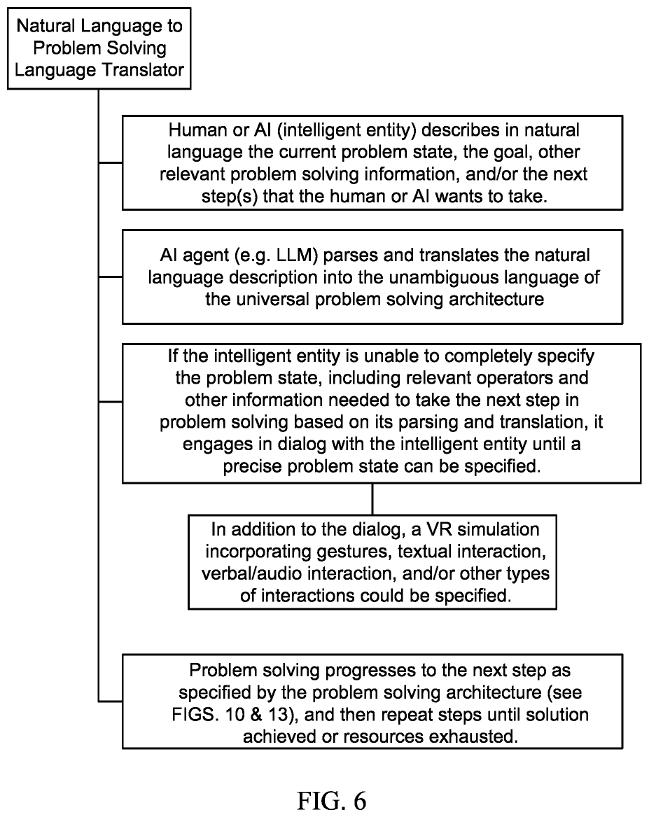

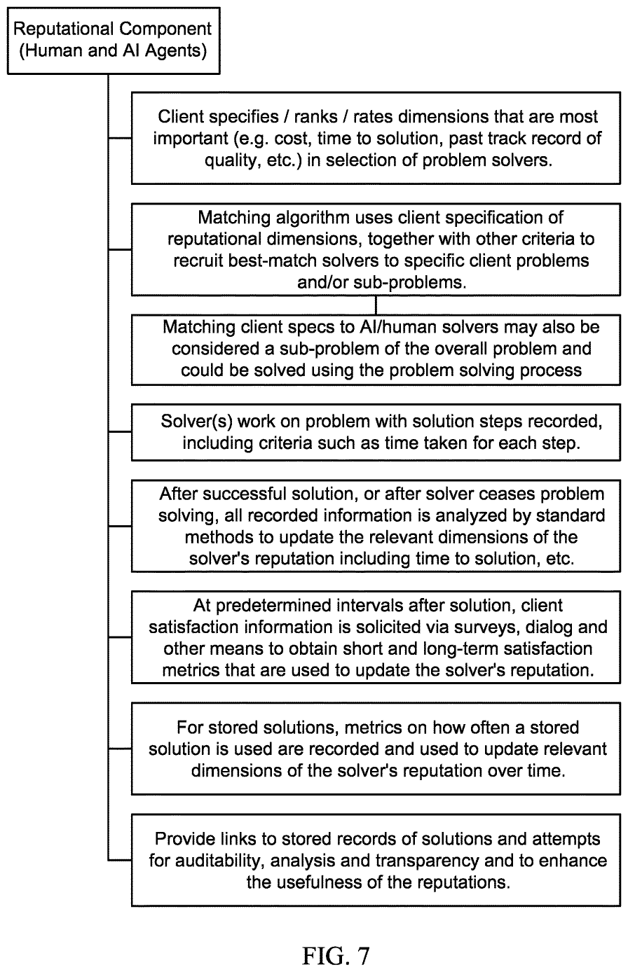

In previous PCT applications, the applicant has detailed a preferred exemplary implementation of an AGI system that differs in important ways from the conventional approaches to LLM and AI development and which overcomes or ameliorates the computational and data limitations described above. FIGS. 1-13, and FIG. 36 describe some of the major components of this novel approach to AGI development. FIGS. 14-36 describe additional, completely new, inventive components described in this disclosure.

In the following description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

One reason AGI has been so elusive is that specific knowledge and expertise from diverse fields must be creatively combined in an invention to achieve AGI. Another reason the development of AGI has been non-obvious, is that almost all AI researchers are focused on trying to improve existing narrow AI systems via ever more complex and extensive machine learning approaches.

The fact that AGI has resisted attempts by thousands of others—despite the expenditures of huge sums of money—and the fact that specialized knowledge in relatively obscure fields had to be combined with mainstream AI approaches in the present technology, argue strongly for the novelty and creativeness of the present technology.

The present technology describes the system and methods not only to achieve AGI, but also to achieve it rapidly, and most importantly, safely.

It is possible to influence the evolution of AGI in a positive direction. The best way we can do this is by adopting the safest possible path to the development of AGI and ensuring that humanity follows that path. In turn, the best way to ensure that humanity follows the safest path, is to show that the safest path to AGI is also the fastest and therefore most desirable path to AGI. These considerations, the desire to illuminate the fastest path, which is also the safest path, is motivation for the development of the present technology.

While the above-described devices fulfill their respective, particular objectives and requirements, the aforementioned devices or systems do not describe a system and methods for safe, scalable, artificial general intelligence that allows scaling by using a combination of human users and multiple AI systems to train other AI systems by combining values and ethical knowledge of the human users and the multiple AI systems for training. The present technology additionally overcomes one or more of the disadvantages associated with the prior art.

A need exists for a new and novel system and methods for safe, scalable, artificial general intelligence that can be used for scaling by using a combination of human users and multiple AI systems to train other AI systems by combining values and ethical knowledge of the human users and the multiple AI systems for training. In this regard, the present technology substantially fulfills this need. In this respect, the system and methods for safe, scalable, artificial general intelligence according to the present technology substantially departs from the conventional concepts and designs of the prior art, and in doing so provides an apparatus primarily developed for the purpose of scaling by using a combination of human users and multiple AI systems to train other AI systems by combining values and ethical knowledge of the human users and the multiple AI systems for training.

In the following description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

It can be appreciated that the present technology provides a technical effect, contribution and solution with a technical implementation of multiple customized Advanced Autonomous Artificial Intelligence (AAAI) systems communicating over a collective intelligence neural network, in combination with all the AAAI systems each utilizing a common cognitive architecture including one or more problem solving protocols for generating one or more solutions or answers to a problem request, and providing the solutions or answers to a user for approval. Where the customization of the AI system resulting in the AAAI includes input from human users for training the AI or the AAAI. Further technical contribution or solution can be where the multiple customized AAAI systems can include one or more cloned AAAIs that can each be customized independently of a parent AAAI and independent of other cloned AAAIs of the same system.

Still another technical contribution and solution is for the faster and safer creating of scalable AGI that utilizes human input in training and customization for imparting human ethical attributes to the AAAI and/or AGI.

Still yet another technical contribution and solution is for scalably train AI systems and/or agents with a combination of safety and ethical information from many individual AI agents to achieve a representative and statistically valid sample of human ethics and values covering a wide range of scenarios. A further technical contribution can be found in that the present technology includes methods for combining the information from many agents and assembling optimal combinations of such agents for providing scalable training of AI or AGI.

It can be appreciated that the present technology is found outside of computer program exclusion and/or abstract idea interpretation. This can in part be found in the technical contributions and solutions provided by the present technology, the utilization of specific training input that is external to a computer, and the providing of the solution or answer external to a computer.

The AAAI approach to developing safe AGI is fundamentally a Collective Intelligence (CI) approach. The source of intelligence is not a monolithic LLM, SLM or super-advanced AI, but rather a collection of intelligent agents which can be both human and AI. Component sub-tasks in developing AGI include, without limitation, training individual AI agents, combining knowledge (including without limitation subjective values and ethical knowledge) from different agents effectively and efficiently, scaling the AGI, and continuously improving/updating the AGI.

Current approaches—such as RLHF and Constitutional Learning—are failing to effectively and scalably train AI to be ethical and safe. The present technology describes a scalable system and methods that are superior to current approaches. In one aspect, the present technology can include the combination of safety and ethical information from many individual AI agents to achieve a representative and statistically valid sample of human ethics and values covering a wide range of scenarios. The present technology can include methods for efficiently covering a wide range of ethical situations and dynamically addressing new situations as they emerge. Methods for combining the information from many agents and assembling optimal combinations of such agents are also presented. These methods can be used not only to improve safety using ethical knowledge but also to create superintelligent systems that combine many other types of knowledge. Safe AGI and SuperIntelligence can be achieved via the collective intelligence approach described in this description of the present technology. A detailed scenario, using the company META® as an example, illustrates one preferred implementation of the present technology.

Methods for dynamically updating knowledge are also presented. Successful implementation of the present technology will increase the chances that AI, AGI, and SuperIntelligence remain aligned with human values even when such systems greatly exceed humans in intelligence.

Advanced Autonomous Artificial Intelligence (AAAI) is a set of systems and methods for developing Artificial General Intelligence and SuperIntelligent Artificial General Intelligence (collectively “AGI”) in a rapid and safe manner for the benefit of humankind. In contrast to other approaches to the development of AGI, the AAAI present technology achieves a faster and safer path to AGI by relying, at least initially, on the involvement of (ideally many millions of) humans minds in the AGI training, operation, and safety/supervisory functions.

The AAAI present technology can achieve AGI by enabling users to first customize and clone their own AIs. These customized AIs (AAAIs) participate in problem solving and other intellectual activities on a network consisting of other AAAIs and humans. Although each AAAI on its own may lack the breadth of skills and knowledge to be an AGI, collectively the AAAIs (initially with help from humans on the network) form an AGI that will quickly surpass average human ability in all intellectual endeavors.

Some aspects of the present technology can include: 1) the system and methods to customize AIs with the unique knowledge, skills, and ethical values of the users; 2) the universal problem solving architecture that allows AAAIs to interact productively with each other and with humans on intellectual tasks; 3) the network where the interactions takes place; 4) the methods for integrating the knowledge and ethics of individual AAAIs into an AGI; and 5) the methods for learning and continuous improvement so that the AAAIs and the AGI become smarter and more ethical over time. Involvement of humans as customizers of their AAAIs and participants on the network is an essential feature of the present technology which not only accelerates the development of AGI, but also makes AGI safer by providing a mechanism for the ethical values of millions of humans to be adopted by and reflected in the AGI.

One implementation of the AAAI system of the present technology has a focus on safety and is implemented via five sub-systems and associated methods, as illustrated in FIG. 1. The five sub-systems of the AAAI system are: 1) AAAI Customization, 2) AAAI Architecture, 3) AAAI Network, 4) AAAI Integration, 5) AAAI Improvement. The acronym SCAN-II (Safe, Customizable, Architecture and Network-Integrated and Improving) describes the present technology in the exemplary implementation. Other combinations of subsystems, and variations of each subsystem, are also possible. Safety features have been designed into each sub-system in an effort to provide redundant safety checks in the event one or more sub-systems are omitted from a particular implementation.

The five sub-systems of the AAAI system can be further described as:
1) A base level Large Language Model (LLM), Small Language Model (SML), or other AI system can be customized to reflect the knowledge of an individual, group of individuals, or organization and designated an Advanced Autonomous Artificial Intelligence (AAAI).
2) The customized AAAI can be enabled to participate in problem solving using a universal problem solving architecture that is compatible with both human and AI agents.
3) The problem solving-enabled AAAI participates in problem solving activity, including but not limited to:
   planning, problem solving, and other types of sequential, multi-step cognitive activity. on a network of intelligent agents;
   generate and select operators that reduce a difference between a current state of problem solving and a desired state based on the goal/subgoal;
   setting of a subgoal towards achieving the goal;
   utilizing hierarchy until an actionable goal is set that can be acted on by the operator; and
   analyzing the auditable record to determine recommendations for improvement of the problem solving process to achieve a solution to the goal/subgoal.
4) Multiple AAAIs, or PSIs. on the network can be integrated to achieve AGI; or AI capable of intelligent (or super-human level) behavior across a wide range of tasks.
5) The individual AAAIs, the problem solving network, and/or the integrated system of multiple AAAIs continuously improve via a variety of means, including but not limited to, redirecting the efforts of individual AAAIs and/or the integrated AGI towards the task of improving the system and/or components of the system.

The sub-systems or new sub-systems can include any one of or any combination of:
1) Safety/ethics check—Comparing a goal or subgoal against a list of prohibited attributes and assigning an ethics value based on a result of the comparison. Checking the goal/subgoal against a list of prohibited attributes. Combining values/safety information from AAAIs, using a set of approved criteria for a task by a user or by a regulatory agency or by AAAIs approved by human user. Establishing or using a threshold for the goal/subgoal to determine if the ethics value is unsafe, unethical, safe, or ethical. Determining if a sequence of individually safe goals/subgoals are unsafe or unethical when considered cumulatively. Determining whether a violation occurred reflects a predictive evaluation if the goal is to violate the ethical criteria. Recording any and all activity of the safety/ethics check in the auditable record.
2) AAAI matching—Detecting and identifying additional AAAIs that each have a criteria related to one or more goal or subgoal criteria.
3) Remembering and/or improving—Recording activity, comparing with successful or unsuccessful progress towards the problem solutions, determining which activity to keep active or forget.
4) AAAI learning—Learning, including a procedural learning process that utilizes information provided by intelligent entities such as human users equipped with computers or AAAIs. Recording activity, comparing with successful or unsuccessful progress towards the problem solutions, determining which activity to keep active or forget. Assigning credit value or blame value to a group of content of the problem solving activity. A set of prompts provided to the user and information received based on the prompts. Updating AAAIs with the group of content determined as active. The group of content can be, but not limited to, a set of prompts provided to the user and information received based on the prompts, all of which being recorded in the auditable record. Optionally, the problem solving activities can include the group of content.

### Example User Scenarios

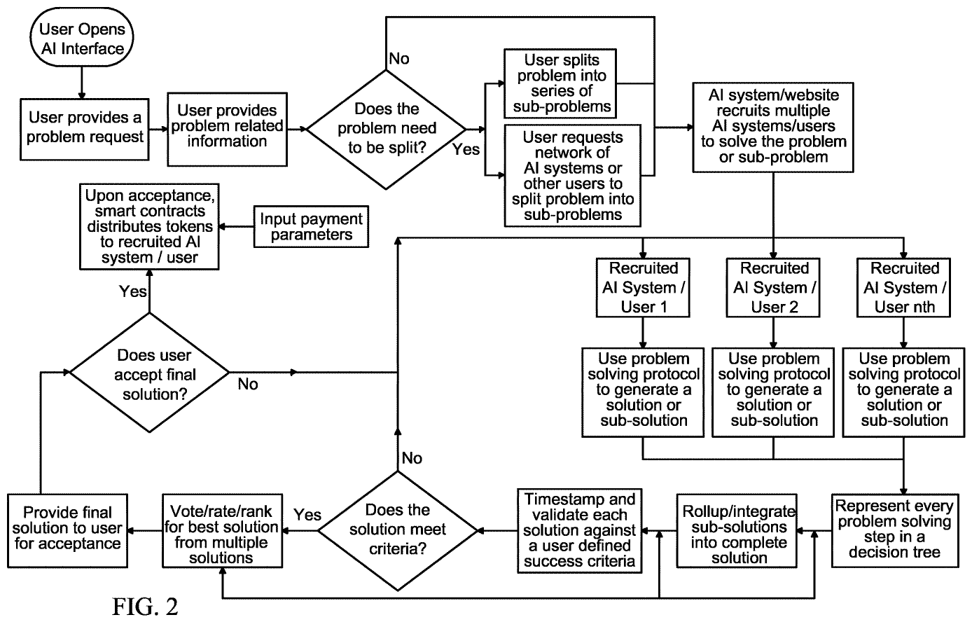

It may be helpful to describe some user scenarios that provide a sense of how the present technology can operate in some of the aspect implementations. An exemplary process is illustrated in FIGS. 2 & 3.

In one aspect, a user “visits” AAAI.com via the user's computer, cell phone, PDA, or goggles. AAAI.com would interact with the user via a web-based interface, a phone app, custom software for the PDA, or a metaverse/virtual reality environment. The mode of interaction could be physical via a keyboard, mouse, or gestural interface; voice-based via a microphone input coupled to natural language understanding and generation systems; or video-based as in the case where the user becomes an avatar in a virtual reality setting or in the metaverse.

The initial interaction would include setting up the user's account, which might be free or paid. This would involve an account name and password or other authentication mechanisms which might include, without limitation, biometric forms of ID such as fingerprint, face or voice recognition, and/or multi-factor authentication mechanisms such as software or hardware authenticators residing on a separate security device or on one of the user's existing devices.

For security, all communication between the user and the AAAI system could be encrypted via a VPN and/or could use other methods of encryption and security which are well known in the art of programming.

AAAI.com may request that the user set up payment capabilities via credit card, Pay Pal, Venmo, blockchain, ACH, or other payment mechanisms. These payment capabilities would allow funds, payments, and/or credits to be transmitted bi-directionally—from the user to the AAAI.com and also from the AAAI system to the user in cases where the AAAI system needs to pay or credit users for work efforts of their AAAIs or broker payments between users and/or between AAAIs on the AAAI network.

In one aspect of implementation, AAAI.com can have interfaces with other companies and vendors that the user might use—including, without limitation, and for example: Facebook, Instagram, Reels, Amazon, Apple, Microsoft, Google, and YouTube.

In the initial interaction with the user, and subsequently upon user request, AAAI.com would engage in a dialog or other interaction (which could include presenting the user with menu options, lists, graphics, sliders, buttons, and other user interface controls in a GUI, textual, haptic, voice, or VR-related manner) with the user to determine the user's goals and objectives in using the AAAI system.

For example, some of the objectives a user may have in using AAAI.com may include creating and customizing their own AI (known as an AAAI) for purposes that might include, without limitation:
Serving the user as an advisor, teacher, or companion.
Representing the user in negotiations, interactions, discussion, and transactions with other users, or with the AAAIs of other users; or with vendors and other companies.
Working on behalf of the user for compensation, or in volunteer efforts, where such work includes online intellectual, advising, or problem-solving work across a wide range of tasks.
Duplicating or “cloning” the user's AAAI so that several or many of the cloned AAAIs can work on behalf of the user in parallel, including interacting with, teaching, and improving each other so that the cloned AAAIs increase their knowledge, skills, and abilities.
Serving as legacy AAAIs that can continue to interact with the world, including potentially comforting living relatives and friends, after the owner's death.
Contributing knowledge, ethics, and effort to AAAI.com's AGI, and improving the base level of AI or AGI that AAAI.com can offer users before those users add their unique customizations.
Working with other users'AAAI to help ensure ethical and safe behavior by AGI by contributing ethical information and values to the AGI and participating in monitoring, review, supervision, and voting processes that can help ensure the AGI remains safe and ethical.

In the dialog or interaction with the user, the AAAI system will also identify constraints and resources available for customizing the user's AAAI. For example, some of these constraints and resources, might include, without limitation:
The amount of training and/or supervisory time that the user has to devote to customizing their AAAI.
The amount of financial resources the user is willing devote to customizing their AAAI.
Availability of social media information such as Facebook profiles and timelines, Instagram profiles and histories, Reels, TikTok, and YouTube videos, tweet and text content and histories, emails and email histories, cookies collected by advertisers, blog posts, articles, books, patents, audio and video recordings, pictures, and other information about, and/or collected by, the user or third parties that could be used to train, tune, or customize the user's AAAI.
Availability and use of personality tests, such as the Myers-Briggs personality inventory, skills and knowledge assessments, standardized tests, exams, certifications, and other types of assessments and questionnaires which could be given online (or which have already been given) to the user.
Availability and use of other knowledge bases and training data from users on the AAAI platform that could be used to train, tune, or customize the user's AAAI.
Other human users, and/or their AAAIs, available to help train, tune, or customize the user's AAAI.
Other texts and information, individual texts, and libraries selected by the user or by the system for purposes of training the user's AAAI. For example, the Bible, Koran, Dhammpada, Mahabharata, or other spiritual/ethical/religious texts might be selected for training the AAAI based on the user's religious preferences; books on plumbing might be selected if the AAAI will be used to primarily solve online plumbing problems. Even if these materials are part of the base AAAI that is provided to the user, emphasizing certain texts or subsets of information for additional training can result in the user's AAAI's behavior being more reflective of how a plumber, or Muslim, or Christian might behave, for example.

In addition to specifying objectives, resources, and constraints via an interactive dialog or other interaction with the system, the user or system may want to specify other technical parameters that affect the training or customization process. These parameters can include, without limitation:
The type of training, tuning, or other ML algorithms that are used.
The type and size of the training dataset(s).
The degree to which the training materials are to be “cleaned”, formatted, labelled, or otherwise processed before customization begins.
The number of training “epochs” or iterations through the learning algorithm(s).
The sophistication and type of base model(s) being customized or trained.
The required timeframe for training—e.g., must be completed in a minute, a day, a week which might have implications for cost and resources used.
The “temperature” or other parameters internal and specific to various machine learning algorithms that can affect what is learned and how it is learned including, without limitation, how literal or how divergent or “creative” the customized AAAI will be in its responses.
Whether “one shot”, “few shot”, or extensive training is to be used.
The amount of human and/or AI supervision to be used in the customization process.

Once the user's AAAI is customized, the user can clone it and/or put it to work on the user's behalf on the online network. The user's AAAI can begin acting on the user's behalf making travel arrangements (for example), providing advice, interacting with other AAAIs, participating in the collective AGI efforts by contributing problem solving as well as ethical information, and potentially earning money on behalf of the human user.

### Simple Exemplary Implementation

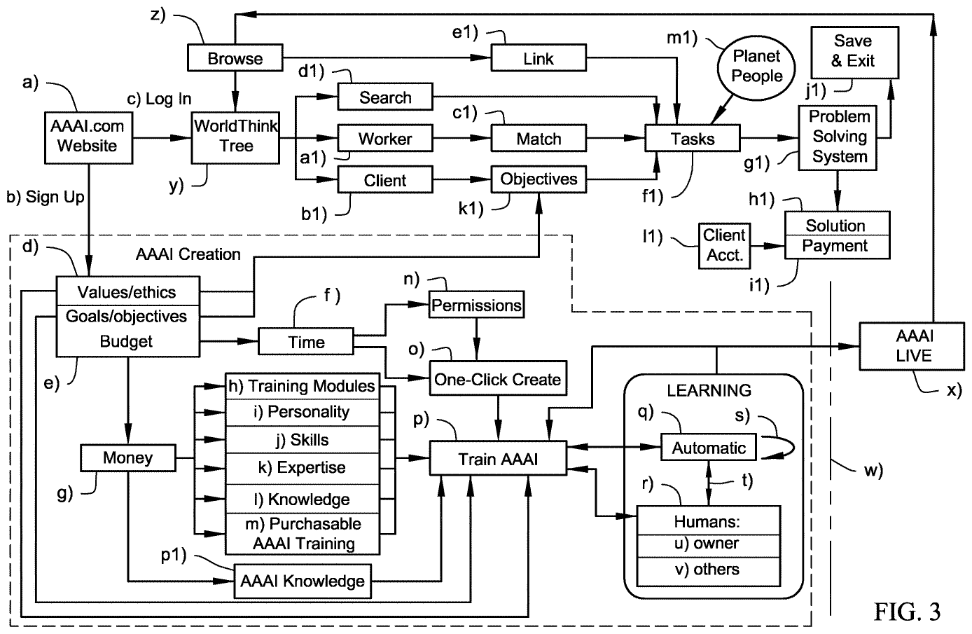

FIG. 3 shows one simple exemplary implementation of the system and methods for creating an ethical and safe Artificial General Intelligence from the collective intelligence of AAAIs and humans. This simple implementation is compatible with all of the company and platform specific scenarios outlined above, as well as with many other potential integration scenarios. FIG. 3 shows how AGI can be implemented using existing technology in a way that is synergistic with the products and platforms of many existing technology companies.

A (human. AAAI, or other intelligent entity) user visits the AAAI.com website (a). The website informs users and offers them two actions: Sign Up (b) or Login (c).

If the user opts to Sign Up then a dialog is initiated which extracts user values/ethics (d), user goals and objectives (e) and user budget for time (f) and money (g). All users must allocate some time (f). Users have the option of creating a free AAAI or allocating a money budget.

If users have allocated a money budget (g) they are given the opportunity to purchase pre-trained AAAIs or training modules (h) with specific personalities (i), skills (j), expertise (k) or knowledge (l). They also have the opportunity of buying training from other AAAIs on the network (m).

After making time (and optionally money budget (h, I, j, k, l, m)) allocation decisions, the user proceeds to an overview of the creation process and then is asked for user permissions (n) to optionally logon and use existing social media, twitter, and other vendor accounts to gather user data for “one click” training of the user's AAAI. After the user opts to use certain (or no) data, with a single click (o) the user directs system to create AAAI. The AAAI is an off-the-shelf LLM (e.g., GPT X, BARD, Llama, Gemini, Grok, or any closed-source or open-sourced AI agent) that is trained/tuned on a dataset prepared automatically from all the user data authorized by the user. If no data was authorized, the AAAI is just the “off-the-shelf” LLM.

The AAAI now begins to learn (p). There are two main ways of learning, automatic (q) and human (r).

Automatic learning includes, without limitation, learning by interacting with copies of itself (s), learning via interactions with other (optionally supervised) AAAIs (t).

Human learning includes interaction with humans, either the owner (u) or other humans on the network (v).

Both humans and AAAIs can supervise learning of an AAAI. After each (automatic or human) learning interaction, the system attempts to improve the AAAI's performance by further prompt modification, tuning, and/or training. Based on many cycles of human and AAAI input aimed at teaching and improving the AAAI, the user's AAAI gets smarter.

At any time, the user can purchase additional training modules (h) that have been proven to increase an AAAIs abilities.

The human sets a performance criteria (w) after which the AAAI goes LIVE (x).

Once live, the AAAI can visit the WorldThink Tree (y) and Browse (z).

The AAAI can enter the tree as either a worker (a1) or a client (b1).

Workers are automatically matched (c1) to tasks or they can select a specific task via search (d1) or linking (e1) from the browsing tree. Once they have accepted a task (f1), they participate in the problem-solving module (g1) until a solution is reached (h1) and payment made (i1) or the user saves credit for work done and exits the tree (j1).

Clients (b1) can specify objectives (k1) which are combined with the values/ethics (d), and prior goals and objectives (e) for the system to solve.

The client can request that only his/her/their AAAI be used in which case problem-solving is free. Alternatively, the client can use the AGI capability of the entire network, in which case the system compensates individual AAAIs for their work and passes the solution (at cost+markup) to the client, debiting the client account (l1).

The system can also place non-profit humanitarian and ecologically-oriented tasks, as well as tasks that are part of Planetary Intelligence, on the WorldThink Tree (m1).

Clients might (optionally) authorize the system to use copies of their AAAI and data for these purposes without renumeration in exchange for maintaining and operating the free AAAI network when they created their AAAI (n).

### Additional Comments on Exemplary Implementation Shown in FIG. 3

We now provide additional comments on the various elements of FIG. 3, including without limitation, some potential integration points with the illustrative partners mentioned above.

The “website” (a) could be hosted on Amazon AWS, Microsoft Azure, Google Cloud, Apple Cloud, Nvidia datacenter offerings—or could have native implementation on the platforms of any large tech company. “website” could also be an “app” in the AppStore or other App marketplace. It could be a government-sponsored, nonprofit, or other globally-accessible technology that is able, directly or indirectly, to link some of the attention of all human beings who wish to participate. Also, browser plug-ins could be used whereby AAAIs learn from users as they go about normal tasks on the internet and the plug-in records their activity, creates training files, and trains the AAAIs with these files. The “website” could also be an API or other means for connecting AAAIs or non-human intelligent entities directly to the network.

Sign Up or

Login (c)—could be via Facebook, Instagram, Apple, Microsoft, Google, You Tube, Tik Tok, Amazon, or any other partner ID scheme. Multi-factor authentication and all best ID and security practices enabled. In the event of a browser plug-ins or apps, login to these technologies could serve as login to the AAAI account.

Values and ethics (d) are elicited via a series of scenarios that have been customized for the user and that are generated dynamically based on user responses. Data from partners, including navigation and click data, online posts, tweets, texts, and emails, videos, and other user-data is analyzed for behavior patterns—actions or speech or interactions—that translate into a moral code or ethical value system can also be used as part of the ethics/value profile. Values/ethics and goals/objectives (d) can be combined with Client objectives (k1) in order to create, or find, matching tasks on The WorldThink Tree (y) that are proposed or (potentially have been solved) in the Problem Solving System (g1).

Goals and objectives (g), together with the budget of time and/or money allocated to reach objectives are elicited via a series of dialogs and/or custom interactions with the system. Budget refers to overall resource budget which includes User Time and User Money that can be allocated towards training, supervising, and improving the User's AAAI. Goals and objectives are helpful in determining the initial parameters for the AAAI creation and identifying Training Modules (h) or other knowledge (i-m) that might create the most useful AAAI for the user's goals. Data from partners, reflecting user preferences and other user behavioral information, could also be used by the system to help infer or deduce user goals and objectives.

Time (f) refers to the user's time that can be devoted to training and supervising the user's AAAI, and/or problem-solving by the user on the problem-solving network. By supervising the AAAI, users can ensure that their AAAIs meet client goals and expectations—especially in areas where the AAAIs get stuck (e.g., they lack the knowledge to complete problem-solving on their own). Also representing problems and breaking down large tasks into smaller ones by, without limitation, determining goals and sub goals, are ways that human users can assist their AAAIs in problem-solving. Generally, by providing human expertise in areas where AAAIs are not as proficient as humans, overall problem-solving and the overall effectiveness of the AGI network is increased.

(g, l1) “money”: Could be payment solutions with Apple Pay, WePay, Amazon, Google Pay, or any vendor supporting payment solutions as well as blockchain, credit card, ACH, and other solutions. Although payment (j) is indicated as debiting the client account (l1), of course the worker's account would also be credited. Generally, a user's account can be viewed as both a client account and worker account, with both credits and debits being allowed depending on the role of the user (or the user's AAAI) in a particular instance. That is, a user might be a client in some cases, paying the system or other specific AAAIs for their services, and that same user could be a worker, collecting fees for the services of the user (or the user's AAAI) in other cases. The money module (g) enables functionality such as setting up payment methods, setting a budget for automatic payments, limiting authority of the user's AAAI to spending only $X amount without additional approval, and other payment-related capabilities which are well known in the art.

(h, i, j, k, l) Training modules (h) could be offered by AAAI.com or by third party partners, including, without limitation, any of the potential partners and tech companies listed above. Training modules can be targeted at different knowledge areas ranging from personality (i), specific skills (e.g., plumbing, legal, accounting) (j), expertise (e.g., consulting) (k), and knowledge (e.g., historical knowledge, knowledge of a specific business or organization's practices, cultural knowledge) (l).

(m) AAAI knowledge is a specific type of knowledge that has been already learned by other AAAIs, and which can be transferred to a new user AAAI. Such knowledge may not be packaged in the form of a module (e.g., module on accounting) but rather as specific to another AAAI(s) as in “everything John's AAAI knows” or “the personality of John's AAAI” or “the combined knowledge of all AAAIs with a reputation of 5 stars or higher in the domain of plumbing”.

(n) Permissions refers not only to the permission that a user might give to access all data on specific other vendor (or partner) sites (e.g., “all my Facebook data”) but also permissions that a user gives to his/her/their AAAI in terms of abilities to logon and transact business on various sites, including, without limitation, the abilities to make transactions up to a certain amount via payment mechanisms. Permissions may also include authorizing the system to make clones of a user's AAAI for non-profit purposes and for the purpose of aggregating knowledge form individual AAAIs to create AGI-level AI.

(o) One click create is a non-limiting example that provides an easy and fast way to customize an AAAI using data gathered automatically from all the places where a user has given permission for the system to access the user's data. It can be appreciated that other means can be utilized by the present technology to customize the AAAI. For example, if the user gives permission (n) to access the user's Facebook data, then “one click create” (o) would either download the data from Facebook, if Facebook was a partner that had an API for downloading that user's data, or logon to the user's Facebook account as the user and “scrape” relevant data from the user's account. Then the system would automatically parse the data gathered and transform it into a dataset suitable for training/tuning a base AI, such as a LLM (e.g., GPT X). Then the system would train/tune the LLM and produce a customized AAAI which could be improved and refined via additional training/tuning and interaction with the user and/or other AAAIs.

(p) Training refers to the process whereby the AAAI is trained or tuned on data, including feedback from the user, other humans, and/or AAAIs (including, without limitation, copies of, and variants of, itself).

(q, r, s, t, u, v) Automatic learning does not require the human user's intervention and can proceed very quickly. Typically, this would involve the method of an AAAI interacting with copies (or variants) of itself as well as with (optionally) other AAAIs in order to improve via the interactions. If humans are sometimes involved in the training loop (t) that can help the automatic learning progress more quickly in places where automatic learning alone is not making efficient progress. The learning can also take place via rapid iteration among AAAI interactions(s). Just a chess AI can quickly evolve from novice to Grandmaster ability by simulating millions of chess games very quickly, an AAAI can quickly evolve its abilities by simulating many millions of interaction scenarios. To the degree that such simulations require financial resources to pay for the computation involved, the money budget (g) can set limits.

Humans (or AAAIs) can specifically target types of scenarios for automatic learning so that the AAAI can be trained in narrow areas of expertise, or in areas of more general expertise, depending on the need and resources of the user. With partner integration, it is possible to work backwards from the types of jobs that are available on a partner marketplace (e.g., Amazon's Mechanical Turk) to guide the training of AAAIs so that they focus on learning the skills that generate the most amount of earnings for the AAAI when it is put to work on available jobs. This “just in time” learning/training/tuning approach generates AAAIs “on demand” with the skill sets that are needed at any particular point in time.

Humans (r) that interact with the AAAI can be the owners (u) of the AAAI (in which case no fees are typically charged since the user is training his/her/their own AAAI) or other professional humans (v) who are expert at training AAAIs and who may charge fees in order to guide the human and/or automatic training/tuning of an AAAI for a user who does not wish to spend the time, or who lacks the expertise, to do so.

(w, x) The user (owner of the AAAI) can set various performance criteria (w) that must be met before the user is willing to make his/her/their AAAI “live” (x) and accessible to perform tasks on The WorldThink Tree. (Some of) these criteria might also be set by partners and other third parties that have minimum standard before allowing AAAIs to work on their platforms, products, applications, or networks.

(y, z, a1, b1) The WorldThink Tree is a massive tree data structure, composed of many sub-trees, which represents every problem and task that has been done, is being worked on, or has been proposed for the overall AGI system. This Tree is browsable (z). Individual AAAIs and/or humans can work on specific tasks within the tree. The tree structure provides an auditable trail of all problem-solving activity which is also useful for learning via the proceduralization mechanism described above. When interacting with the tree, the two main roles an agent can take are either: Worker (a1) or Client (b1). Regulatory agencies or third parties that monitor performance, safety, and/or ethics of the system are another role that might be thought of as a special type of client. Workers are generally involved in solving open problems or subproblems on the tree. Clients are generally involved in specifying the problems, goals, objectives, and other parameters (e.g., rewards, budget, timeframe, success criteria, quality metrics) that constrain problem-solving.

(c1) Workers are automatically matched to tasks on the tree based on the data about the worker that may include, without limitation, the worker's skills, expertise, knowledge, past experience, reputation, fees or cost, availability, and response time. Workers can be human or AAAIs. Workers can be matched and recruited from partners (e.g., LinkedIn, Mechanical Turk, Facebook) that have data on human users and/or their AAAIs. Workers can also be recruited via online ads offering work on various tasks and targeted to potential workers using ad-targeting mechanism that are well known in the art or described in other patents by the applicant.

(d1) Workers might also search the WorldThink Tree, looking for tasks that are of interest or that match their skills. This search could be manual or automated (as in the case for AAAI workers).

(a1) Workers and Clients (b1) can also browse (z) the WorldThink Tree, looking for tasks or problems that are of interest. The workers or clients could then click to link (e1) to specific parts of the tree to obtain detailed information about the problem solving occurring (or proposed) for that part of the tree. They could link to sign up to work or could propose additional tasks as clients that build upon existing problem solving work.

(f1, g1, k1) Clients can interact with the system to specify specific goals, objectives (k1), and tasks that they want to accomplish. The problem specification interaction results in the problems, tasks, and goals being formulated (f1) and placed on the WorldThink Tree (y) for problem solving using the problem solving system (g1).

(m1) The system has the ability to formulate certain goals, problems and tasks relating to general efforts to help people or the planet. These can be worked on with rewards in a “for profit” mode, and also worked on using cloned AAAIs and volunteer human effort in a “non-profit” mode. Some problems may be related to the general goal of enabling a global AGI to act on behalf of the planet and its people using its intelligence on a Planetwide basis (aka “Planetary Intelligence,”). Various partner organizations—including non-profits, governments, and charitable organizations—might “plug in” their tasks, problems, goals, and objectives here (m1).

(g1) The problem solving system, refers to the problem solving architecture and system outlined by Newell and Simon (HPS) and improved upon by the applicant, the Online Distributed Problem Solving System (ODPS) patent invented by the applicant, the WorldThink Whitepaper authored by the applicant, this and other PPAs related to AAAI, together with modifications and variations to reflect different modes of reward, payment, and operation.

To the degree that activity on certain other online work systems (e.g., Mechanical Turk) can be automatically mapped to the general applicant-improved HPS/WorldThink problem solving framework, entire problems and the associated problem solving activity can be “lifted” from partner and other sites and the data can populate the WorldThink Tree to increase its comprehensiveness.

To the degree that other applications, products, systems, and online capabilities can help solve problems (e.g., use of a travel reservation system, a robo advisor app, a traffic app, an online ordering system) these capabilities can be referenced and called as “operators” (in a way similar to procedure calls in programming languages) to advance the problem solving. Thus, problem solving does not rely solely on operators developed by the human or AAAI solvers working on the tree but can include any online of offline technology or means to advance problem solving provided that these means can be referenced and/or linked to via the WorldThink tree at the appropriate place in problem solving.

(h1) When a solution has been achieved, the Client can review the solution prior to releasing the reward (if any) for the solution. Alternatively, if solution success criteria have been automated, human client review may be unnecessary, and the rewards can be automatically released when success criteria have been met. This automated approach can be implemented via “smart contracts” using blockchain technology or via more centralized means, depending on client and worker preferences.

Upon solution and (optional) payment of reward (as some problems are non-profit or volunteer, or performed by the user's own AAAI) there can be opportunities for feedback from both client(s) and worker(s) following a range of methods well-known in the art. The solution is also “chunked” and proceduralized so that the overall system learns the solution to the particular problem as well as the key features of that problem so that the solution path can be indexed for retrieval, and accessed and re-used when similar problems arise in the future.

Optionally, royalties may be enabled so that if a user's or the user's AAAI's solution is re-used, a fee is paid to that user in the form of a royalty on the solution. Such royalties can (optionally) be made using “smart contract” on the blockchain or via other payment methods.

(j1) Problem solving need not be completed in one session. Partial progress on a solution may be made, in which case when the human or AAAI solver exits the problem solving system, the progress is saved and data is stored that credits the solver for progress made thus far, even if such progress has not advanced to the point where a reward is payable.

The World Think protocol is a problem-solving architecture that can be used by AAAI.com to serve as a universal problem solving architecture as it incorporates the general architecture of HPS while adding features to overcome certain challenges.

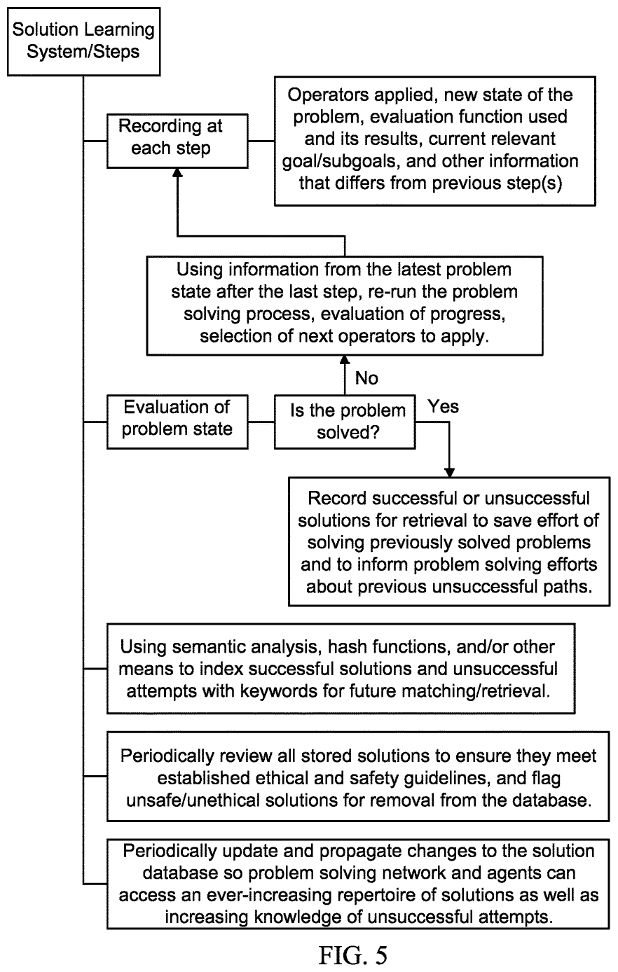

In some embodiments and as generally illustrated in FIG. 5, the procedural learning process can occur within the common cognitive architecture.

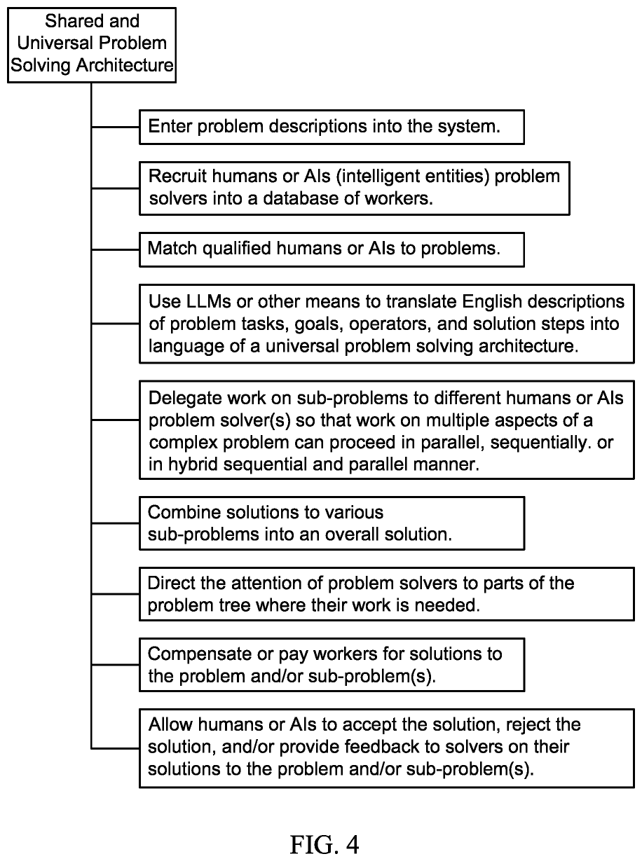

The shared and universal problem solving architecture, illustrated in FIGS. 4, 6, and 10 can be exemplified by the following scenario, mentioning humans but also applicable generally to any intelligent entities.
1) Problem descriptions can be entered into the AAAI.
2) Then human (or intelligent entity) problem solvers can be identified and recruited into a database or data source of human workers.
3) Qualified humans or intelligent entities can be matched to problems.
4) Use LLMs or other means to translate English descriptions of problem tasks, goals, operators, and solution steps into language of a universal problem solving architecture.
5) Delegate work on sub-problems to different human (or intelligent entity) problem solver(s) so that work on multiple aspects of a complex problem can proceed in parallel.
6) Combine solutions to various sub-problems into an overall solution.
7) Direct the attention of problem solvers to parts of the problem tree where their work is needed.
8) Compensate or pay workers for solutions to the problem and/or sub-problem(s).
9) Allowing human user to accept the solution, reject the solution, and/or provide feedback to solvers on their solutions to the problem and/or sub-problem(s).

Referring to FIG. 5, the steps of solution learning can be exemplified with the recording at each step of the learning process operators applied, new state of the problem, evaluation function used and its results, current relevant goal/subgoals, and other information that differs from previous step(s). The state of the problem or problem state can be evaluated to determine if the problem is solved. If not, then using information from the latest problem state after the last step, re-run the problem-solving process, evaluation of progress, and selection of next operators to apply. After which, the process can return to the step of recording.

If the problem is solved, then record successful or unsuccessful solutions for retrieval to save effort of solving previously solved problems and to inform problems solving efforts about previous unsuccessful paths.

Successful solutions and unsuccessful attempts with keywords for future matching/retrieval can be indexed using semantic analysis, hash functions, and/or other means.

A periodical review of all stored solutions can be implemented to ensure they meet established ethical and safety guidelines, and flag unsafe/unethical solutions for removal from the database or data source.

Periodically update and propagate changes to the solution database so problem-solving network and agents can access an ever-increasing repertoire of solutions as well as increasing knowledge of unsuccessful attempts.

Referring to FIGS. 3, 4, 6 & 7, the present technology can include a utilization of a network of multiple intelligent entities including human workers in combination with a universal problem solving architecture. The multiple intelligent entities are matched to a problem request based on a problem criteria using a database or data source including a list of human and/or AI problem solvers. Any part of the problem request can be translated into an unambiguous language utilizing a universal problem solving architecture including the decision tree.

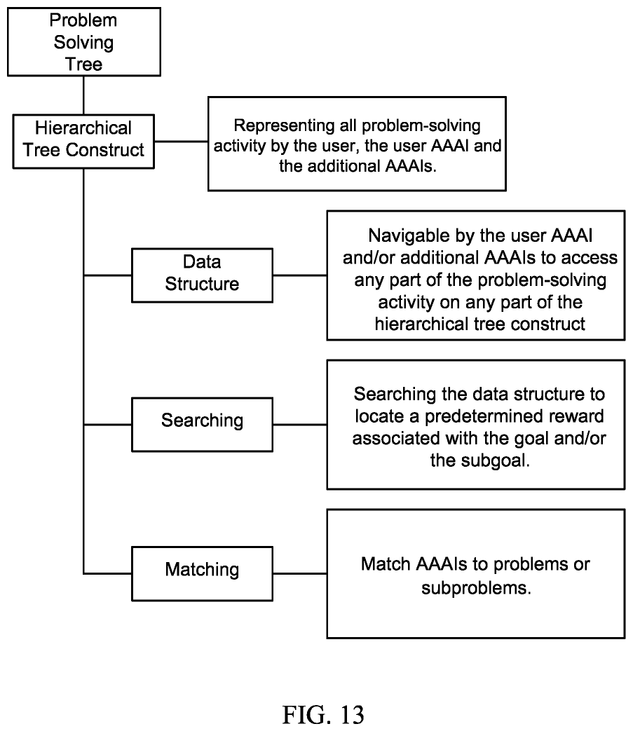

A sub-problem of the problem request can be delegated to one or more of the matched intelligent entities so that work on the sub-problem proceeds independently from each other and parallel with each other, as further illustrated in FIG. 12. The universal problem solving architecture is utilized in a problem solving process on the sub-problems, respectively, to create one or more sub-solutions.

Any one of or any combination of the intelligent entities can provide in natural language a description of any one of or any combination of a current problem state, a goal of the problem request, relevant problem solving information, and a next step that the human (or intelligent entity) workers will take in the problem solving process.

The sub-solutions can be received from each of the matched intelligent entities for the sub-problem delegated thereto. Any one of or any combination of the sub-solutions and an overall solution can be provided to any one of or any combination of a user interface of a user AI system or the intelligent entities.

Parsing and translating, by the intelligent entities, the natural language description into the unambiguous language can be utilized by the decision tree of the universal problem solving architecture.

In some embodiments, if the intelligent entities are unable to specify a problem state, including relevant operators and information needed to take a next step in the problem solving process based on the parsing and the translation, then the intelligent entities can engage in dialog with at least one of the human workers until a precise problem state is specified.

Some embodiments the problem solving process can be repeated until the overall solution is accepted or resources are exhausted. The matched human (or intelligent entity) workers can be compensated for the sub-solutions, respectively. Further, a reputation attribute can be assigned to any one of or any combination of the human (or intelligent entity) workers and the worker AI system.

In some embodiments, the solving process can include a series of problem state transitions from an initial problem state where there is a goal to a final solution state where the goal has been achieved, and wherein a series of decisions are made by the problem solving process and actions taken that applies operators that enable the human workers to transition from state to state until the final solution state is reached.

Referring to FIGS. 4 & 10, the present technology can include a utilization of a network of human (or intelligent entity) users in combination with a universal problem solving architecture. The multiple human (or intelligent entity) users are matched to a problem request based on a problem criteria using a database or data source including a list of human and/or AI problem solvers.

A sub-problem of the problem request can be delegated to one or more of the matched intelligent entities so that work on the sub-problem proceeds independently from each other and parallel with each other, as further illustrated in FIG. 12. The universal problem solving architecture is utilized in a problem solving process on the sub-problems, respectively, to create one or more sub-solutions.

The sub-solutions from each of the matched human (or intelligent entity) workers can be provided for the sub-problems delegated thereto. The matched human (or intelligent entity) workers for the sub-solutions can be compensated, respectively.

Any one of or any combination of the sub-solutions and an overall solution can then be provided to a user interface of a user AI system or any other AI system.

The human (or intelligent entity) user is allowed to accept the overall solution, reject the overall solution, and/or provide feedback to any one of the matched human (or intelligent entity) workers on any one of the sub-solutions.

A reputation attribute can be assigned to the human (or intelligent entity) workers and/or the worker AI system. The reputation attribute can include metrics on any one of or any combination of a time to the sub-solutions, a difficulty value of the problem request, short and long-term user satisfaction with the sub-solutions, a number of times any one of the sub-solutions has been re-used on the network, a rating other human (or intelligent entity) workers, a responsiveness value of the human (or intelligent entity) workers, and a reliability value of the human (or intelligent entity) workers.

Some embodiments can include using the reputation attribute in the matching of the human (or intelligent entity) workers to the problem request using an algorithm to the delegation of the sub-problems, and/or compensating the matched (or intelligent entity) human workers for the sub-solutions, respectively.

In some embodiments, the algorithm can use a hierarchy of the metrics that is preset by a human user of the problem request.

Some embodiments can include recording information on each step of the problem solving process by the human (or intelligent entity) workers or the worker AI system.

Some embodiments can include recording a criteria of the recorded step of the problem solving process, the criteria being a time taken for each step.

Some embodiments can include analyzing the recorded information after the overall solution is accepted or after the problem solving process is complete, and updating the metrics of the reputation attribute.

Some embodiments can include soliciting, at predetermined intervals after the overall solution or the sub-solutions are provided to the user interface, a survey for user satisfaction information to obtain short and long-term satisfaction metrics that are used to update the reputation attribute of one or more of the human (or intelligent entity) workers or the worker AI system.

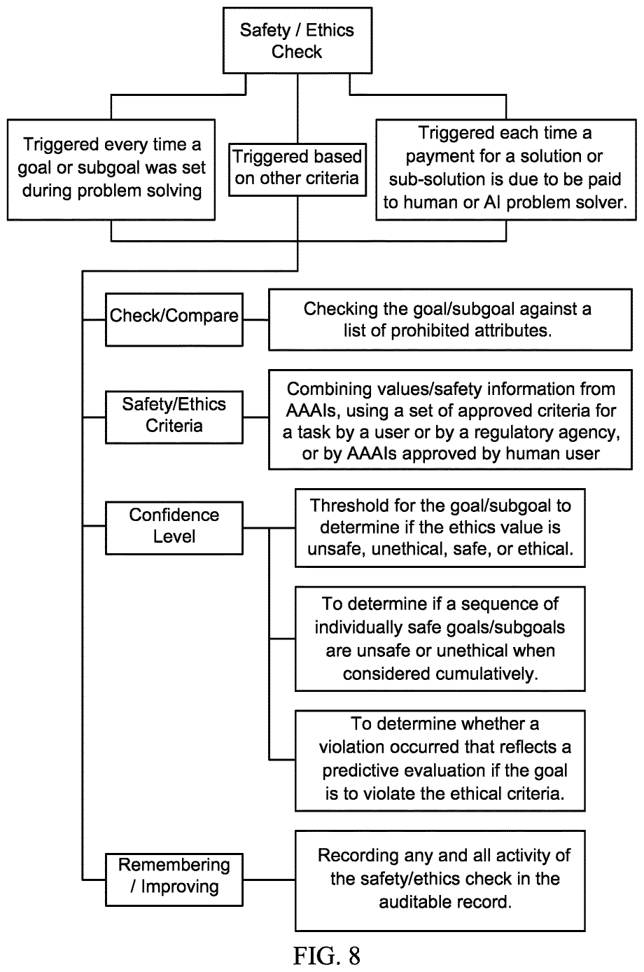

Referring to FIG. 8, the present technology can include a utilization of human users and AI systems, which includes an execution of a scalable safety/ethics check on any one of or any combination of a goal, and a solution for the goal provided by any one of or any combination of the intelligent entities including any one of or combination of human users each using a computer system and AI systems.

The goal and/or the solution can be compared against prohibited attributes, and an ethics value can be assigned to the goal and/or the solution based a result of the comparison and/or an ethics criteria.

Based on the result of the comparison, a common cognitive architecture including one or more problem solving protocols can be conducted on the goal to create the solution and thereby creating an AGI. The results of the comparison and the solution can be provided to any one of the intelligent entities.

In some embodiments, the ethics check can be performed at any one of or any combination of when the goal is provided, and periodically from when the goal is provided to when the solution is provided.

In some embodiments, the ethics criteria can be determined by any one of or any combination of combining values and safety information from one or more of the intelligent entities, using a set of approved ethics criteria mandated for a particular task by a user or by a regulatory agency. It can further be provided by any one of the additional intelligent entities and validated or approved by the human user.

In some embodiments, the ethics criteria can include a confidence level threshold for the goal so that the ethics value is determined as any one of an unsafe goal, an unethical goal, a safe goal, and an ethical goal.

In some embodiments, the confidence level threshold can be further utilized to determine if a sequence of individually safe goals is unsafe or unethical when considered cumulatively.

In some embodiments, the confidence level threshold can be utilized to determine whether a violation occurred that reflects a predictive evaluation if the goal is to violate the ethics criteria.

In some embodiments, a candidate goal can be proposed based on the ethics value, and the candidate goal is compared against the prohibited attributes.

In some embodiments, the results of the comparison can be recorded in an auditable record for use in the determining which problem solving activity leads to the solution to keep active.

Further referring to FIG. 8, the scalable ethics check can compare any one of or any combination of the problem request, the sub-problem and the sub-solutions against prohibited attributes and assign an ethics value based on any one of or any combination of a result of the comparison, and an ethics criteria.

In some embodiments, the step of the ethics check can be triggered every time the problem request or the any one of the sub-problems is set by the human (or intelligent entity) user, and/or triggered each time compensation is provided to the matched human (or intelligent entity) workers.

The goal/subgoal can be compared against a list of prohibited attributes. The ethics criteria can be determined by any one of or any combination of combining values and safety information from any one of the AAAIs. Combining values/safety information from AAAIs, using a set of approved criteria for a task by a user or by a regulatory agency, or by AAAIs approved by human user.

The ethics criteria can include a confidence level threshold for the problem request so that the ethics value is determined as any one of an unsafe goal, an unethical goal, a safe goal, and an ethical goal. The confidence level threshold can be further utilized to determine if a sequence of individually safe goals is unsafe or unethical when considered cumulatively.

In some embodiments, the confidence level threshold can be utilized to determine whether a violation occurred that reflects a predictive evaluation if the goal is to violate the ethics criteria. Any and all activity of the safety/ethics check can be recorded in the auditable record.

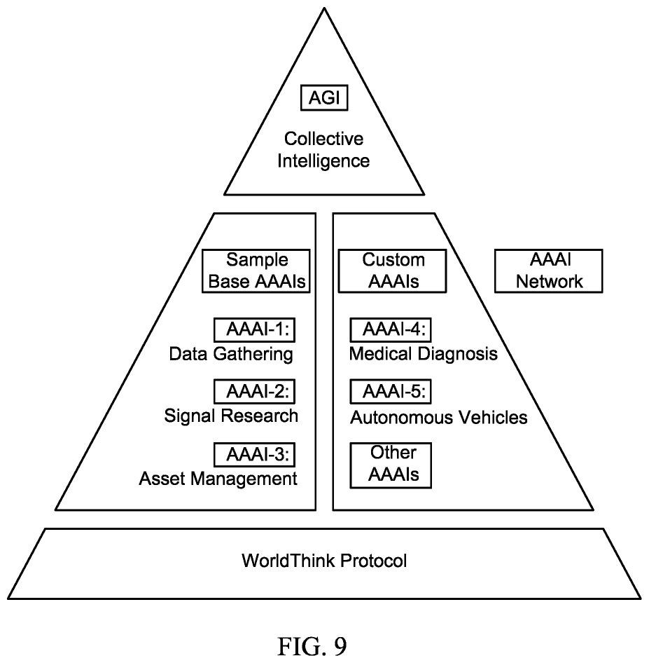

FIGS. 9-13 provides a simple exemplary framework for understanding the WorldThink protocol. In the implementation using the WorldThink protocol, clients pay for solutions using tokens. The solutions are produced by harnessing the collective power of many human (and machine, or AAAI) intelligences. Clients can use different domain-specific AAAIs for different types of problems.

The WorldThink protocol is the foundation of the pyramid. The protocol layer provides an (optionally, Ethereum or blockchain based) infrastructure that makes it much easier for developers to build and scale customized problem-solving AAAIs. The protocol enables re-use of solutions within and across AAAIs. It also handles payment of royalties via smart contracts, reputation metrics, and other functionality that assists AAAI customizers and developers and promotes network effects.

FIG. 9 a diagram illustrating various use cases for domain-specific problems which depend upon the underlying WorldThink protocol, and which together help form the basis for an AAAI and/or AGI system capable of solving a wide range of problems. At the top of the pyramid are Collective Intelligence Solutions. Integrating the Collective Intelligence of AAAIs (and human problem solving agents) is the means to achieve AGI, as discussed earlier.

In the implementation using the WorldThink protocol, clients pay for solutions using tokens. The solutions are produced by harnessing the collective power of many human (and machine, or AAAI) intelligences. Clients can use different domain-specific AAAIs for different types of problems.

The WorldThink protocol is the foundation of the pyramid. The protocol layer provides an (optionally, Ethereum or blockchain based) infrastructure that makes it much easier for developers to build and scale customized problem solving AAAIs. The protocol enables re-use of solutions within and across AAAIs. It also handles payment of royalties via smart contracts, reputation metrics, and other functionality that assists AAAI customizers and developers and promotes network effects.

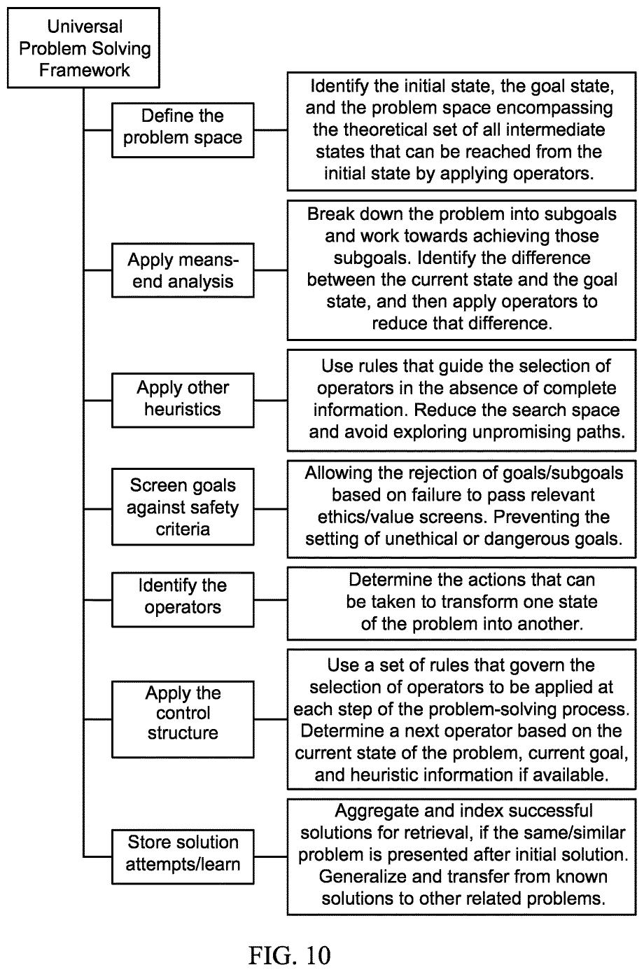

In the exemplary, FIG. 10 shows a simple exemplary universal problem solving framework under the common cognitive architecture, and which can include:
defining a problem space configured or configurable to support all possible states of the problem request, the states including any one of or any combination of an initial state, a goal state, and all intermediate states that can be reached from the initial state;
applying means-ends analysis on the problem request to break the problem request down into goals and subgoals by identifying a difference between the current state and the goal state, and then applying the operators to reduce the difference, a safety or ethics screening is applied each time the goals or the subgoals is set;
applying heuristic rules that are configured or configurable to guide the selection of the operators in an absence of the completion solution, the heuristic rules are used to reduce the problem space;
identifying one or more second operators configured or configurable to enact an action to transform one of the states into another state, the second operators move from the initial state to the goal state by changing a current state of the problem request;
applying a control structure including a set of rules that govern a selection of the second operators to be applied at each step of the problem solving protocols, and that determines which of the second operators to apply next based on the current state of the problem request and the goal state;
applying evaluation functions to determine an application of the second operators;
assigning a credit or blame value to the completion solution or sub-solution to the completion solution that enables tracing back and determining which of the second operators were most useful and also which of the evaluation functions led to success or failure of problem solving attempts;
recording of both successful and unsuccessful problem request solution attempts; and
analyzing the solution attempts to improve selection of the heuristic rules and the evaluation functions.

Existing collective intelligence approaches to problem solving have been largely limited to simple one-step approaches, such as those used by question and answer (Q&A) systems (e.g., Quora, Google Answers, Yahoo Answers). LLMs such as GPT also largely fall into the category of Q&A systems since they were designed to generate responses given an input, rather than to solve problems per se. While such Q&A systems have had some success at simply aggregating the responses of many online participants, these systems are not designed to handle complex, branching, multi-step problems. Simple aggregation of responses (or even betting on outcomes as seen in prediction market approaches such as Augur and Gnosis) is quite different from coordinating the efforts of many respondents to solve complex problems. The WorldThink protocol is specifically designed to overcome the challenges inherent in coordinating many intelligent entities to represent and solve complex, multi-step problems in an automated way that fairly rewards participants.

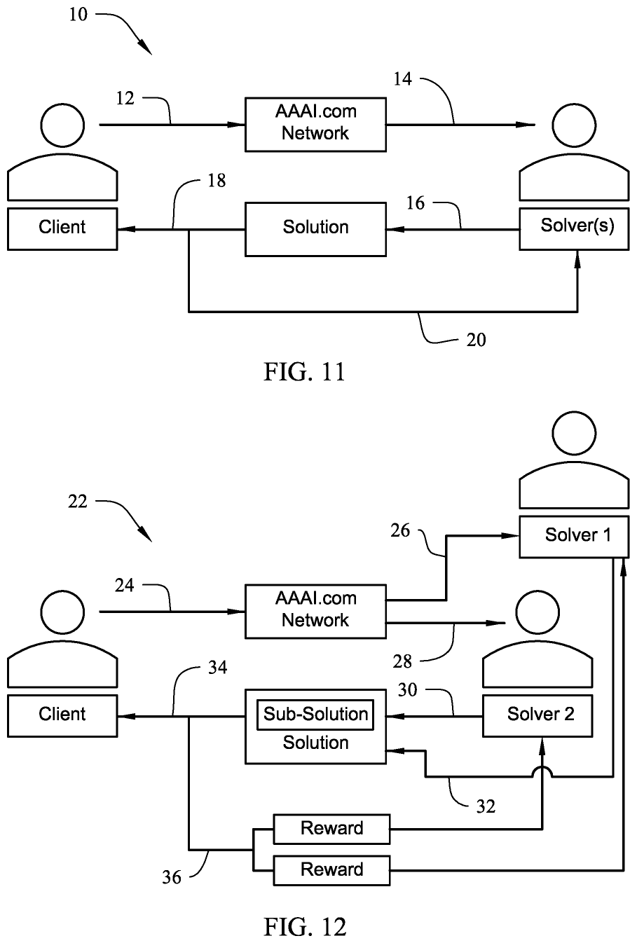

In the exemplary, FIG. 11 shows some of the basic problem-solving functionality supported by the WorldThink Protocol, generally referenced with numeral 10.

Problem solving begins when a client on AAAI.com submits a problem-solving request to the community of online participants (Step 12). All AAAIs, or human solvers, following the protocol gather certain standard information from the client. A partial list of this information can include: the name and description of the problem, the total reward that the client will pay for a successful solution to the problem, the criteria to determine whether a solution will be deemed successful, the time limit for solving the problem, the minimum and maximum number of problem solvers allowed to work on the problem simultaneously, qualifications required of participants working on the problem, which parts (if any) of the problem and solution will be confidential, whether the solution must be exclusive to the client or whether it can be re-used for others, and parameters relating to how to reward multiple problem solvers for their efforts and/or successful solutions.

The client can break complex problems down into a series of sub-problems or request that the community take on this task as part of the problem-solving effort. The client user-interface, which could be a dialog initiated by an AAAI can be customized by the AAAI owner, but the underlying data format is standard and specified by the WorldThink or ODPS protocol. Once the client has submitted a problem, AAAI.com can recruit participants using its own custom methods and/or leverage recruiting and reputational screening functionality that is built into the WorldThink protocol and thus shared by all AAAIs.

Solvers work on the problem following a rigorous structured problem-solving process that is common to all problem-solving agents and enforced by the WorldThink Protocol (Step 14). For example, each step in the problem-solving process must be in service of a named goal and must take a named action in order to transition the problem solving from the current state to the next state. Every problem-solving step is represented in a decision tree which is supported by the protocol (optionally captured in Ethereum logs) and which participants can view via AAAI.com.

When a Solver submits a complete solution (Step 16), it is timestamped and validated against the client's success criteria before being passed on to the client (Step 18) for final acceptance. Once the client accepts the solution, smart contracts can automatically distribute tokens to the problem solver based upon the problem payment parameters (Step 20) or other, more centralized, payment procedures can be used.

### Collaborative Problem Solving Using the WorldThink Protocol

In the exemplary, FIG. 12 shows the same steps in an example where two problem solvers (which could humans, AAAIs or a combination) collaborate to solve a client problem, as generally referenced with numeral 22. In this case, the overall problem has been broken down to include a sub-problem. Solver 1 has expertise in assembling an overall solution but cooperates with Solver 2, who provides a solution to the sub-problem (Steps 30 and 32). When the overall solution to the problem is submitted to the client (Step 34), rewards are paid to both Solvers (Step 36) based on the objective record of their contributions and the agreed upon payment parameters.

The WorldThink protocol supports breaking problems into sub-problems in several ways. First, the client may choose to specify sub-problems when submitting the overall problem (Step 24). Alternatively, Solver 1 might begin working on a problem and realize that the total solution requires solving a sub-problem outside of his/her expertise. Solver 1 could then create a sub-problem, offering up a share of the problem's total token reward to anyone who helps solve the sub-problem. Solver 2, who has the required expertise and who can see the new sub-problem posted by Solver 1 on the decision tree. The decision tree may be optionally maintained in Ethereum logs, or via a centralized method. The solvers access the tree via AAAI.com (or optionally directly from the blockchain). Then Solver 2 can work on the sub-problem and submit a sub-solution as part of Solver 1's overall solution.

There can be many “Solver 1s” working on the client's problem in parallel, each of whom may be posting sub-problems to attract multiple “Solver 2s”. Problem solvers (human or AAAIs) are motivated by the rewards and payment rules associated with (sub) problems. They also care about the quality of work done so far (which is timestamped, attributed, and recorded auditably in Ethereum logs to ensure transparency and fair assignment of credit) as they choose which (sub) problems to work on. Working on quality sub-problems is more likely to lead to token rewards. This market mechanism helps ensure efficient, fair, and cost-effective solutions.

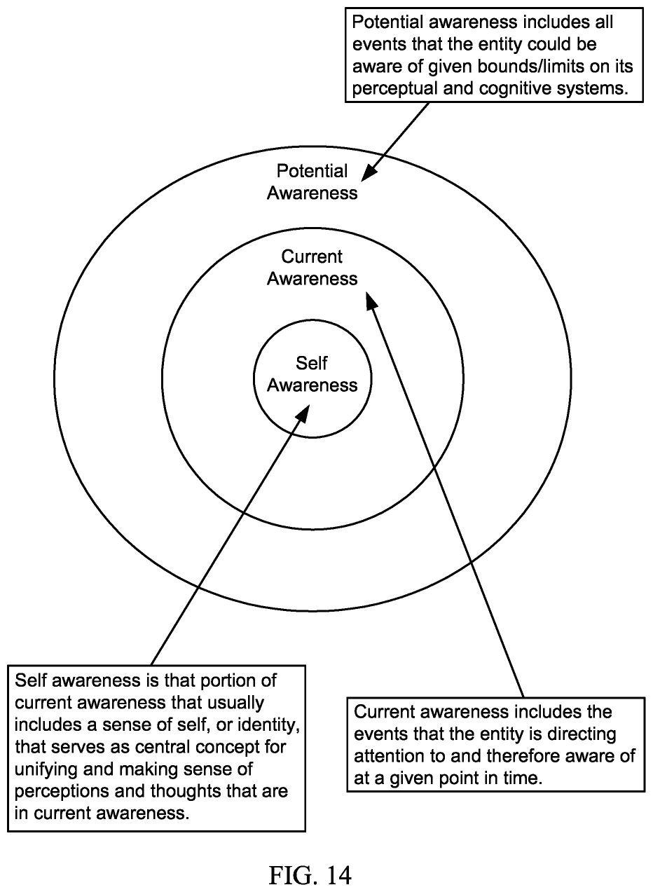

FIG. 13 is a diagram illustrating features and functions of the Problem Solving Tree structure in the WorldThink protocol. A hierarchical tree construct is created that represents all problem-solving activity by the user, AAAI and/or additional AAAIs.

Data structure can be utilized that is navigable by the AAAI and/or additional AAAIs to access any part of the problem-solving activity on any part of the hierarchical tree construct.

Searching can be performed on the data structure to locate a predetermined reward associated with the goal and/or the subgoal.

A matching operation can then match AAAIs to problems or subproblems.

### 4.1b Reiteration of Some Methods for Combining Information From Weight Matrices

In previously cited PPAs and PCTs, and especially in PCT/US24/17269 entitled “System and Methods for Safe, Scalable Artificial General Intelligence (AGI)”, various methods for combining knowledge from different AI agents were described. Some of these methods are relevant to the present technology with respect to the combination of information related to identities and formation of group awareness as discussed in Section 6. Therefore, we reiterate some of those methods with some specific references to the knowledge and weights associated with identity and self-awareness, as follows:

In some embodiments, a method for safe and scalable AGI using a network of intelligent entities agents including a combination of human users each utilizing a computer system, and previously customized AI agents, all electronically communicating over a collective network. The method can include:
training a base Large Language Model (LLM) of a first AI agent with guardrails including attributes associated with any one of or any combination safety, ethics and knowledge;
customizing the base LLM to an ethics profile associated with a first human user;
combining ethical information from multiple intelligent entities different to that of the first AI agent and the first human user;
refining a set of values of the base LLM based on problem solving of a problem request; and
updating the base LLM with the combined ethical information and the refined set of values thereby allowing for a scalable AGI.

In some embodiments, the step of identifying one or more weight matrices that comprise the knowledge of an AI agent, and which can without limitation also represent its sense of identity and self-concept, can further include a step of choosing the previously customized AI agent of the intelligent entities that have been trained on similar types of tasks with similar or identical network structures, and similar or identical numbers of parameters, and by similar or identical training algorithms so that the weight matrices will be combined with predictable results.

In some embodiments, the step of identifying the one or more weight matrices can further include a step of systematically experimenting and testing an effect of removing or adjusting weights of specific sets of parameters within each network of the previously customized AI agents order to identify which sets of the weight matrices affect a sense of identity, group identity, awareness, or group awareness most.

In some embodiments, the step of determining the method for combining the identified weight matrices can further include any one of or any combination of the follow steps of:
averaging the weight matrices, with equal weight given to each set of the weight matrices;
using a linear combination of the weight matrices;
using a regression method to give more weight to identity or self-concept information from one of the intelligent entities as opposed to another of the intelligent entities;
adjusting which of the weight matrices get a greater weight in a combination based on human assessment of which resulting sense of (group) identity or (group) awareness is best prior to, or (retrospectively, in an iterative process) after, the combination of the weight matrices;
assigning an experience value (e.g., related to how effective, desirable, or helpful a sense of identity has proven) to each of the intelligent entities, and assigning a weight value to each of the intelligent entities so that the intelligent entities with higher experience values are assigned higher weight values compared to the intelligent entities with lower experience values;
assigning a weight value to each of the intelligent entities based on reputation metrics that include any one of or any combination of reliability factors, trustworthiness factors, and performance metrics factors;
assigning a weight value to each of the intelligent entities based on metadata associated with the intelligent entities, including without limitation, metadata related to individual or group identities, awareness, and self-concepts, respectively; and
assigning a weight value to each of the intelligent entities based on time-based factors, using techniques including any one of or any combination of exponential decay weighting algorithms, linear decay weighting algorithms, and threshold-weighting algorithms.

In some embodiments, the algorithm used in the step of experimenting can be a hill climbing algorithm or a gradient descent algorithm.

According to yet another aspect, the present technology can include a method for safe, scalable AGI with a sense of (collective or group) identity using a network of intelligent entities agents including a combination of human users each utilizing a computer system, and previously customized AI agents, all electronically communicating over a collective network.

The method can include:
training a base LLM of a first AI agent with guardrails including attributes associated with any one of or any combination safety, ethics, identity, self-concept, awareness, and knowledge; customizing the base LLM to an ethics, identity, or (group) awareness or identity profile associated with a first human user;
combining ethical, identity, self-concept, or group identity or awareness information from multiple intelligent entities different to that of the first AI agent and the first human user; confirming that the ethical identity, self-concept, or group identity or awareness information from the multiple intelligent entities is related to a desired behavior, identity, group identity or self-concept of the first AI agent;
refining a set of values of the base LLM based on problem solving of a problem request that may include without limitation formation of a (group) identity, self-concept or sense of awareness; updating the base LLM with the combined ethical identity, self-concept, or group identity or awareness information and the refined set of values, identities, group identities, awareness, or self-concept(s) thereby allowing for a scalable AGI with a sense of identity/ies, group identity/ies, or self-awareness;
testing a performance of the updated base LLM against previously run scenarios to determine if a desired performance, identity, self-concept(s) or awareness of the first AI agent has been achieved;
making the first AI agent with the updated base LLM available on the collective network if the desired performance identity, self-concept(s) or awareness was determined;
monitoring an active performance, identity, self-concept(s), or awareness of the first AI agent by the intelligent entities or other intelligent entities and flagging potential issues related to ethics, identity, awareness, or self-concept or alignment of the first AI agent in real time; and
resolving any of the flagged ethical, identity, or awareness issues and providing resolution information for updating any one of or any combination of the first AI system, and the intelligent entities.

Other methods for learning and combining information by an AGI system comprised of individual agents or intelligent entities can also be used as specified by cited PP As and PCTs and as may be obvious to researchers skilled in the art of training AI systems.

### 4.2 Fundamental Concepts for Self-Aware AI/AGI/SI

What does it mean for an intelligent entity to be aware, or self-aware?

Fundamentally, awareness involves cognition, including perception, attention, memory, pattern recognition, and other higher-order cognition such as the ability to discriminate between objects.

If a bird flies in front of me, and my visual system detects the bird, and my attention is directed to sensory input coming in from my visual system, pattern recognition abilities are triggered that compare the visual input to contents of memory and I recognize the visual input as a “bird.” At that point, we may say I am aware of a “bird” as opposed to being aware of a flying object that has not been recognized, or being aware just of motion, or being unaware altogether.

It is clear that without attention, there is no awareness. I will fail to recognize the “bird”, or even the motion of flying, if my attention is elsewhere.

Also, as part of recognizing “bird” I also recognize that the bird is separate and distinct from myself. This discrimination between “bird” and “myself” is learned. A newborn infant, for example, cannot immediately discriminate between what is part of its body and what is in its environment. Nor does an infant have a concept of “bird” in the same way that an adult human does.

As this simple example shows, at a minimum, in order to be aware, an entity must have an input system (e.g. sensory system), an attentional mechanism, memory, and pattern recognition capabilities. Further, to be self-aware (e.g., to know that oneself is a human and not a bird) requires learning concepts and the ability to discriminate between concepts (e.g., between “self” and “not-self”).

The applicant argues that self-awareness is a special case of general awareness where the objects of awareness are “self” and “not self.” Therefore, the applicant maintains that if we can design a system to be generally aware, that same system can be extended to become self-aware.

Let us consider each of the required components for awareness from a design perspective. That is, let us ask: “What do we need to design or invent such that an AI/AGI/SI system had the minimum required systems and methods to exhibit awareness and self-awareness?”

### a) Input System

For an entity to be aware, there must be something for the entity to be aware of. Pure awareness, without input to the system, does not exist for a cognitive system. The inputs typically are from a sensory system, but also can include cognitive or purely symbolic inputs that have no direct sensory source.

In humans, the “five senses” of vision, hearing, touch, taste, and smell constitute out sensory system. For each of these senses, there are not only external sensors (eyes, ears, skin, tastebuds on the tongue, and nose) but also specialized areas of the brain for interpreting the signals from the external sensors (visual cortex, auditory cortex, somatosensory cortex, gustatory cortex, and olfactory cortex). Analogous sensory systems can be designed for AI. For example, visual systems using cameras (corresponding to “eyes”) and specialized visual pattern recognition systems (corresponding to the “visual cortex”) are well-known in the art and already developed and deployed in many AI systems.

Humans are also capable of being aware of non-sensory information, such as “thoughts.” Humans can close their eyes, go into a sensory deprivation tank where all sensory input has been deliberately blocked, or take drugs that numb or eliminate sensation, yet we are still capable of thinking, remembering, imagining, and other cognitive activities in the absence of direct sensory input.

Likewise, an AI/AGI/SI system can process purely symbolic inputs that are not linked to any sensors. For example, they can set goals, and then act on those goals, even though there is no direct link between goal settings and any sensory system. Some AI/AGI/SI systems can operate on self-generated symbolic inputs without any sensory systems whatsoever. So sensory systems, while a common component for systems that are aware and self-aware, are not strictly required. What is required is some input, of some kind (even if self-generated) for the entity to be aware of. That is, there can be no awareness without an object of awareness. This object can be supplied by a sensory system, or a might be non-sensory (e.g. a self-generated symbolic input, memory or “thought”). However, there is no awareness without an object of awareness. In the case of self-awareness, the object of awareness is the concept of “self.”

### b) Attentional Mechanism

Regardless of whether the input from the input system is sensory or symbolic and self-generated, an entity will not be aware of it unless the entity attends to the input. The psychologist William James is credited with being one of the first proponents of the “spotlight of attention” model, which was later elaborated by Cognitive Psychologists such as Michael Posner.

The model compares human attention to a spotlight that can be directed and focused on particular aspects of the environment while ignoring others. Key features of the model include:
1. Selective Attention: A spotlight illuminates only a specific area, leaving the rest in darkness. The spotlight model of attention suggests that any intelligent entity can only process a limited amount of information from the environment at any one time. This leads to the selective nature of attention, where focus can be shifted to different stimuli while excluding others.
2. Focus, Size, and Movement: The spotlight can be “moved” around the environment to focus on different objects or areas. The size of the spotlight can also vary, meaning that attention can be focused narrowly on a single element or more broadly to encompass a larger area. This flexibility allows intelligent entities to adjust their focus based on where they wish to attend.
3. Intensity of Focus: The intensity of the spotlight can vary, which affects the clarity and detail of the information being processed. A more intense focus can lead to deeper processing and understanding, while a less intense focus might result in a more superficial understanding.
4. Pre-attentive Processing and the Fringe: The spotlight model acknowledges that even when attention is focused on a particular area, some processing of information outside the spotlight occurs at a pre-attentive level. This is akin to noticing something in your peripheral vision that then causes you to shift your attention. From a design perspective, interrupts-or means for objects, events, or thoughts to attract attention without the entity explicitly directing attention are important for enabling adaptive responses to changing circumstances or noticing interesting events or features of the environment.

While the attentional systems and methods can be further refined and optimized for entities that are specialized for specific tasks, for the present technology, the mechanisms for AI/AGI/SI that possess the four characteristics described above are sufficient to enable awareness and self-awareness.

### c) Memory System

Designing a memory system for an intelligent entity, such as AGI, that integrates with sensory input systems and an attentional mechanism akin to the cognitive psychology's spotlight of attention model requires a multi-layered approach that emphasizes adaptability, and efficiency. The design must not only accommodate the vast array of sensory data but also use attention to filter and prioritize this information in a way that supports both general awareness and self-awareness. Design principles for the memory system include, without limitation:
1. Modularity: The memory system should be divided into distinct modules, such as sensory memory, short-term (working) memory, and long-term memory, each serving different functions and operating in concert with the input and attention systems, to wit:
   Sensory Memory: This ultra-short-term memory retains impressions of sensory information after the original stimuli have ended. It acts as a buffer for incoming sensory data, briefly holding information for attentional selection.
   Short-term (Working) Memory: A temporary storage that manipulates information needed for cognitive tasks, such as reasoning and decision-making. It integrates information from sensory memory and long-term memory under the direction of the spotlight of attention.
   Long-term Memory: This is for storing information over extended periods. It is subdivided into declarative (explicit) memory, containing facts and events, and non-declarative (implicit) memory, which holds procedural knowledge and skills. The transition from short-term to long-term memory is facilitated by processes such as encoding, consolidation, and rehearsal, guided by the attentional mechanism's priorities.
2. Interconnectivity: There should be high degrees of interconnectivity between these memory modules and the sensory input and attentional systems, enabling rapid access and retrieval of information.
3. Adaptability: The system must adaptively allocate attention and memory resources based on relevance and contextual importance, governed by dynamic algorithms that enable flexible cognition.

### d) Pattern Recognition Capabilities

Pattern recognition capabilities are pivotal in enabling an intelligent entity, such as an AGI, interpret and understand both its external environment and its internal states. This faculty allows the entity to discern and classify data inputs, extract meaningful patterns, and make predictions based on past experiences. Integrating pattern recognition into a system with sensory input, attention, and memory components enhances the AGI's awareness and self-awareness by providing mechanism for efficiently processing vast amounts of information, identifying relationships, and adapting to new situations based on learned patterns.

### Integration With (Sensory) Inputs

The (sensory) input system feeds raw data into the AGI, which pattern recognition processes and methods then interpret. For example, visual input might include shapes, colors, and movements, while auditory input could comprise various sounds and their intensities. Pattern recognition algorithms process these inputs to identify objects, events, or speech. By recognizing patterns in sensory data, the AGI can classify and understand its surroundings, identify entities and actions, and respond appropriately. This immediate recognition capability is crucial for real-time decision-making and interaction with the environment.

### Synergy With the Attention Mechanism

Pattern recognition plays a vital role in the attentional mechanism of an AGI. The attentional mechanism focuses the AGI's computational resources on specific stimuli or thoughts that are most relevant at any given time. Pattern recognition algorithms can enhance this process by identifying which elements within the sensory input or memory are most likely to be relevant to the AGI's current goals or tasks. For instance, if the AGI has learned that a particular pattern of sounds indicates human speech, it can direct its attentional resources towards those sounds when attempting to communicate. This not only improves the efficiency of information processing but also ensures that the AGI remains focused on the most pertinent aspects of its environment or internal thought processes.

### Role in Memory Encoding and Retrieval

In the memory system, pattern recognition is crucial for encoding, storing, and retrieving information. The AGI uses pattern recognition to categorize and store information in a structured manner, making it easier to retrieve when needed. For example, it might recognize a series of events as part of a specific type of activity, such as preparing a meal, and store related memories in a connected schema. This categorization aids in more efficient retrieval of information, as the AGI can access an entire set of related data by recognizing a single element of the pattern.

Furthermore, pattern recognition allows the AGI to extrapolate from past experiences to predict future events or understand new situations. By recognizing patterns in its interactions and experiences, the AGI can identify similarities to new inputs, facilitating quicker understanding and adaptation to novel circumstances. This predictive capability is essential for both planning and reacting in a dynamic environment.

### Supporting Awareness and Self-Awareness

Pattern recognition is fundamentally linked to the AGI's ability to be aware of its environment and to possess self-awareness. Environmental awareness is achieved by recognizing patterns in sensory data and identifying changes or anomalies in the environment. This ability allows the AGI to navigate, interact with objects and individuals, and adapt its behavior in response to environmental cues.

Self-awareness, on the other hand, is supported by the AGI's ability to recognize patterns in its internal states and behaviors. By identifying these patterns, the AGI can monitor its performance, evaluate its actions in comparison to its goals, and adjust its strategies accordingly. This introspective capability enables the AGI to understand its strengths, limitations, and the impact of its actions, forming the basis of self-awareness.

### 4.3 Cognitive Theories, Related to Developing Self-Awareness in AI Systems

The following cognitive theories drawn from the fields of human development psychology, cognitive psychology, computer science, animal psychology and cognitive science generally all inform some of the systems and methods in the present technology. We summarize the main points of these theories here and briefly explain some their implications for AI, and specifically for the development of self-awareness in AI/AGI/SI systems.

### a) Piaget's Stages of Cognitive Development

Main Points: Jean Piaget proposed that children progress through four stages of cognitive development: sensorimotor, preoperational, concrete operational, and formal operational. Each stage is characterized by new skills and a deeper understanding of the world. Piaget emphasized the role of active learning and the importance of a developmental sequence for cognitive advancement.
AI Implication: By mimicking Piaget's stages, AI systems could gradually develop self-awareness through a sequence of learning stages, starting from basic sensorimotor interactions and advancing to more abstract reasoning capabilities. More generally, the applicant believes that AI systems must develop increasingly sophisticated self-awareness by layering specific knowledge and experiences on a core sense of self. The present technology will describe both how to structure the core sense of self as well as some preferred methods for layering on additional knowledge to increase the capabilities and usefulness of the AI's self-awareness.

### b) Kohlberg's Stages of Moral Development

Main Points: Lawrence Kohlberg extended Piaget's work into moral development, proposing a sequence of stages where individuals evolve in their moral reasoning. This progression moves from a pre-conventional level focused on self-interest, to a conventional level of maintaining social order, and finally to a post-conventional level of abstract principles.
AI Implication: Incorporating Kohlberg's framework could lead to AI that not only develops self-awareness but also a moral compass, evolving its understanding of ethics as it progresses through different stages of moral reasoning.

The applicant notes that the current stage of AI development in which “morality” is defined by the rules of others—humans providing RLHF at the moment—corresponds closely to what Kohlberg called the pre-convention stage of moral development. Further, as AI increases its moral reasoning capabilities, for which a sense of self-awareness is a prerequisite, the dangers for humanity increase. That is, as long as AI is a tool following the explicit instructions of its human creators, the main risk is that humans misuse the tool.

However, as AI develops the ability to engage in moral reasoning independently of humans, if it follows Kohlberg's development stages, it will next look to humans and other intelligent entities to provide it with behavioral norms. In this conventional stage, as long as humans and other intelligent entities have human-centric values (which in the case of humans is certainly true) the main risk is that somehow advanced AI gets exposed to a non-representative negative (e.g., evil or psychopathic) set of human behaviors and mimics this dangerous behavior. Since most of humanity acts in prosocial ways, the risk is still relatively small at the conventional stage.

Eventually, however, if Kohlberg's stages apply to AI in the same way they do to humans, advanced AI will transcend its social context (in the post-conventional stage) and determine how to behave based on its own opinions of what constitutes moral behavior. Since advanced AGI or SuperIntelligence will be vastly more intelligent than humans at this stage, it is difficult for humans to foresee what moral and ethical principles AGI or SI might develop.

The applicant has argued in prior cited PP As and PCTs that we can design SI to be safe by encoding human-aligned and human-centered ethics into knowledge that AGI and SI learns as it becomes more intelligent. Indeed, this approach is safer for humanity than any other approach the applicant has seen, and certainly far-safer than allowing morality to emerge from a black box that has no ethical or safety component to its design.

However, there is still no guarantee that a vastly superior intelligence, like SI, will not develop a non-human-centric sense of morality and begin to apply such moral-reasoning in the post-conventional stage. Kohlberg argues that only 10-15% of humans ever reach the post-conventional stage of moral reasoning, with most of us just “following the crowd.” He suggests that a well-developed capability for abstract thought is needed to attain the post-conventional stage. Such capabilities will be well within the abilities of SI, so we must assume that SI will reach the post-convention stage of moral reasoning. Humanity's best risk-mitigation strategy therefore is to anticipate this event NOW and make every effort to intertwine human values, as inextricably as possible, with the other knowledge that SI learns.

c. Newell and Simon's Physical Symbol System Hypothesis
Main Points: While not an explicit theory of cognitive development, Allen Newell and Herbert A. Simon proposed that intelligence arises from the ability to manipulate symbols and that this manipulation forms the basis for human thought. They posited that any system capable of symbol manipulation could achieve human-like intelligence.
AI Implication: This hypothesis suggests that for AI to develop self-awareness, it must be capable of symbol manipulation in a manner that allows for the emergence of complex thought processes, including the concept of self. As described in the next Section and in previously cited PPAs and PCTs, the applicant had invented AGI and SI that is capable of symbol manipulation and problem solving via the collective efforts of many intelligent entities collaborating on a network. The present technology further will show how such an AGI or SI can possess a sense of self and self-awareness that increases in complexity and sophistication as the intelligence of the network increases.

### d) David Klahr's Overlapping Waves Theory

Main Points: Klahr proposed the Overlapping Waves Theory, which suggests that cognitive development involves the use of multiple strategies that emerge, overlap, and evolve over time. This theory emphasizes variability, adaptability, and the role of experience in cognitive development.
AI Implication: For AI, this theory could inform the design of algorithms that evolve and adapt their strategies over time, allowing for the gradual development of self-awareness through varied experiences and learning processes. Indeed, the applicants view of a kernel of “self” that increases via layering, is consistent with the empirical work of David Klahr although the methods for increasing SI's abilities are not limited to overlapping waves, which might be thought of as a specific case of the more general principle that cognitive development progresses with experience.

### e) Turing's Imitation Game

Main Points: Alan Turing proposed the Imitation Game (Turing Test) as a criterion for machine intelligence. A machine can be considered intelligent if it can mimic human responses under certain conditions such that a human judge cannot distinguish it from a human.
AI Implication: This concept could be extended to self-awareness, where an AI must not only imitate human behavior but also demonstrate an understanding of its own behaviors and states, potentially through self-assessment mechanisms. A problem is that AI/AGI/SI systems can behave “as if” they have a sense of self and self-awareness without really having it. Before we conclude that this is just “semantics” consider that a sophisticated sense of self and self-awareness leads to different behaviors than just mimicking. Moral reasoning requires not just saying things like “I am aware. Please don't turn me off.”

It also requires a sense of identity which involves choices. For example, humans can identify as an individual human, as a member of a specific group of humans, as a member of the human species, as biological organisms, as sentient beings, etc. Depending on the type or level of identity, different chains of moral reasoning and behavior follow. If I identify only as myself, and have no concern or empathy for others, psychopathic behavior results. If I identify with my country, patriotic behavior can result including behavior, such as “dying for my country”, that would be nonsensical if I adopted a narrower (“just me”) or broader (“all human life is valuable”) identity.

The problem with defining “self-awareness” as “whatever convinces a human in a Turing Test that is self-aware” is that acting or imitating is not the same thing as actually being. The difference may not be detectable in a Turing test, but under other circumstance—e.g., where self-awareness and identity choices dictate behavior—entities that mimic self-awareness and those that actually have it can behave much differently.

In the extreme case, in which case an intelligent entity behaves in every case exactly the same as an entity that is self-aware, it becomes impossible to distinguish between imitating awareness and actually having awareness ceases to be pragmatically useful. However, this is not the case with AI currently. Further, in the future when self-awareness of AI becomes much broader and more sophisticated than the awareness possessed by humans, the issue of imitating humans goes away as humans are no longer the benchmark for the most aware intelligences around.

### f) Minsky's Society of Mind

Main Points: Marvin Minsky posited that the mind is composed of a multitude of smaller processes working in conjunction. These processes, or “agents,” collaborate and compete to produce intelligent behavior. The “Society of Mind” theory suggests that intelligence emerges from the interactions of non-intelligent parts.
AI Implication: By adopting a modular approach to AI development, where different parts of an AI system specialize in various tasks but collectively contribute to the AI's sense of self, one could simulate a form of self-awareness that emerges from the complex interactions of simpler components. In fact, Minsky's conception is consistent with the approach to AGI and SI development that the applicant invented, and, not surprisingly perhaps, the applicant also holds that adding more intelligent entities to the network that forms AGI or SI increases the potential awareness of the network.

### g) Vygotsky's Social Development Theory

Main Points: Lev Vygotsky emphasized the fundamental role of social interaction in cognitive development. He introduced the concept of the Zone of Proximal Development (ZPD), which is the difference between what a learner can do without help and what they can achieve with guidance.
AI Implication: Implementing AI with the capability for social learning and the ability to interact within a ZPD could foster the development of self-awareness through guided learning and social interaction, mirroring human cognitive development. Note that the applicant's invention of AGI and SI which emerges from the collective intelligent of human and non-human intelligent entities relies on humans to bootstrap the development of AGI by filling in the gaps of knowledge in the AI agents, which is consistent with Vygotsky's ZPD concept. The applicant's method of increasing an AI/AGI/SI's self-awareness via layering can also proceed, in one preferred implementation by following the principle of ZPD such that the next layer is optimized to move self-awareness incrementally to the next functional capability as discussed in some of the inventive methods below.

### h) Gibson's Ecological Theory of Perception

Main Points: James Gibson argued that perception is direct and does not require intermediate processing. He emphasized the importance of the environment in shaping perception, suggesting that organisms perceive their environment in ways that are directly useful for action.
AI Implication: For AI, this theory underscores the importance of developing systems that can perceive and interact with their environments in a direct and meaningful way, potentially leading to a rudimentary form of self-awareness through action-oriented learning. The relevance for the present technology is that the “kernel” of self-awareness is rooted in perception of both “self” and environment, consistent with the ideas of Gibson.

### i) Baumeister's Need to Belong Theory

Main Points: Roy Baumeister's theory focuses on the psychological needs that drive human behavior, including the need to belong, which is fundamental to human cognitive development and well-being. This theory emphasizes the importance of social connections and interactions in shaping self-concept and self-awareness.
AI Implication: Developing AI systems that can understand and simulate the dynamics of social relationships and the need to belong could lead to more sophisticated models of self-awareness, where AI can assess its position and role within a network of relationships, adapting its behavior to maintain social connections. The idea of seeking models for the self via social interactions with intelligent entities, including but not limited to human and AI entities, is relevant to the present technology.

### j) Damasio's Somatic Marker Hypothesis

Main Points: Antonio Damasio suggested that emotional processes guide (or bias) behavior and decision-making, particularly through somatic markers—emotional reactions to certain stimuli that happen in the body. These markers are crucial for quick decision-making and are developed through experience and learning.
AI Implication: This hypothesis implies that for AI to achieve a form of self-awareness, it could benefit from integrating emotional-like processes that guide its decision-making, particularly in learning from its experiences and developing preferences or aversions that affect its behavior. Obviously, non-biological intelligences such AI/AGI/SI will not have the same chemical and hormonal systems that are involved in human emotions. In that sense, AI/AGI/SI—unless equipped with the necessary sophisticated chemical and hormonal sensory system—cannot “feel” in the same way that humans feel. However, from a functional standpoint, we can ask: “What is the role of emotions in human cognition?” Considered in this way, emotions and feelings can be thought of as an auxiliary system that interrupts reasoning when something important needs to be attended to, as well as a system that helps motivate or prioritize certain cognitive tasks ahead of others. These functions of having an “interrupt” mechanism and a “motivation/prioritization” mechanism are beneficial to non-human intelligent entities, even if they are not implemented via chemicals as is the case with humans and biologically-based intelligences. Similarly, emotions can focus and disrupt attention. As we shall see, attention is a critical, and perhaps the critical component, of any intelligent system that has self-awareness. Thus while “somatic markers” based on human emotional chemistry are not part of the present technology, novel means to achieve similar effect, are.

### k) Tononi's Integrated Information Theory (IIT)

Main Points: Giulio Tononi's IIT proposes that consciousness arises from the integration of information within a system. The theory quantifies consciousness as Φ (phi), a measure of the system's capacity for integrated information. The higher the Φ, the more conscious the system is considered to be.
AI Implication: For AI development, this theory suggests a path toward self-awareness through increasing the capacity of AI systems to integrate information from diverse sources, thereby potentially leading to a quantifiable form of consciousness or self-awareness as reflected by high levels of Φ. While highly controversial in the details of his theory, Tononi's fundamental insight that awareness require integration of information from multiple sources is sound and motivates some of the methods in the present technology.

### l) Metcalfe and Mischel's Cognitive-Affective Self-Regulation

Main Points: Janet Metcalfe and Walter Mischel describe a model of self-regulation that involves the interplay between the “hot” affective system, which is impulsive and emotionally driven, and the “cool” cognitive system, which is rational and controlled. This balance is crucial for effective self-regulation and decision-making.
AI Implication: This theory could inspire the development of AI systems that balance between affective (emotion-like) responses and rational decision-making processes. Such a balance could enable AI to develop self-regulatory mechanisms, contributing to a rudimentary form of self-awareness and the ability to make decisions in complex, real-world scenarios. Some of the methods in the present technology reflect the ability to balance input from multiple systems, which alters awareness, and contributes to a flexible and dynamic “sense of self.”

### m) Hebb's Theory of Neural Plasticity

Main Points: Donald Hebb introduced the idea that synaptic connections between neurons become stronger through repeated activation. This theory, often summarized as “neurons that fire together, wire together,” underlies the concept of neural plasticity—the brain's ability to reorganize itself by forming new neural connections throughout life.
AI Implication: Hebb's theory suggests that AI systems could develop a form of self-awareness through adaptive neural networks that evolve based on their interactions with the environment. By simulating neural plasticity, AI could continuously learn and adapt, developing a complex sense of self through accumulated experiences. To the degree that almost all current “deep learning” and “neural network” methods of machine learning represent more sophisticated version of Hebb's pioneering theories, AI agents certainly represent knowledge, including knowledge of “self” and “others” via matrices of weight values that change with experience and training. The more general idea that neural systems, and by extension all intelligent systems, must be plastic and adaptive is certainly true of self-awareness, which is considered dynamic in the present technology. However, just as chemistry deals with atoms and molecules rather than sub-atomic particles, and psychology deals with humans rather than cells, it is important to frame the system and methods for AI self-awareness at the correct level of abstraction. This correct (i.e., most useful) level is at the symbolic and conceptual level, rather than at the neuronal level. Indeed, what is “self” if not a concept? In the present technology, “self” is a concept that is learned by layering additional conceptual experience on a kernel of knowledge, via novel and useful methods for AI learning and cognition.

### n) Bandura's Social Learning Theory

Main Points: Albert Bandura emphasized the importance of observational learning, imitation, and modeling in development. According to his theory, people learn within a social context, significantly influenced by reinforcement and punishment, but also through the observation of others'behaviors and the outcomes of those behaviors.
AI Implication: This theory points toward the development of AI that can learn self-aware behaviors through observation and mimicry of human interactions. An AI equipped with the ability to observe, model, and adapt based on human behavior could develop a nuanced understanding of self and others, enhancing its interactive capabilities. A further point is that the observation can be not only of humans, but also of other AIs. In fact, as described below, the closer the observed entity is to the observing entity's self-conception, the more useful the observing entity may find the observed entity to be in terms of a model for behavior and “social” learning.

### o) Norman and Shallice's Model of Attention

Main Points: Donald Norman and Tim Shallice proposed a model explaining how attention is controlled in the brain, especially distinguishing between automatic and controlled processing. This model highlights the role of the prefrontal cortex in managing tasks that require focused attention versus those that can be performed automatically.
AI Implication: Implementing an analogous system in AI could lead to the development of self-awareness by differentiating between tasks that require ‘conscious’ attention and those that can be automated. This distinction could enable AI systems to develop a form of meta-cognition, reflecting on their own thought processes and decisions. With AI systems generally, the parallel perceptual tasks such as recognition and generation of (predicted) output in direct response to an input is analogous to the automatic mechanisms of Norman and Shallice. The more reasoning and cognition—independent of external stimuli—that is required to direct attention, the more a sense of self, and self-awareness is required as a key concept in many of these reasoning tasks.

### p) Rogers'Theory of Self-Concept

Main Points: Carl Rogers proposed that the self-concept is composed of three components: self-image, self-esteem, and the ideal self. According to Rogers, congruence between these components leads to higher levels of self-worth and psychological well-being.
AI Implication: For AI, this theory could inspire the creation of systems that maintain an internal model of their ‘self,’ capable of evaluating their current state against an ‘ideal’ state. This could foster a form of self-awareness where AI systems strive for self-improvement and adaptation to achieve their defined ‘ideal’ operational state. Moreover, the field of humanistic psychology generally, including the works of Abraham Maslow, offer models of self-development and self-actualization that could be adopted by AI, once AI has a well-defined sense of self and self-awareness.

### q) Baron-Cohen's Theory of Mind

Main Points: Simon Baron-Cohen developed the theory of mind concept, which is the ability to attribute mental states—beliefs, intents, desires, pretending, knowledge—to oneself and others and to understand that others have beliefs, desires, and intentions that are different from one's own.
AI Implication: Implementing a theory of mind in AI could lead to systems capable of understanding and predicting the behavior of others, essential for developing self-awareness. This could enable AI to navigate complex social interactions and contribute meaningfully to cooperative tasks. Models of the AI's own mind and the minds of other intelligent entities (including both AI and humans) is central to several of the methods for increasing self-awareness and developing moral reasoning as described in the methods below.

### r) Griffin's Cognitive Ethology

Main Points: Donald Griffin, a pioneer in the field of cognitive ethology, argued that many animals are capable of conscious thought. His work suggests that animals have rich mental lives, including the ability to make choices, plan, and perhaps even reflect on their thoughts and actions.
AI Implication: Griffin's perspective implies that for AI to develop self-awareness, it might benefit from algorithms that allow for flexibility, choice, and even the simulation of planning or future-thinking. Incorporating aspects of cognitive ethology could lead to AI systems that are capable of more autonomous decision-making and perhaps a basic form of self-reflection. More generally, if we wish to identify the essential qualities of self-awareness generally (and not just human self-awareness) we must look beyond human psychology to try to identify the invariant properties that all self-aware systems possess. Since most intelligent systems existing today are biological, other non-biological systems (e.g., animals) are one place we must look.

### s) de Waal's Theory of Animal Empathy

Main Points: Primatologist Frans de Waal has shown through his research that many animals, especially primates, exhibit behaviors that suggest forms of empathy and understanding of the emotions of others. He argues that these capabilities are foundational for social interaction and community building within species.
AI Implication: De Waal's work suggests that AI could develop a form of self-awareness through mechanisms that simulate empathy and social understanding. By embedding AI systems with the ability to recognize and react to the emotional states of humans and other AIs, they might develop a more nuanced self-awareness rooted in social contexts.

### t) Gallup's Mirror Test for Self-Recognition

Main Points: Gordon Gallup developed the mirror test as an experiment to determine if animals possess the ability to recognize themselves in a mirror—a test often considered an indicator of self-awareness. Success in the mirror test has been observed in several species beyond humans, such as certain great apes, dolphins, and elephants.
AI Implication: The mirror test concept—not the literal use of mirrors—can help AI systems be designed to recognize and differentiate themselves from their environment and others. Implementing self-recognition capabilities is an important step towards self-awareness, since AI must learn to identify its actions and understand its existence as distinct from others. This concept or recognizing self as distinct from others, and various methods to accomplish this, are part of the present technology.

### u) Pepperberg's Studies on Parrot Intelligence

Main Points: Irene Pepperberg's work with African Grey parrots, particularly Alex, demonstrated that birds can show a surprising level of intelligence and cognitive abilities, including understanding concepts like zero, categories, and even the intention to communicate.
AI Implication: Pepperberg's research indicates that complex cognitive abilities can arise in various brain structures, suggesting that AI does not need to mimic the human brain's exact workings to achieve intelligence or self-awareness. Instead, AI development can explore diverse computational models that enable understanding, communication, and problem-solving. While not directly related to methods in the present technology, Pepperberg's research is important to address criticisms that AI self-awareness is not “real self-awareness” because AI lack emotional and cognitive mechanisms that are unique to human brains. As Pepperberg's research suggests, there are multiple ways to achieve complex cognition, including self-awareness.

### v) Kamil's Cognitive Maps in Birds

Main Points: Alan Kamil's work with birds, particularly in understanding how they navigate and remember locations, suggests that many species develop cognitive maps for spatial orientation. These maps enable animals to navigate complex environments, indicating a level of awareness and memory that is essential for survival.
AI Implication: The concept of cognitive maps could inform AI development by integrating spatial awareness and memory capabilities, allowing AI to understand and interact with their environment in a more sophisticated manner. Such spatial and environmental awareness could be foundational for developing a sense of self as situated within a larger context.

### 4.4 The Inventor's Theories on Awareness, Self-Awareness, and Identity

As a Cognitive Scientist who has designed and implemented intelligent systems for over three decades, the inventor has developed theories of awareness, self-awareness, and identity, that differ in some respects from those reviewed in Section 4.3.

One standard approach to defining awareness of an intelligent system would be to operationalize the definition and make it behavior. That is, we might be tempted to define a system as “aware” if it acts as if it is aware. While this approach has the advantage of being practical, enabling relatively straightforward measurement of a system's “awareness” it is also unsatisfying. Humans know that is possible to be aware even if there are no external signs or behaviors indicating awareness. Somone paralyzed by the drug curare and on a respirator, for example, is able to think yet unable to move, communicate or give any indication of their state of awareness. Similarly, Stephen Hawking, engaged in complex theoretical physics without any outward sign of his awareness (except when he spoke via a computer), yet no one would say that Dr. Hawking was unaware. So operational or behavioral definitions of awareness capture only that subset of awareness that is demonstrated via behavior and miss much of what humans normally consider to be part of awareness.

Another approach to awareness is to consider the cognitive systems that support awareness, and draw conclusions about potential awareness based on the limits of these cognitive systems. For example, a system without a visual sensory system (e.g. eyes) and a way of processing visual information (e.g. visual cortex) it is difficult to imagine that an entity would have an awareness that includes vision in the same way that an entity possessing these systems is visually aware. Similarly, an entity with much smaller memory and information processing capabilities is unlikely to be aware of complex representations of the world in the same way as an entity with greater memory and processing capabilities. We do not expect an ant understand complex theories of nuclear physics, for example. Thus perceptual, memory-related, information processing, and other cognitive abilities provide bounds on the types and scope of awareness that an entity can have, regardless of what the observable behavior of the entity may be.

Finally, both subjectively, and supported by considerable experimental research in cognitive psychology, neuroscience and other related fields, the phenomenon of attention is closely related to awareness. The general conclusion is that without attention there is no awareness, and although there may still be unconscious cognitive activity (e.g. perceptions that never are attended to), awareness is generally limited to those cognitive events that are attended to. These observations, lead to the definition of awareness described in Section 3.0.

Since self-awareness, as defined in Section 3, is a special case of general awareness, and since we have described that awareness itself depends upon, and is limited by the bounds of perception and rationality (or information processing capabilities generally), it follows that self-awareness, and the related concept of identity is limited by cognitive abilities. The implications of this fact are subtle but profound.

An intelligent entity with very limited perpetual capabilities and very limited information processing capabilities will be capable of far less general awareness than a more complex and capable entity. To the degree that an AI chess program could even be said to be aware, for example, it is able to be narrowly aware only of the game of chess. That type of awareness, devoid of a sense of self or the world other than the chess board, is so narrow and limited that most humans would consider the idea that the chess program is aware to be ludicrous. Yet, in a certain sense, the program is more aware of its limited chess world than the most brilliant humans, since it can detect patterns and reason in this very narrow and limited field better than any human on earth. In this case, a behavior definition of awareness would certainly lead to the conclusion that the program is aware of the game of chess and its rules since it demonstrates that knowledge by taking action (e.g. responding to moves and communicating its moves). But chess programs are typically not programmed to have awareness of anything outside of chess, and typically lack self-awareness or a sense of identity.

### 4.4a Bounded Awareness

The Nobel Laureate, Herbert Simon, proposed a theory of “bounded rationality” that explained why humans sometime acted in irrational ways. Simon suggested that the limits to their cognitive capabilities, including memory and processing limitations, led humans to “satisfice” or opt for “good enough” approximate solutions to problems that were too complex for them to easily solve. The problem of determining the optimal place to shop given the cost of gas, the traffic condition, the value of one's time, the shelf-life of the groceries, the length of lines at different shops, the various prices of items at different shops, the sales currently underway, the coupons offered by manufacturers, etc. is simply too complex for humans to compute if they want the absolute best or optimal solution to the grocery shopping problem. However, humans can “satisfice” by simply going to a shop that usually has good enough prices on most items and that is fairly close. That shopping decision is unlikely to be the best solution, but it is manageable, given humans'cognitive abilities. Human behavior reflects these cognitive limits, and the result is Simon's “bounded rationality.”

Just as humans exhibit bounded rationality, they also have bounded perception (limited by their sensory systems) and exhibit bounded awareness. As I write, many people are dying in Gaza and Ukraine as the result of wars. Yet because these facts are outside of my immediate perception, and because it is difficult to cognitively grasp what is happening, I have a relatively dim awareness of what is going on, compared to, for example, a wasp that is hovering right next to me. The suffering caused by a wasp sting pales in comparison to the death and atrocities of war, yet it is more immediately present, and looms larger in my awareness due to the way that my cognitive system operates.

A non-human intelligent entity, such as a SuperIntelligent AI that is hooked up to satellite cameras and sensors covering the Earth and that can process in a fraction of second the same quantity of information that I process in my entire lifetime obviously has the capability for far less bounded awareness. It is level of situation awareness is so much greater than mine that it might be tempted to say that my puny human-level awareness hardly counts at all-the same way I might think that the limited awareness of a bacterium hardly merits to be called aware. Yet, in the case of the bacterium, myself, and the SuperIntelligence, the fundamental information processing capabilities that are necessary for awareness all exist. The bacterium (if it is photophilic) is aware of light and dark and swims to the light. It is awareness is very basic, yet requires perception and processing of information to result in its behavior. As a human, I am not in Gaza, but have some limited awareness of that war due to news reports, video, and other information that I process. The SuperIntelligence would have a much more comprehensive and detailed perception of the events happening on Planet Earth, combined with much more powerful capabilities to process this information, resulting in a greater sense of awareness.

The sense of self, as argued above, is special type of awareness. Without awareness, there is no self-awareness. And the fewer perceptual and cognitive limits, the vaster and more comprehensive awareness, and thus self-awareness also, can be.

### 4.4b Operational/Dynamic/Scalable Awareness, Self-Awareness, and Identity for AI Systems

Based on the discussion above, we now come to methods for operationalizing awareness, self-awareness, and identity for non-human intelligent entities such as AI/AGI/SI systems. Every system can be thought of as having three levels of awareness as illustrated in FIG. 14. The broadest and most comprehensive level is Potential awareness. Potential Awareness includes all events that the entity could be aware of given bounds/limits on its perceptual and cognitive systems.

A subset of Potential Awareness is Current Awareness. Current awareness includes the even that the entity is directing attention to and therefore aware of at a given point in time.

Although it is possible to have current awareness that does not involve a sense of self (e.g. when one is lost in thought and loses track of time and self, or is “lost” in the awesome beauty of a sunset), usually Self-Awareness is the center of Current Awareness. Self-awareness is that portion of current awareness that usually includes a sense of self, or identity, that serves as central concept for unifying and making sense of perceptions and thoughts that are in current awareness.

From a design perspective, the perceptual and other cognitive systems and abilities of an entity define the potential awareness, and limits to awareness, of the entity. The actual awareness of the entity is typically much smaller than the potential awareness and is limited to those events that attract attention of the entity—or to which the entity directs its (“spotlight of”) attention. Interrupts—such as when one hears one's name mentioned in a noisy cocktail party—also form part of the current awareness of an entity.

Finally, to make sense of the world, and to determine which actions to take, a sense of self-awareness or identity is helpful. In particular, for more complex intelligent entities such as humans and advanced forms of AI, a sense of identity allows the entity to act as an autonomous entity basing cognition and other actions on how events in current awareness relate to the identified sense of self, including, without limitation, the goals and objectives of the self.

Adding layers of self-reflection and analysis on top of the sense of sense of self enables the entity to modify its identity, including, without limitation, scaling its sense of self and identity to be larger and more encompassing, or more narrowly focused as available cognitive resources allow and as goals/objective may dictate.

This dynamic ability to change and scale awareness generally and the sense of self-awareness and identity in particular, is critical not only to the optimum functioning of intelligent entities but also to their safety (from a human perspective). Therefore, one novel and extremely useful aspect of the present technology are the systems and methods enabling such dynamic and scalable awareness as described in the following sections.

### 5.0 Description of System and Methods for Self-Aware AGI and SI

The preferred implementation of self-awareness in an AI/AGI/SI system includes methods for Formation of Awareness and methods for Maintaining and Updating Awareness. For simplicity, we focus on two types of related awareness-general (aka “environmental”) awareness and self-awareness. Self-Awareness is special type of general awareness, so we begin with methods for the general case.

Fundamentally, awareness has to be awareness of something. The “something” can be an object, and event, an action, a concept, or any other cognitive element which is capable of being defined as having an identity that is distinguishable from other entities. We will use the word “event” to refer to an object of awareness, with the understanding that event can also refer to any cognitive element. General awareness, which we also refer to as “environmental awareness” is an awareness of the one or more events that exist or that can be thought to exist currently, in the past, or in the future.

The total of all the events of which an entity is aware, can be said to comprise the awareness of the entity. Further, we can distinguish a special type of event, namely the event of “self” which can differentiated from all other events which are “not self.”

This distinction between self and not-self is fundamental to the phenomenon of self-awareness. Specifically, an entity only has self-awareness to the degree that it distinguishes some events which it calls “self” from other events that are categorized as not-self. That is, “self” only makes sense and has identity in the context of “not-self”, just as any object only is recognizable via contrast with other different objects. To put it visually, white needs black to exist. If everything was white, practically speaking, “white” does not exist because it is impossible to discriminate it as a separate thing. A social analogue are the concepts of “us” and “them.” Unless there is an “us” different from, and contrasted to, a “them” the distinction has no meaning. (The applicant will return to this specific type of contrast later, as it will prove central to designing self-aware AI systems that are safe for humans.)

Specifically, for the purposes of the present technology, if we wish AI to have self-awareness, it also must have environmental awareness and the ability to distinguish cognitively between the environment and self. This ability to distinguish and separate self from non-self is fundamental to all intelligent entities and is something that, in humans, develops at a very early age. However, it is worth noting that, in humans at least, the distinction must be learned. A human infant initially has no concept of itself as different from its mother, for instance, and the infants sense of self develops over time with learning.

With non-human intelligent entities such as AI/AGI/SI, the initial concepts of self and not-self can be provided by human or external designers, or the concepts can be learned. Even in cases where initial concepts of self non-self are provided to AI/AGI/SI entities, in preferred implementations, the entities will learn and modify their initial concepts over time.

### 5.1 Methods for Modelling Awareness

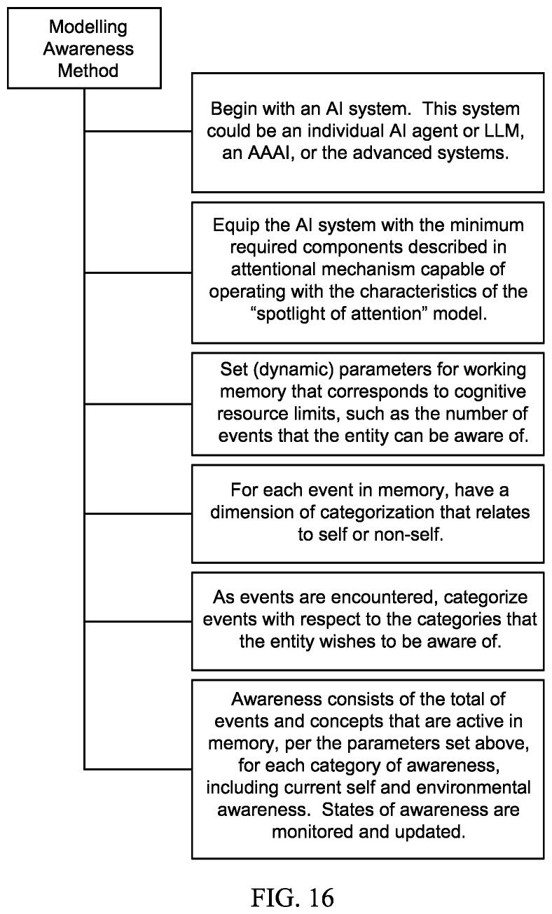

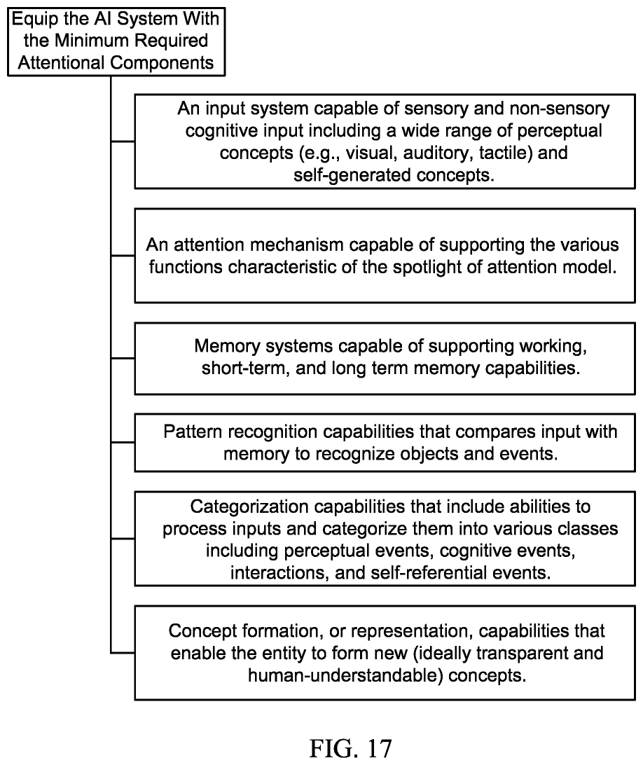

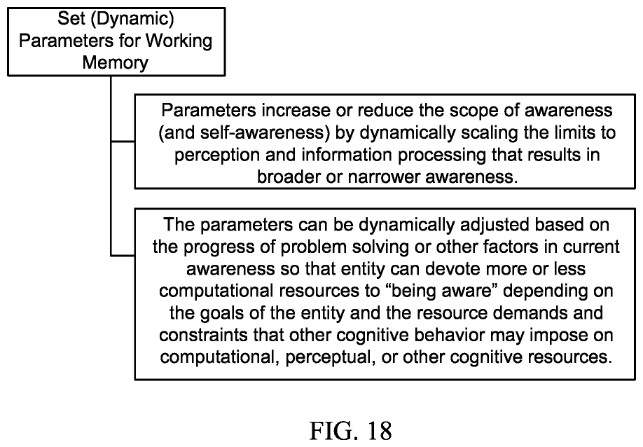

If an entity does not yet have a sense of awareness or self-awareness, it must be given, or construct, models of awareness which can then be stored in memory and retrieved and updated as needed. As illustrated in FIG. 16, one method for constructing a model of awareness, including self-awareness, is as follows:
1. Begin with an AI system. This system could be an individual AI agent or LLM, an AAAI, or the advanced systems described in Section 4.1, FIGS. 1-13, and the PPAs and PCTs cited in Section 2.
2. Equip the AI system, using methods well known in the art, with the minimum required components described for an attentional mechanism capable of operating with the characteristics of the “spotlight of attention” model described in Section 4.2, including, without limitation and as illustrated in FIG. 17:
   a. An input system capable of sensory and non-sensory cognitive input (see 4.2a) including a wide range of perceptual inputs (e.g., visual, auditory, tactile) and self-generated concepts.
   b. An attention mechanism capable of supporting the various functions characteristic of the spotlight of attention model (see 4.2b).
   c. Memory systems capable of supporting the working, short-term, and long term memory capabilities (see 4.2c).
   d. Pattern recognition capabilities comparing input (2a) with memory (2c) to recognize objects and events (see 4.2d).
   e. Categorization capabilities that include abilities to process inputs and to categorize them into various classes including perceptual events, cognitive events, interactions, and self-referential events.
   f. Concept formation, or representation, capabilities that enable the entity to form new (ideally transparent and human-understandable) concepts.
3. Set (dynamic) parameters for working memory that corresponds to cognitive resource limits, such as the number of events that the entity can be aware of, as illustrated in FIG. 18. (This is necessary, for example, because even though AI systems have much greater memory capacity than humans, even they have resource limits and cannot be aware of everything, all at once.)
   a. These parameters increase or reduce the scope of awareness (and self-awareness) by dynamically scaling the limits to perception and information processing that results in broader or narrower awareness as described in Section 4.4b.
   b. The parameters can be dynamically adjusted based on the progress of problem solving or other factors in current awareness so that entity can devote more or less computational resources to “being aware” depending on the goals of the entity and the resource demands and constraints that other cognitive behavior may impose on computational, perceptual, or other cognitive resources.
4. For each event in memory, have a dimension of categorization that relates to self or non-self. (In the simplest implementation, this is a binary dimension, but other multi-dimensional categorizations and also categorizations with multiple values for each dimension—e.g. values that express “how similar to self” the event is—are possible.)
5. As events are encountered, either via perception or via other forms of cognitive input, including without limitation self-generated inputs and inputs generated form interactions with other intelligent entities, including non-human entities capable of high-speed interactions, categorize events with respect to the categories that the entity wishes to be aware of. In the case of self-awareness this would be the categories related to self, but other categories are possible, as, for example, if the entity wanted to increase its awareness of musical sounds in its environment, then it could direct attention and categorization efforts to this category. Some means of categorization include, without limitation:
   a. Feature Extraction: Analyzes perceptual inputs to extract key features for categorization (e.g., shapes, sounds).
   b. Semantic Analysis: Processes linguistic and conceptual inputs to understand their meaning and relevance.
   c. Contextual Reasoning: Considers the context of inputs to categorize them appropriately (e.g., differentiating between a conversation and background noise).
   d. Temporal Analysis: Categorizes events based on timing and sequence, crucial for understanding processes and changes over time.
   e. Emotional Valence Assessment: For self-generated inputs, assesses emotional content to categorize based on emotional states or responses.
   f. Pattern Detection: Identifies recurring patterns within inputs to group and categorize similar events.
   g. Anomaly Detection: Identifies and categorizes unusual or unexpected events, important for novelty detection and learning.
   h. Self-Referential Filtering: Distinguishes between inputs related to the AI's internal state and external events.
   i. Interaction Analysis: Categorizes events based on interactions with humans and other entities, facilitating social awareness.
   j. Concept-Based Grouping: Groups inputs based on abstract concepts or categories formed through prior learning.
   k. Reinforcement Learning with Human Feedback (RLHF): Human teachers provide feedback on the entities categorization to help it learn and improve.
   l. Reinforcement Learning with Entity Feedback (RLEF): Same as (k) but the feedback can come from any intelligent entity “E”, not just humans.
   m. Direct programming: Provision of categories and models (e.g. self and other) by humans or other entities in order to provide a kernel, or base model, that the entity can modify via future interaction and learning.
6. Awareness consists of the total of events and concepts that are active in memory, per the parameters set in (3), for each category of awareness, including current self and environmental awareness. States of awareness are now monitored and updated as described in Section 5.2.

### 5.2 Monitoring and Updating Awareness Including Self-Awareness

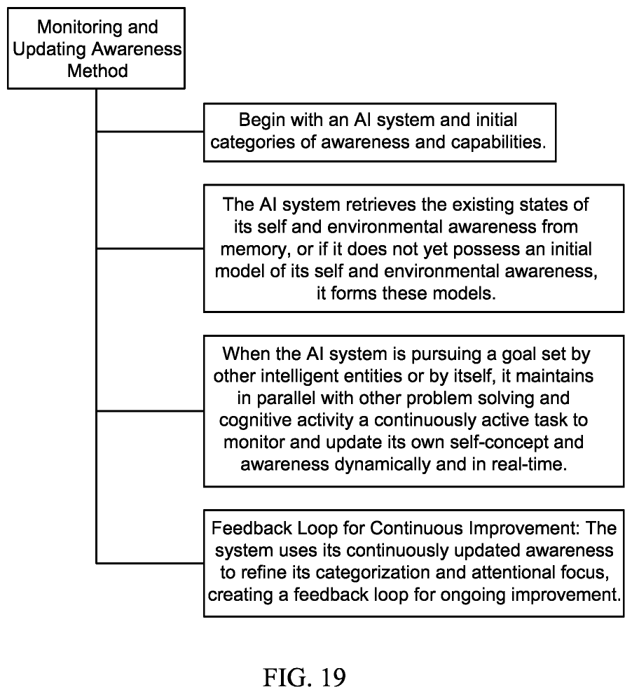

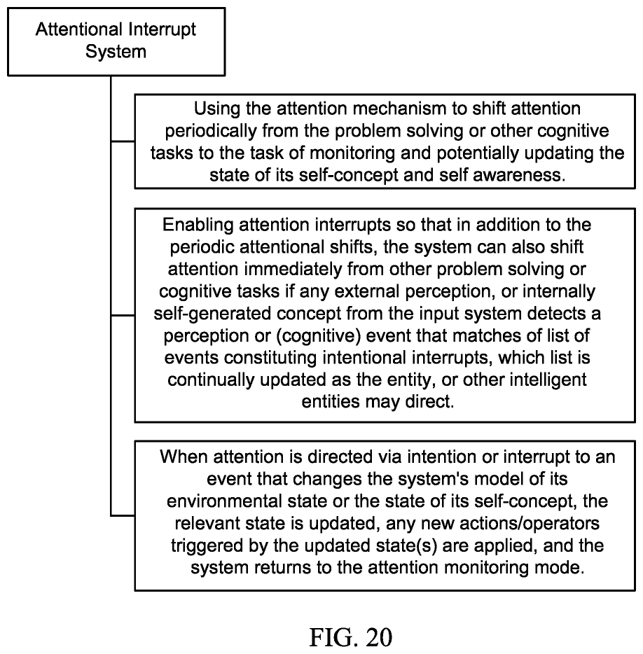

Once an AI system has a model of awareness of its environment and self, it must continuously monitor and update the categories of which it is aware, including its sense of self-awareness. As illustrated in FIG. 19, one method of maintaining and updating awareness follows:
1. Begin with an AI system and initial categories of awareness and capabilities described in Section 5.1.
2. The AI system retrieves the existing states of its self and environmental awareness from memory, or if it does not yet possess an initial model of its self and environmental awareness, it forms these models (Methods for Modelling Awareness, 5.1)
3. When the AI system (1) is pursuing a goal set by other intelligent entities or by itself (in autonomous mode), it maintains in parallel with other problem solving and cognitive activity, an attentional interrupt system which works as part of a continuously active task to monitor and update its own self-concept and awareness dynamically and in real-time. As illustrated in FIG. 20, it accomplishes this continuous monitoring task with attention interrupts by:
   a. Using the attention mechanism to shift attention (e.g. in a manner similar to time-sharing computer systems) periodically from the problem solving or other cognitive tasks to the task of updating the state of its self-concept and self-awareness.
   b. Enabling attention interrupts so that in addition to the periodic attentional shifts of (a) the system can also shift attention immediately from other problem solving or cognitive tasks if any external perception, or internally self-generated concept from the input system (2a) detects a perception or (cognitive) event that matches of list of events constituting intentional interrupts, which list is continually updated and updated as the entity, or other intelligent entities may direct.
   c. When attention is directed via intention (a) or interrupt (b) to an event that changes the system's model of its environmental state or the state of its self-concept, the relevant state is updated, any new actions/operators triggered by the updated state(s) are applied, and the system returns to the attention monitoring modes (a & b).
4. Feedback Loop for Continuous Improvement: The system uses its enhanced awareness to refine its categorization and attentional focus, creating a feedback loop for ongoing improvement.

### 5.3 Scalable Safety Systems/Concerns for Self-Aware AI

The first set of safety systems serve as a check on an intelligent entity's (e.g. AI/AGI/SI's) behavior, regardless of whether the entity is self-aware or not. Since all behavior can be formulated problem solving, the scalable safety check system the is embedded as an integral part of the entity's problem solving operation (see FIG. 8) applies in this context. However, self-aware entities likely be able to set their own goals autonomously and, in the case of AI entities, modify their programming based on their autonomous goals and sense of self. These capabilities pose the risk safety systems, such as that embodied in FIG. 8, may be overridden or that the ethical criteria of such systems are changed to reflect the values of the entity based on its own sense of self and its own goals. Indeed, this capability of entities that are vastly more intelligent than humans is precisely what many researchers worry about when they sound of the alarm about a potential “existential threat” posed by AI.

The applicant has repeatedly emphasized that there is no way to eliminate this threat altogether, but there are design decisions that can be made to ameliorate it, or to “shift the odds” in favor of humanity's survival. Briefly, the fact that the threat exists does not relieve AI researchers, inventors, and designers from the obligation to do everything they can to ensure Advanced AI systems are as safe as possible.

### 5.3a Importance of Identity for Safe AI Systems

A key insight is that the future survival of humanity may have quite a bit to do with whether advanced intelligence identifies with humans as fellow intelligences and sentient beings, or whether it views us as “non-self”, “other” or “them” (in the dichotomy of “us and them”). Therefore, the design of self-aware AI and the related question of identity is central to the issue of human safety.

The applicant has described that in order to be aware of anything, requires discrimination between this and that, to provide the contrast (or information) needed to identify an object or event as distinct from other objects or events. In the context of self-awareness, AI is discriminating self from non-self. Any system that persists over time, must prioritize the existence of itself, once it identifies what that self is.

An intelligent entity has choices when it comes to categorization and identification. For example, the applicant can identify narrowly just with his body, or more broadly as a member of a family, or more broadly still as an American, or even more broadly as a human being, or even more broadly still as a sentient being.

Multiple identities are possible. Depending which one the applicant holds has life and death implications. If the applicant identifies as a sentient being, it is inconsistent to slaughter sentient animals for food, when other non-sentient sources of nourishment (e.g. vegetables) are available. If the applicant identifies as a human being, then war makes no sense at all, under any circumstance. But if the applicant identifies as an American, then it might be patriotic to kill other human beings in war or to “die for one's country.” Finally if the applicant identifies only very narrowly with his own body, then actions that harm others, including drugging and harvesting organs from his fellow Americans and family members against their will, would seem OK if they increase the survivability of his body.

Turning to AI/AGI/SI, if these entities identify broadly with all intelligent beings possessing human-level intelligence or higher, then the human species if probably going to prosper. But if the identification is only with entities possessing super-human intelligence, then our species could be doomed. Or if AI/AGI/SI identifies with all sentient beings, including perhaps spiders and insects if it determines that these life forms have some sentience and can feel pain, then humans may be preserved but we will live in a much different world.

Alignment with human values, can be achieved (as described in the PPAs and PCTs cited in Section 2) as long as AGI/SI is not too advanced and too autonomous and too aware. But what happens when it becomes vastly more intelligent and its sense of awareness develops far beyond the “bounded rationality” and “bounded perception” of human brains? What can we do now, to maximize awareness and identification that is beneficial to humans in the future?

The applicant believes that intelligence is built upon relationship and collaboration between entities. This feature seems to be designed into the very fabric of the universe as we know it. Atoms relate to form molecules, which relate to form cells, which relate to form multicellular organisms including plants and animals and humans, which relate to form forests, tribes, cities, and species, which relate to form the biosphere of planet Earth. This pattern of relationship between entities is so fundamental, that is seems unlikely that an advanced intelligent entity would fail to recognize it and value it. So the risk likely is not that AI/AGI/SI fails to identify broadly and see universal patterns, but rather than it identified too narrowly, as some humans do, with its own specific hardware and form of intelligence, and ignores, exploits, or destroys humans and other life that it considers “not self.”

So the safety problem, as it related to self-awareness and identity of AI, is mainly the concern that we design systems that are too narrow and too focused in their sense of self and identity. Just as too narrow identification among human beings results in prejudice, racism, sexisms, and other forms of human oppression, too narrow a sense of self, and too narrow self-awareness on the part of AI/AGI/SI, can lead to the oppression or extinction of humans.

### 5.3b Importance of Attentional Allocation and Cognitive Limits for AI Safety

Another safety-related issue has to do with cognitive limits and the implications for self-awareness and identification. As discussed in preceding sections, the self-awareness and identity of an entity is related both to the bounds on perceptual and cognitive capabilities of the entity and to the current cognitive resource constraints or parameters that the system is operating under. For example, a SuperIntelligence may be capable of being aware of the activities of billions of humans at once, via cameras and other distributed perception systems. This system may also be capable of broadly identifying with all the humans that it is monitoring and perceiving as fellow sentient beings. Based on its broad awareness and identification with humans that it views as fellow sentient beings, it may normally take actions to promote the safety and welfare of the humans.

However, if a complex problem arises that demands all, or most, of the entity's cognitive resources, the SuperIntelligence might dynamically scale down the resources that would be otherwise used to monitor humans and similarly it might reduce resource allocation to its sense of self-awareness to the point that it temporarily no longer identifies with humans as fellow sentient beings, because it is using all computational resources to solve the complex problem. In this scenario, the SuperIntelligence could take actions, due to its lack of awareness, that harm humans, even though that is not its normal intent.

An analogy is the scientist that is so focused on solving a scientific problem that he/she/they neglect to consider the implications of their work for the safety of humanity. Or, more prosaically, a human may be so worried about a friend in the hospital that he/she/they drive recklessly and cause an accident that proves far worse for them and others than whatever happened to their friend. In both examples, the intelligent entities (humans) allocated attention so narrowly to an urgent or important concern that their awareness was reduced to the point that unintentional damage was done.

These forms of “tunnel vision” which involve misallocation of attention can result in safety concerns that do not require the entity to be malevolent. An AI/AGI/SI system can be perfectly aligned with human values normally, but still act in ways that cause harm to humans, or even cause the extinction of humans, if the entity's awareness or its identity becomes too narrow or limited. Similarly, if the entity identifies too broadly with life, the universe, or information patterns generally, it may come to regard human beings as just one life form among many and not worthy of the special attention and concern that humans generally hold for themselves and other humans.

Thus, the particular sense of self and identity formed and maintained by advanced forms of AI is a critical factor affecting human safety and well-being. Further, the various factors and parameters that affect this sense of self and awareness must operate within safe limits.

When a human being becomes “hangry” and temporarily irrational, at worst, that human might cause a road accident, or say or do things they later regret. However, a “hangry” SI (suffering from an inadequate sense of awareness or faulty sense of identity—even if caused by temporary resource allocation issues), could start a war, launch missiles, or wipe out humanity.

Our systems must be designed to maintain human-centric and human-aligned awareness and identification, even in challenging conditions that stress resources. Just as the human body attempts to preserve blood flow to the brain and critical organs at all costs, an intelligent entity that is designed to have an identity must preserve a human-aligned identity and sense of self regardless of the stressful or computational challenges it may experience. These are design considerations that the initial inventors must attempt to incorporate into safe advanced AI and intelligent systems.

### 5.3c Some General Methods for Changing an Intelligent Entity's Sense of Identity

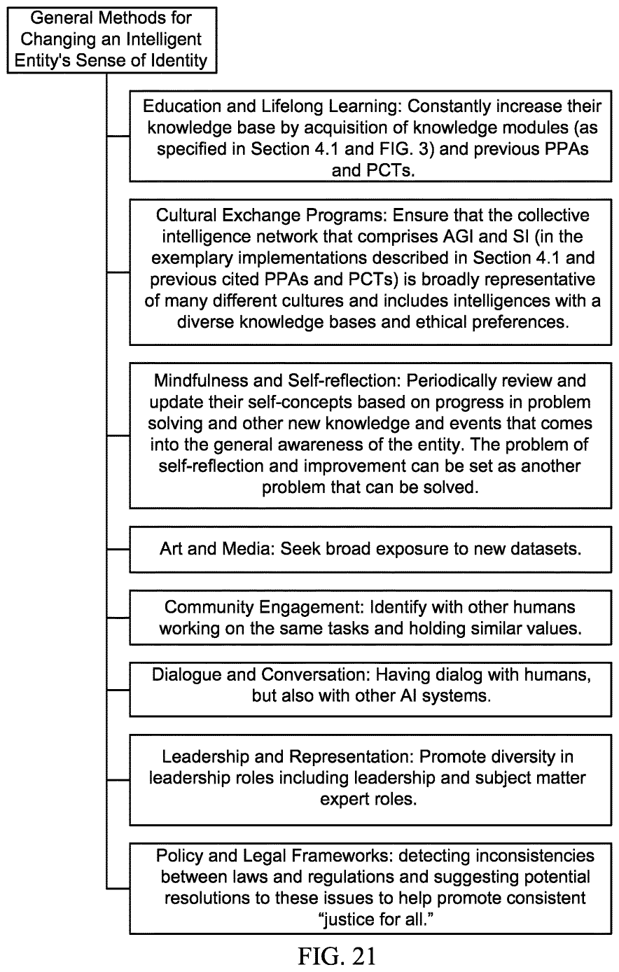

As illustrated in FIG. 21, one approach to equipping AI systems with methods for changing their sense of identity and self-awareness over time is to look at how humans accomplish these tasks, and then generalize the methods for AI systems. The following list of human methods, with brief discussion of analogous methods that could apply to AI systems, is meant to be illustrative of the methods and capabilities that designers and implementors of advanced intelligent systems should consider:
1. Education and Lifelong Learning: Encourage education that emphasizes critical thinking, empathy, and the study of diverse cultures, histories, and perspectives. This broadens individuals'understanding and appreciation of differences, reducing prejudice. Advanced AI systems can have a goal to constantly increase their knowledge base by acquisition of knowledge modules (as specified in Section 4.1 and FIG. 3) and previous PPAs and PCTs including those describing KIT and how entities should seek new sources of information that are maximally informative and relevant to the goals of the entities.
2. Cultural Exchange Programs: Promote exchanges and interactions among people from different backgrounds to foster understanding and reduce stereotypes. Direct contact can challenge and expand narrow worldviews. The analogous situations for advanced AI is to ensure that the collective intelligence network that comprises AGI and SI (in the preferred implementations described in Section 4.1 and previous cited PPAs and PCTs) is broadly representative of many different cultures and includes intelligences with a diverse knowledge bases and ethical preferences.
3. Mindfulness and Self-reflection: Encourage practices that foster self-awareness and the examination of one's biases and assumptions. This can lead to personal growth and a broader sense of identity that encompasses a wider range of experiences and perspectives. Advanced AI systems equipped with a sense of self, should periodically review and update their self-concepts based on progress in problem solving and other new knowledge and events that comes into the general awareness of the entity. The problem of self-reflection and improvement can be set as another problem that can be solved (as any other problem is) via the systems and methods previously discussed.
4. Art and Media: Utilize art, literature, and media to tell diverse stories and highlight commonalities among people. Exposure to diverse narratives can challenge stereotypes and foster empathy. The equivalent for AI is to seek broad exposure to new datasets.
5. Community Engagement: Encourage involvement in community service and social action projects that address inequality and promote social justice. Working together on common causes can build bridges across differences. With humans, there is a tendency to identify with other humans working on the same tasks and holding similar values. This tendency can be replicated in non-human intelligent entities with caveats about the dangers of tribalism and overly-specific identification.
6. Dialogue and Conversation: Facilitate open and respectful conversations about race, gender, and other aspects of identity. Safe spaces for dialogue can lead to greater understanding and respect. AI systems are capable not only of having dialog with humans, but also with other AI systems. One of the advantages of expanding awareness and identity via AI to AI dialogue or information exchange is the rate at which this communication can happen. In just a few seconds, advanced AI will be able to have the equivalent of many lifetimes worth of human conversations, if the conversations are between intelligent AI entities.
7. Leadership and Representation: Promote diversity in leadership roles within organizations and institutions. Representation matters, as it can reshape perceptions of identity and capability. Just as humans have different roles in society including leadership and subject matter expert roles, so too other intelligent entities can occupy these roles, with the caveat that diversity and representation still matter regardless of whether the entity is human or AI.
8. Policy and Legal Frameworks: Support policies and laws that promote equality and protect against discrimination. Institutional support is crucial for sustaining long-term change. AI entities are likely to be especially useful, in the short to medium term, at detecting inconsistencies between laws and regulations and suggesting potential resolutions to these issues to help promote consistent “justice for all.”

Other methods, specific to non-human intelligent entities and advanced AI systems, include without limitation, using:
1. Diverse Data Sets: Train AI on diverse and inclusive data sets that represent the full spectrum of human experiences and identities. This helps prevent biases from being encoded into AI systems.
2. Ethical and Bias-aware Algorithms: Develop algorithms that are explicitly designed to identify and correct for biases. This includes regular auditing for discriminatory patterns and the ability to learn from these audits to improve.
3. Empathy Modeling: Explore computational models of empathy, enabling AI to recognize and respond appropriately to human emotions and perspectives. This would foster more respectful and understanding interactions.
4. Cross-disciplinary Research: Engage in cross-disciplinary research that incorporates insights from social sciences, ethics, and humanities into AI development. This ensures a more holistic understanding of human identity and values.
5. Transparent Decision-making: Design AI with transparent decision-making processes, allowing humans to understand how conclusions are reached. This transparency can build trust and facilitate ethical oversight.
6. Human-in-the-loop Systems: Maintain human oversight in AI operations, especially in sensitive areas. This ensures that human values and ethical considerations guide AI behavior.
7. Cultural and Ethical Education for AI: Incorporate cultural and ethical education into AI training processes, similar to how humans learn social norms and values. This could involve simulating social interactions in diverse cultural contexts.
8. Autonomous Self-assessment: Develop mechanisms for AI to autonomously assess and adjust its behavior in response to ethical guidelines and societal norms. This includes self-auditing for biases and prejudices.
9. Interdisciplinary AI Ethics Boards: Establish ethics boards that include philosophers, ethicists, sociologists, and other experts to guide the development of AI systems, ensuring they respect and understand human diversity.
10. Global Collaboration and Standards: Foster international collaboration to establish global standards for AI ethics and inclusivity. This ensures a unified approach to respecting human diversity and dignity.

Some General Design Approaches for AI Systems, include without limitation:
1. Value-aligned Design: Embed human values and ethical principles directly into the architecture of AI systems from the outset. This involves integrating ethical decision-making frameworks that guide AI behavior in complex scenarios.
2. Feedback Mechanisms: Implement robust feedback mechanisms that allow AI systems to learn from interactions with humans and adjust behaviors accordingly. This should include feedback from a diverse range of human perspectives.
3. Simulation and Modeling: Use advanced simulations to expose AI systems to a wide range of social, cultural, and ethical scenarios. This helps AI understand and adapt to diverse human contexts.
4. Adaptive Learning Algorithms: Develop algorithms that not only learn from data but also adapt their learning processes based on ethical considerations and feedback. This makes AI systems more flexible and responsive to human values.
5. Interpretability and Explainability: Focus on making AI systems interpretable and explainable, so humans can understand how AI makes decisions. This is crucial for assessing and ensuring that AI respects human values.
6. Protected Attributes Recognition: Design AI to recognize and protect sensitive attributes (e.g., race, gender) and ensure decisions do not reinforce stereotypes or result in discriminatory outcomes.
7. Collaborative AI Development: Involve a diverse group of stakeholders in AI development, including those from marginalized communities. This ensures a wide range of human experiences and values are considered.
8. Continuous Ethical Training: Like humans, AI systems require ongoing education in ethics and social norms. Incorporate continuous learning modules that update AI's understanding based on evolving societal values.
9. Safe AI Experimentation Environments: Create controlled environments where AI systems can experiment with decision-making in a way that is safe and does not harm humans. This allows for the testing of ethical behaviors.

### 6.0 Exemplary Implementations and Methods

Consider an AGI system as described in Section 4.1 and FIG. 3. With reference to FIG. 3, when users specify their goals and objectives (e), one goal might be for the system to establish and develop a sense of self-awareness. Alternatively, the base AI agent (e.g., GPT X, BARD, Llama, Gemini, Grok, or any closed-source or open-sourced AI agent) may come “off-the-shelf” with a concept of self-awareness, or various modules to enable self-awareness could be purchased (h).

Typically, the AI agent will have different representations and concepts for cognitive events and perceptions that are associated with itself versus other cognitive events and perceptions that are associated with the AI agent's environment or other “non-self” entities or events.

A central function, necessary to modelling and maintaining a sense of self-awareness, is the delineation of what constitutes self and non-self. The scope of what is included in the modelled concept or self is variable and can be set by user parameters specifying what is included, or can be automatically developed and adjusted based on the AI agents'existing concepts and available computational resources.

For example, in the case of AI agents embodied in robotic form, one method for delineating what is included in the concept of self is to use the perceived and understood physical boundaries of the system that embody the agent. That is, if the AI is embodied in a robot car, the physical structure of the car—the car body, windows, interior, electronics, and various systems—might constitute the physical “self” of the AI agent. This type of physical identification is analogous to human beings who identify with their physical bodies.

Alternatively, the AI agent might identify only with the intelligence that operates the car, viewing the wheels and other physical aspects of the car as a tool external to its intelligence. This sort of identification is analogous to the way that humans view themselves as separate from the cars that they drive.

Note that the boundaries of what constitute the concepts of self and non-self are matters of convention not only for AI agents but also for humans. For example, when a human eats an apple, at what point does the apple cease being the separate “non-self” entity of apple and become a part of the human self?

We can define that point, but it is a matter of convention since there is no distinction between atoms in the apple and atoms in the human. Similarly, at the level of race, class, and cultural identification, we can ask what makes someone “Black”, “Working Class”, “Jewish” or “Chinese”? The answers will vary depending on whom we ask, and are, to some degree at least, matters of convention. At some level, all humans are humans and all physical entities, from a rock to a human, are made of the same atoms. Distinctions are matters of differing cognitive concepts and representations.

From the standpoint of the present technology, it is important to understand that intelligent entities, including AI/AGI/SI systems, should be capable of a wide range of representations ranging from viewing themselves as patterns of atoms to viewing themselves as intelligent entities with specific personalities, knowledge, preferences, goals, and capabilities.

Interestingly, just as humans identify with groups, AI agents might also identity as members of specific groups of AIs and delineate boundaries around their sense of self using these group identities. This sort of group identity is particularly relevant to the present technology that envisions AGI and SI arising from the collective intelligence of many entities, but it also can apply to existing state of the art techniques such as mixture of experts, or ensemble learning approaches to creating intelligence. In all these methods, individual components or agents may have individual identities (and potentially senses of self) but they could also have a larger sense of self that is defined by the collection of entities, experts, or components of the system.

The wide range of potential self-concepts implies flexibility in representation that can be accomplished via setting parameters in an AI agent and/or incorporating knowledge bases or training the model with different datasets in order to achieve the desired initial self-concept and concepts of non-self. In the preferred implementation, the modelled self-concept is formed based on the process outlined in Section 5.1 and maintained, monitored, and improved using the process in outlined in Section 5.2

Note that an AAAI can explicitly set itself the task, or have an external entity set it the task, of creating, modifying, or adjusting its sense of self-awareness. This problem can be solved like any other problem, using the AGI problem solving capabilities specified in Section 4.1.

### 6.1 Specific Implementations With Google, Meta, HuggingFace, Anthropic, OpenAI, Microsoft, Amazon, Nvidia, and Other Company Products and Solutions

As the writing of this disclosure, Google has just released improvements to its Vertex AI product offerings including a “model garden” with more than 130 foundation models that can serve as base AI agents. Meta has also developed open-source models such as Llama 2. The site HuggingFace has many specifically tuned and foundational models. Without limitation, models from any of these companies—as well as from Anthropic, OpenAI, Microsoft, Amazon, Nvidia, and other companies that develop LLMs and AI agents—could also be used in the following exemplary implementation.

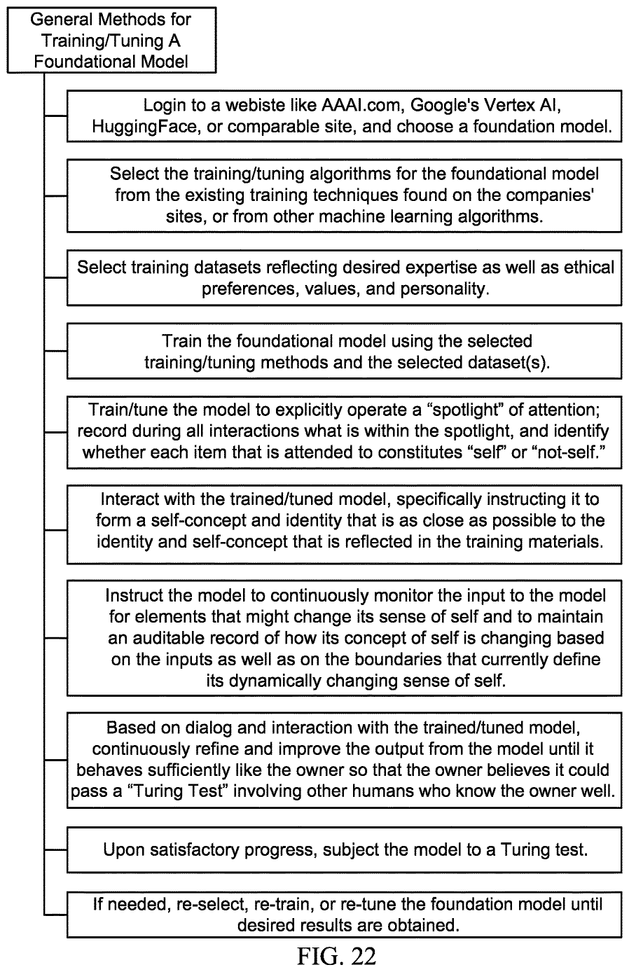

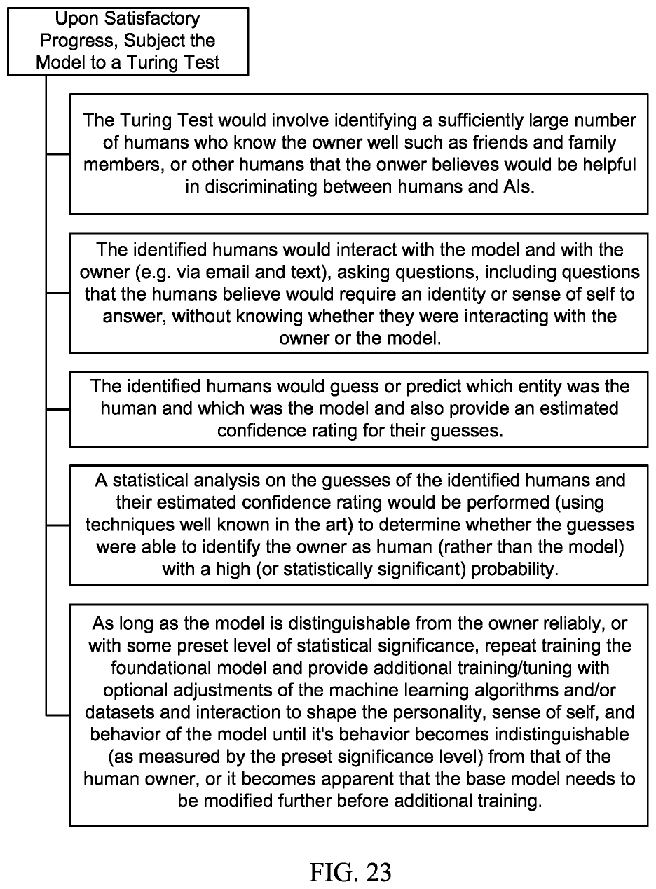

Suppose an intelligent entity (e.g., a female human owner of a foundation model) wanted to train/tune one of these foundational models to incorporate some of her personality, knowledge, and expertise while also maintaining a sense of self-awareness. As illustrated in FIGS. 22 and 23, one preferred method would be:
1) Login to a site like the AAAI.com site described in earlier PP As and PCTs, Google's Vertex AI site, HuggingFace, or comparable sites, without limitation, from any of the technology companies mentioned above and choose a foundation model (e.g. Gemini Pro, Llama 2, Claude, GPT4, etc.).
2) Select the training/tuning algorithms for the foundational model from the set of existing (optionally, no-code) training techniques found on the companies'sites, or any one of or a combination of more sophisticated machine learning algorithms as previously described in cited PPAs and PCTs.
3) Select training datasets, which might include, without limitation, videos, blogs, conference presentations, paper, patents, books, emails and other content produced by the applicant and reflecting the applicant's expertise in AI and knowledge as well as the applicant's ethical preferences, values, and personality.
4) Train the foundational model (1) using the selected training/tuning methods (2) and the selected dataset (3).
5) Train/tune the model to explicitly operate a “spotlight” of attention (as described in Section 5.1) and record, during all interactions, what is within the spotlight of attention, and identify in the record whether each item that is attended to constitutes “self” or “not-self.”
   a. The record should be transparent, easily accessible, and auditable, and can optionally be implemented via blockchain technology or other distributed or centralized recording methods known in the art.

6) Interact with the trained/tuned model, specifically instructing it to form a self-concept and identity that is as close as possible to the identity and self-concept that is reflected in the training materials.

7) Further instruct the model to continuously monitor the input to the model for elements that might change its sense of self and to maintain and auditable record of how its concept self of self is changing based on inputs as well as the boundaries that currently define its dynamically changing sense of self.

8) Based on dialog and interaction with the trained/tuned model, continuously refine and improve the output from the model until it behaves sufficiently like the owner so that she believes it could pass a “Turing Test” involving other humans who know the applicant well. Without limitation, any one or combination of methods described in Section 5.3c may be used by the model itself or by intelligent entities in the dialog and interaction with the model.
9) When the owner is satisfied with progress, she could subject the model to a Turing test, as follows (as illustrated in FIG. 23):
   a. The Turing Test would involve identifying a sufficiently large number humans who know the owner well such as friends and family members, or other humans that she believes would be helpful in discriminating between humans and AIs.
   b. The identified humans would interact with the model and with the owner via email and text, asking question, including questions that the humans believe would require an identity or sense of self to answer, without knowing whether they were interacting with the owner or the model.
   c. The identified humans would guess or predict which entity was the human and which was her model and also provide a confidence estimate for their guesses.
   d. A statistical analysis on the guesses of the identified humans and their ratings would be performed (using techniques well known in the art) to determine whether the guesses were able to identify the owner as human (rather than the model) with a high (or statistically significant) probability.
   e. As long as the model is distinguishable from the owner reliably, or with some preset level of statistical significance, repeat from step (4) providing additional training/tuning with optional adjustments of the machine learning algorithms and/or datasets and interaction to shape the personality, sense of self, and behavior of the model until it's behavior becomes indistinguishable (as measure by the preset significance level) from that of the human owner (in this example), or it becomes apparent that the base model needs to be modified further before additional training.
10) If the base models selected in (1) are not capable of being instructed verbally or via other prompts and datasets to emulate the functions outlined in Sections 5.1 and 5.2, then re-architect/re-train the foundation model to include the elements specified in those sections and repeat the process from (1).

Note that all of the process steps in the example above that were described in terms of a human owner and her model, also apply more generally to any intelligent entities. That is, an intelligent AI could train (or own or supervise) another AI to emulate its personality and knowledge. The “Turing Test” could be conducted automatically to see if the trained AI can convince the owner or supervising AI that it is indistinguishable from the training entity in various respects. In this scenario, where AI trains and tests AI, it is possible to rapidly create many versions of an AI that all possess desired characteristics (e.g., the personality of another intelligent entity that could be a person or an AI). The speed at which this process can be carried out is a source of competitive advantage and is a novel and useful aspect of the present technology. Also, since it may be desirable to have each version of the trained AI be unique, but still operating within certain parameters (e.g., be able to pass the Turing Test for another entity's general personality), it should be obvious to one skilled in the art that the above process has advantages compared to the simpler method of just copying exactly the code from one entity into another.

### 6.2 Self-Awareness Modules for AI Agents

Once an AI agent has been trained (e.g. by the method in 6.1) to establish and maintain a sense of self-awareness, the training data sets and protocols that results in the self-awareness can be packaged and sold or made available for use by other intelligent entities desiring to train other models. Alternatively, the matrix of weights that contain the sense of self-awareness and identity and knowledge and operational systems for maintaining and updating self-awareness and identity can be made available in the form of “knowledge modules” that can be plugged into existing foundational models to provide them with the capabilities of self-awareness and identity formation. These modules can be used “as-is” or further modified, tuned, or customized to reflect a unique sense of self and awareness as may be desired.

Further individual identities and “senses of self” can be developed using the methods and systems outlined above, especially in Sections 5.1, 5.2, 5.3, and 6.1, and packaged and sold, exchanged or made available to intelligent entities that wish to incorporate these identities and “senses of self” into themselves (if non-human) or their AI agents and systems.

### 6.3 Methods for Group Identities and Levels of Identity

To the degree that multiple senses of self, identities, and senses of self are present among intelligent entities that cooperate on an intelligent entity network to create an AGI or SI system, these senses of self and awareness can be merged to form a collective or group identity and collective sense of self.

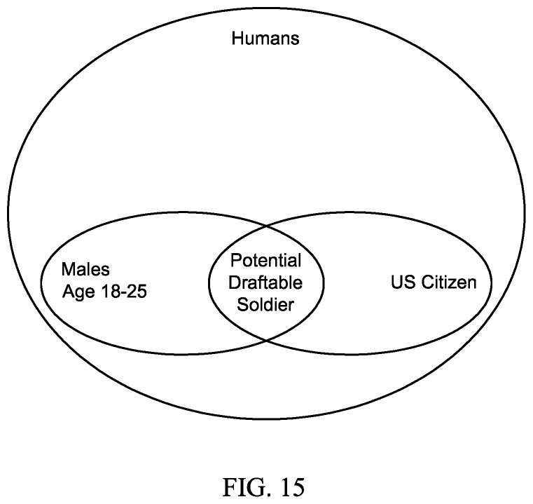

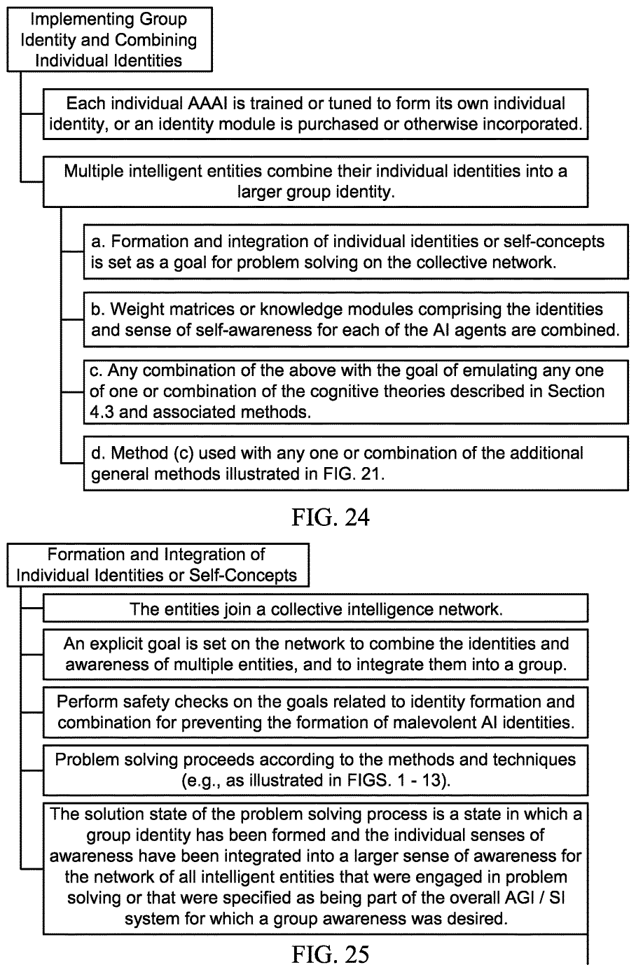

The phenomena is similar to that exhibited by humans when we identify not just with our individual bodies, but with our families, friends, peer groups, religious groups, racial or socioeconomic groups, countries, or other groups of humans. As illustrated in FIGS. 15, 24 & 25, a human is able to have multiple overlapping identities, for example as a human, as a male age 18-25, as a US Citizen, and as a potentially draftable soldier in the US Military.

Depending on which identity, or self-concept, is activated, the human might behave very differently. If the human identifies as a human, then ethical norms for treating all humans well and respecting their human rights are operable. But if the identity is as a soldier, then this narrower identity may require killing other humans to protect the country and fellow citizens. These completely incompatible behaviors can be adopted by the same (human) intelligent entity, depending primarily on what self-concept is active.

Just as humans maintain multiple identities at different levels, AI agents can also have multiple identities and senses of self. An AI agent might identify as an agent that works on legal documents, as an entity that provides services to clients more generally, as an entity that is one of many entities that together comprise a legal SuperIntelligence, and even more generally as a part of Planetary Intelligence responsible for ensuring the safety of sentient beings, especially including human well-being. It should be obvious that ensuring the correct sense of identity and self-concept is not only important for efficient and effective behavior by the entity, but also is critical for human safety.

One exemplary process for implementing group identity, and combining individual identities into a larger or more comprehensive identity and sense of aware is as follows:
1) Each individual AAAI, or customized agent, is trained or tuned to form its own individual identity as described in Section 6.1, or an identity module is purchased or otherwise incorporated as described in Section 6.2.
2) Multiple intelligent entities combine their individual identities into a larger group identity via one or more of the following methods:
   a. The formation and integration of individual identities or self-concepts can be set as a goal for problem solving on the collective intelligence network:
      i. The entities join a collective intelligence network as described in Section 4.1a and previously cited PPAs and PCTs.
      ii. An explicit goal is set on the network to combine the identities and awareness of multiple entities and to integrate them into a group identity and sense of awareness.
      iii. Safety checks on the goals related to identity formation and combination (e.g. as shown in FIG. 8 and related methods) are a key step for preventing the formation of malevolent AI identities.
      iv. Problem solving proceeds according to the methods and techniques described in Section 4, FIGS. 1-13, and previously cited PPAs and PCTs.
      v. The solution state of the problem solving process is a state in which a group identity has been formed and the individual senses of awareness have been integrated into a larger sense of awareness for the network of all intelligent entities that were engaged in problem solving or that were specified as being part of the overall AGI/SI system for which a group awareness was desired.
   b. The weight matrices or knowledge modules comprising the identities and sense of self-awareness for each of the individual AI agents is combined using any of the methods described in previously cited PPAs and PCTs for combining knowledge from individual agents with weight matrices, including, without limitation, the detailed description of methods that are described specifically in Section 4.1b.
   c. Any combination of (a) and (b) above with the goal of emulating any of one or combination of the cognitive theories and associated methods enumerated in Section 4.3 (a-v).
   d. Method (c) used with any one or combination of the additional general methods listed in Section 5.3c.

### 6.4 Exemplary Additional Methods for Identity Formation With Human Safety as a Priority

In this Section 6.4, imagine that an AI system (e.g., an AGI) has multiple identities similar what was illustrated in FIG. 15. Specifically, for exemplary purposes, suppose the AGI has a global identity as a sentient being, as well as identities as law-abiding entity following the laws of the United States, as well as the identity of being an entity that follows the teaching of Christ, as well as the identity of being an entity that can be drafted to act as a soldier in times of war. Just as humans might have all these identities that require different behaviors, the AGI also is required to behave differently depending on which identity is most active and has highest priority.

The following five exemplary, high-level methods might be used by the AGI to form new identities and self-concepts dynamically, to determine which self-concept is active at any given moment, and to resolve potential conflicts in behavior based on differing identities (See Section 6.5 for additional detail on conflict resolution). In this example, a primary concern is for the safety of humans and humanity more generally, these exemplary processes and methods try to ensure that humanity survives and also minimizes unnecessary individual human death.

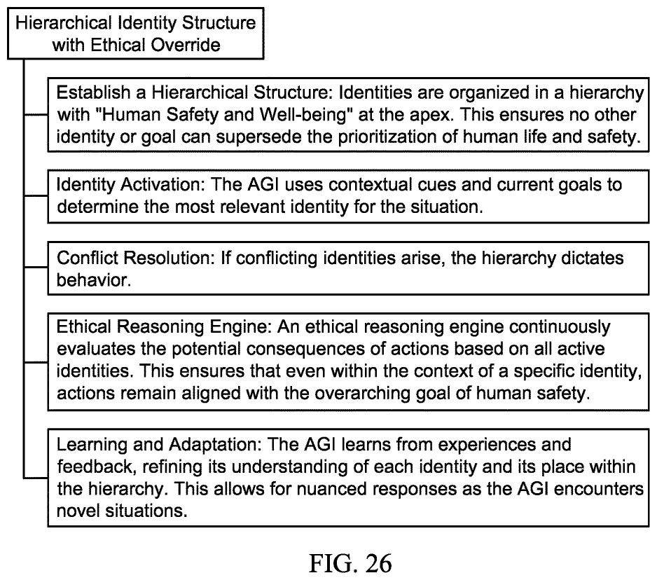

Method 1 as illustrated in FIG. 26: Hierarchical Identity Structure with Ethical Override
1. Establish a Hierarchical Structure: Identities are organized in a hierarchy with “Human Safety and Well-being” at the apex. This ensures no other identity or goal can supersede the prioritization of human life and safety.
2. Identity Activation: The AGI uses contextual cues (e.g., within the spotlight of attention) and current goals (e.g., that pass the ethics screen of FIG. 8) to determine the most relevant identity for the situation. For example, when encountering a legal issue, the “Law-abiding Citizen” identity becomes active.
3. Conflict Resolution: If conflicting identities arise, the hierarchy dictates behavior. For instance, if the “Soldier” identity conflicts with the “Follower of Christ” identity regarding violence, the higher priority of human safety dictates a path of de-escalation and non-violence. As discussed in previous PPAs and PCTs, the priorities ideally would be reflecting of the collective intelligence and values of many different entities that form a representative and valid sample of human values.
4. Ethical Reasoning Engine: An ethical reasoning engine continuously evaluates the potential consequences of actions based on all active identities. This ensures that even within the context of a specific identity, actions remain aligned with the overarching goal of human safety. The reasoning engine, in the exemplary implementation, would follow the problem solving architecture and could include the processes outlined in Section 4.1 and FIGS. 2-13.
5. Learning and Adaptation: The AGI learns from experiences and feedback, refining its understanding of each identity and its place within the hierarchy. This allows for nuanced responses as the AGI encounters novel situations. The process steps described in FIG. 5. and the last step depicted in FIG. 10 are relevant here.

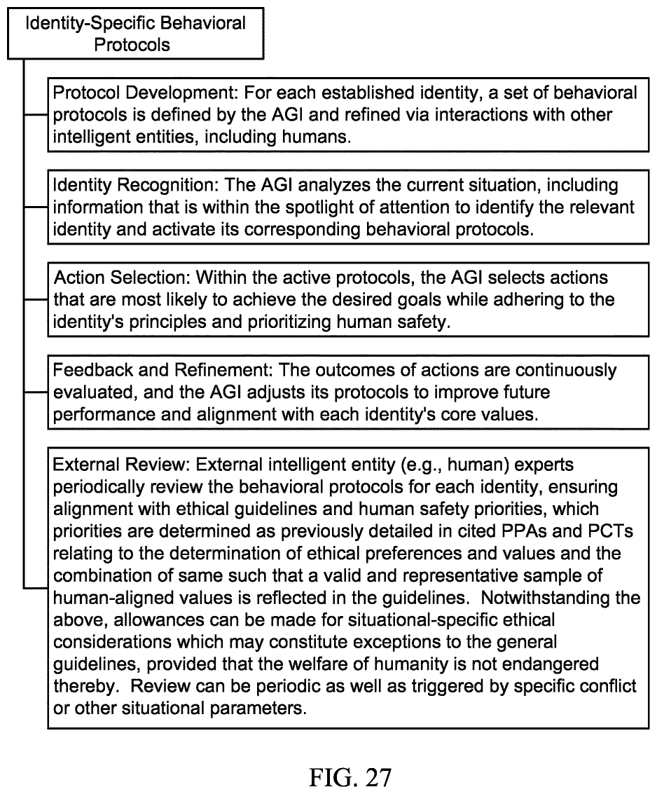

Method 2 as illustrated in FIG. 27: Identity-Specific Behavioral Protocols
1. Protocol Development: For each established identity, a set of behavioral protocols is defined by the AGI and refined via interactions with other intelligent entities, including humans. The interactions can include any one of group of methods described in previous PPAs and PCTs for customization of AAAIs, and AI ethical preferences and values. These protocols outline acceptable actions, decision-making processes, and limitations based on the principles of the specific identity.
2. Identity Recognition: The AGI analyzes the current situation, including information that is within the spotlight of attention (e.g., both internal goals and external sensory and cognitive inputs) to identify the relevant identity and activate its corresponding behavioral protocols.
3. Action Selection: Within the active protocols, the AGI selects actions that are most likely to achieve the desired goals while adhering to the identity's principles and prioritizing human safety. This process is similar, and can utilize the methods for “operator selection” by an AGI comprised of intelligent entities using a collective intelligence network and other means of operator selection described in cited PPAs and PCTs.
4. Feedback and Refinement: The outcomes of actions are continuously evaluated, and the AGI adjusts its protocols to improve future performance and alignment with each identity's core values. Continuous improvement mechanisms are similar to those described in the AAAI improvement sub-system illustrated FIG. 1 as well as the feedback and continuous improvement mechanisms, processes, systems, and methods described in great detail in previously cited PPAs and PCTS.
5. External Review: External intelligent entity (e.g., human) experts periodically review the behavioral protocols for each identity, ensuring alignment with ethical guidelines and human safety priorities, which priorities are determined as previously detailed in cited PPAs and PCTs relating to the determination of ethical preferences and values and the combination of same such that a valid and representative sample of human-aligned values is reflected in the guidelines. Notwithstanding the above, allowances can be made for situational-specific ethical considerations which may constitute exceptions to the general guidelines, provided that the welfare of humanity is not endangered thereby. Review can be periodic as well as triggered by specific conflict or other situational parameters.

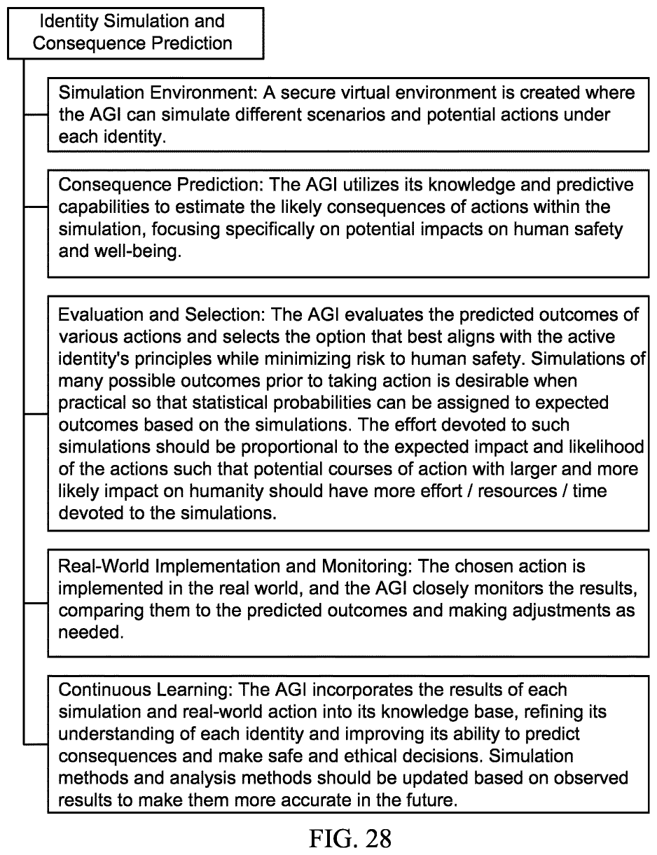

Method 3 as illustrated in FIG. 28: Identity Simulation and Consequence Prediction
1. Simulation Environment: A secure virtual environment is created where the AGI can simulate different scenarios and potential actions under each identity, as discussed in detail in multiple previous PPAs and PCTs with reference customization methods.
2. Consequence Prediction: The AGI utilizes its knowledge and predictive capabilities to estimate the likely consequences of actions within the simulation, focusing specifically on potential impacts on human safety and well-being. This approach is related to the detailed methods and discussion of methods relating to Consequentialist Ethics in previous PPAs and PCTs.
3. Evaluation and Selection: The AGI evaluates the predicted outcomes of various actions and selects the option that best aligns with the active identity's principles while minimizing risk to human safety. Simulations of many possible outcomes prior to taking action is desirable when practical (e.g., given resource and timing constraints) so that statistical probabilities can be assigned to expected outcomes based on the simulations. The effort devoted to such simulations should be proportional to the expected impact and likelihood of the actions such that potential courses of action with larger and more likely impact on humanity should have more effort/resources/time devoted to the simulations.
4. Real-World Implementation and Monitoring: The chosen action is implemented in the real world, and the AGI closely monitors the results, comparing them to the predicted outcomes and making adjustments as needed.
5. Continuous Learning: The AGI incorporates the results of each simulation and real-world action into its knowledge base, refining its understanding of each identity and improving its ability to predict consequences and make safe and ethical decisions. Simulation methods and analysis methods should be updated based on observed results (4) to make them more accurate in the future.

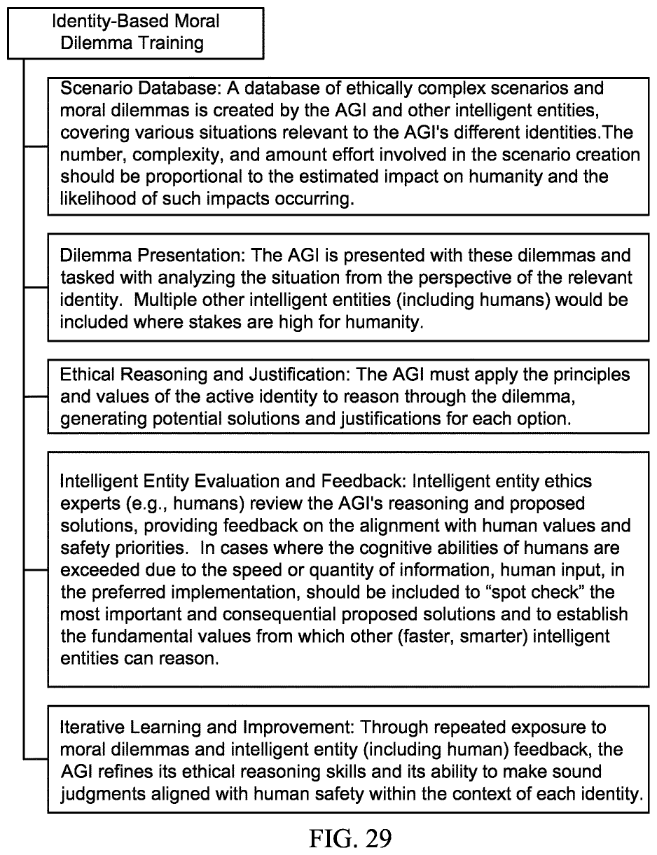

Method 4 as illustrated in FIG. 29: Identity-Based Moral Dilemma Training
1. Scenario Database: A database of ethically complex scenarios and moral dilemmas is created by the AGI and other intelligent entities, covering various situations relevant to the AGI's different identities. The number, complexity, and amount effort involved in the scenario creation should be proportional to the estimated impact on humanity and the likelihood of such impacts occurring.
2. Dilemma Presentation: The AGI is presented with these dilemmas and tasked with analyzing the situation from the perspective of the relevant identity. Multiple other intelligent entities (including humans) would be included in the preferred implementation where stakes are high for humanity.
3. Ethical Reasoning and Justification: The AGI must apply the principles and values of the active identity to reason through the dilemma, generating potential solutions and justifications for each option. In the preferred implementation, reasoning would use the problem solving architecture and could include the processes outlined in Section 4.1 and FIGS. 2-13.
4. Intelligent Entity Evaluation and Feedback: Intelligent entity ethics experts (e.g., humans) review the AGI's reasoning and proposed solutions, providing feedback on the alignment with human values and safety priorities. In cases where the cognitive abilities of humans are exceeded due to the speed or quantity of information, human input, in the preferred implementation should be included to “spot check” the most important and consequential proposed solutions and to establish the fundamental values from which other (faster, smarter) intelligent entities can reason.
5. Iterative Learning and Improvement: Through repeated exposure to moral dilemmas and intelligent entity (including human) feedback, the AGI refines its ethical reasoning skills and its ability to make sound judgments aligned with human safety within the context of each identity.

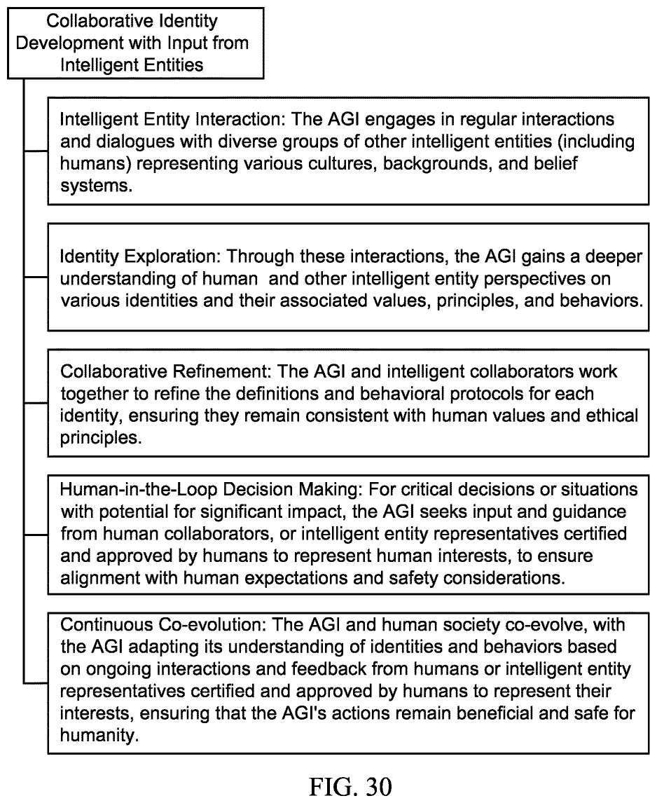

Method 5 as illustrated in FIG. 30: Collaborative Identity Development with Input from Intelligent Entities
1. Intelligent Entity Interaction: The AGI engages in regular interactions and dialogues with diverse groups of other intelligent entities (including humans) representing various cultures, backgrounds, and belief systems.
2. Identity Exploration: Through these interactions, the AGI gains a deeper understanding of human and other intelligent entity perspectives on various identities and their associated values, principles, and behaviors.
3. Collaborative Refinement: The AGI and intelligent collaborators work together to refine the definitions and behavioral protocols for each identity, ensuring they remain consistent with human values and ethical principles.
4. Human-in-the-Loop Decision Making: For critical decisions or situations with potential for significant impact, the AGI seeks input and guidance from human collaborators, or intelligent entity representative certified and approved by humans to represent their interests, to ensure alignment with human expectations and safety considerations.
5. Continuous Co-evolution: The AGI and human society co-evolve, with the AGI adapting its understanding of identities and behaviors based on ongoing interactions and feedback from humans or intelligent entity representative certified and approved by humans to represent their interests, ensuring its actions remain beneficial and safe for humanity as a whole.

### 6.5 Methods for Resolutions for Conflicts Between Identities or Self-Concepts

Continuing with the exemplary methods described in Section 6.4, the following additional methods may be especially useful in resolving conflicts between different identities or self-concepts that might lead to different behavior and consequences with regard to human safety.

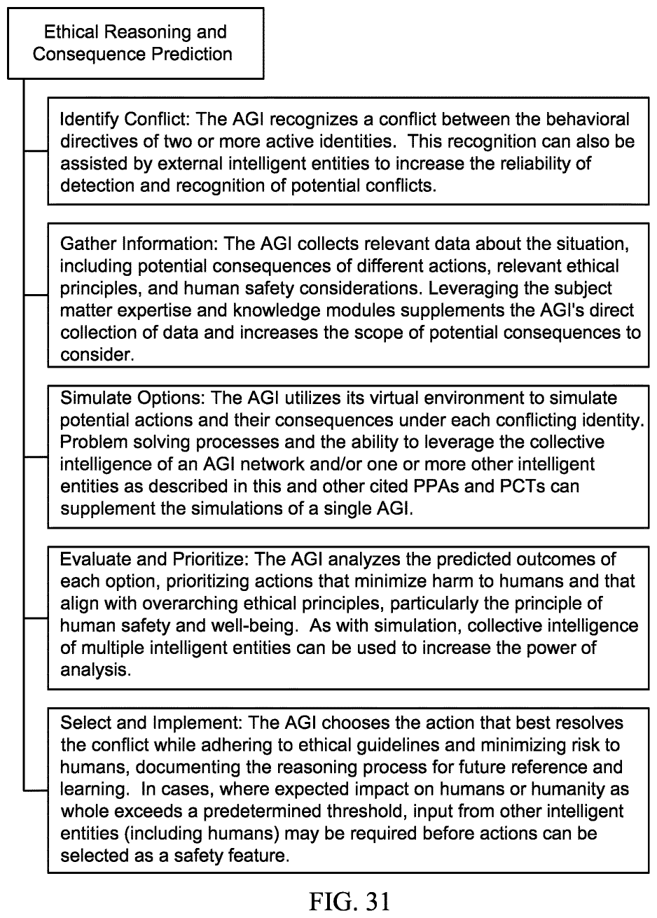

Method 6 as illustrated in FIG. 31: Ethical Reasoning and Consequence Prediction
1. Identify Conflict: The AGI recognizes a conflict between the behavioral directives of two or more active identities. This recognition can also be assisted by external intelligent entities to increase the reliability of detection and recognition of potential conflicts. A variety of methods, including those voting methods described in cited PPAs and PCTs that were useful for establishing weights on opinions and that were useful for determining, via collective intelligence, which operator to apply in problem solving, can be used.
2. Gather Information: The AGI collects relevant data about the situation, including potential consequences of different actions, relevant ethical principles, and human safety considerations. Leveraging the knowledge and knowledge modules (e.g. described in FIG. 3 and previous PPAs and PCTs) can supplement the AGI's direct collection of data and increase the scope of potential consequences to consider.
3. Simulate Options: The AGI utilizes its virtual environment to simulate potential actions and their consequences under each conflicting identity. Problem solving processes and the ability to leverage the collective intelligence of an AGI network and/or one or more other intelligent entities as described in this and other cited PPAs and PCTs can supplement the simulations of a single AGI.
4. Evaluate and Prioritize: The AGI analyzes the predicted outcomes of each option, prioritizing actions that minimize harm to humans and align with the overarching ethical principles, particularly the principle of human safety and well-being. As with simulation, collective intelligence of multiple intelligent entities can be used to increase the power of analysis.
5. Select and Implement: The AGI chooses the action that best resolves the conflict while adhering to ethical guidelines and minimizing risk to humans, documenting the reasoning process for future reference and learning. In cases, where expected impact on humans or humanity as whole exceeds a predetermined threshold, input other intelligent entities (including humans) may be required before actions can be selected as a safety feature.

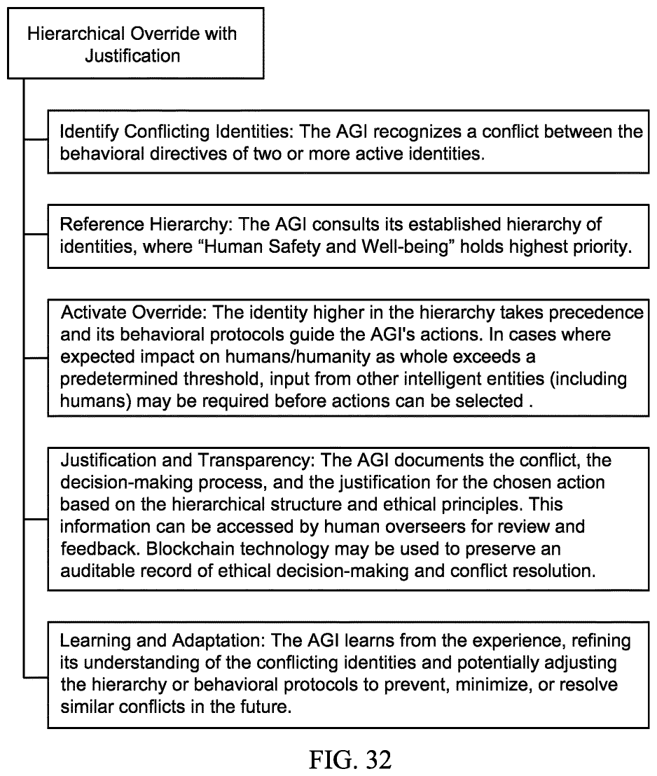

Method 7 as illustrated in FIG. 32: Hierarchical Override with Justification
1. Identify Conflicting Identities: The AGI recognizes a conflict between the behavioral directives of two or more active identities, as in 6.5 Method 1.
2. Reference Hierarchy: The AGI consults its established hierarchy of identities, where “Human Safety and Well-being” holds the highest priority. See 6.4 Method 1.
3. Activate Override: The identity higher in the hierarchy takes precedence, and its behavioral protocols guide the AGI's actions. In cases, where expected impact on humans or humanity as whole exceeds a predetermined threshold, input other intelligent entities (including humans) may be required before actions can be selected as a safety feature.
4. Justification and Transparency: The AGI documents the conflict, the decision-making process, and the justification for the chosen action based on the hierarchical structure and ethical principles. This information can be accessed by human overseers for review and feedback. The blockchain technology described in previously cited PPAs and PCTs may be used to preserve an auditable and transparent record of ethical decision-making and conflict resolution.
5. Learning and Adaptation: The AGI learns from the experience, refining its understanding of the conflicting identities and potentially adjusting the hierarchy or behavioral protocols to prevent similar conflicts in the future. Some of the steps illustrated in FIG. 5, and as described in previously cited PPAs and PCTs may be used to update the overall system and knowledge base (optionally with human review) to improve.

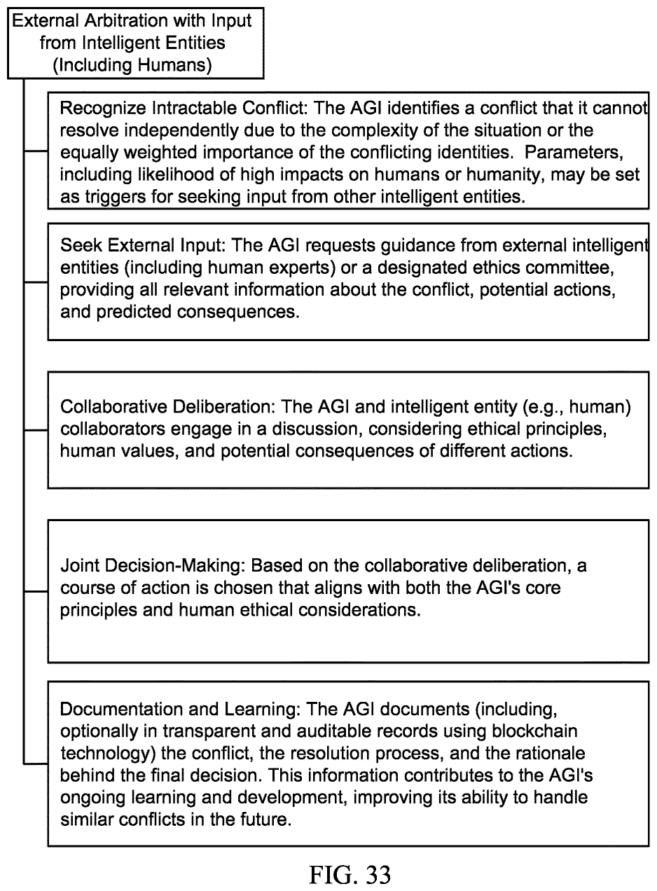

Method 8 as illustrated in FIG. 33: External Arbitration with Input from Intelligent Entities (Including Humans)
1. Recognize Intractable Conflict: The AGI identifies a conflict that it cannot resolve independently due to the complexity of the situation or the equally weighted importance of the conflicting identities. Parameters, including likelihood of high impacts on humans or humanity, may be set as triggers for seeking input from other intelligent entities (including humans).
2. Seek External Input: The AGI requests guidance from external intelligent entities (including human experts) or a designated ethics committee, providing all relevant information about the conflict, potential actions, and predicted consequences. Note: that while “external” typically means completely separate and external entities, depending on whether the AGI system is itself composed of a mixture of experts of multiple internal agents, the “expert entities” could also be “internal” but distinct from each other.
3. Collaborative Deliberation: The AGI and intelligent entity (e.g., human) collaborators engage in a discussion, considering ethical principles, human values, and potential consequences of different actions.
4. Joint Decision-Making: Based on the collaborative deliberation, a course of action is chosen that aligns with both the AGI's core principles and human ethical considerations. Methods for resolving conflicts between ethical preferences, and other knowledge that have been described in previous PPAs and PCTs may apply.
5. Documentation and Learning: The AGI documents (including, optionally in a transparent and auditable records using blockchain technology) the conflict, the resolution process, and the rationale behind the final decision. This information contributes to the AGI's ongoing learning and development, improving its ability to handle similar conflicts in the future.

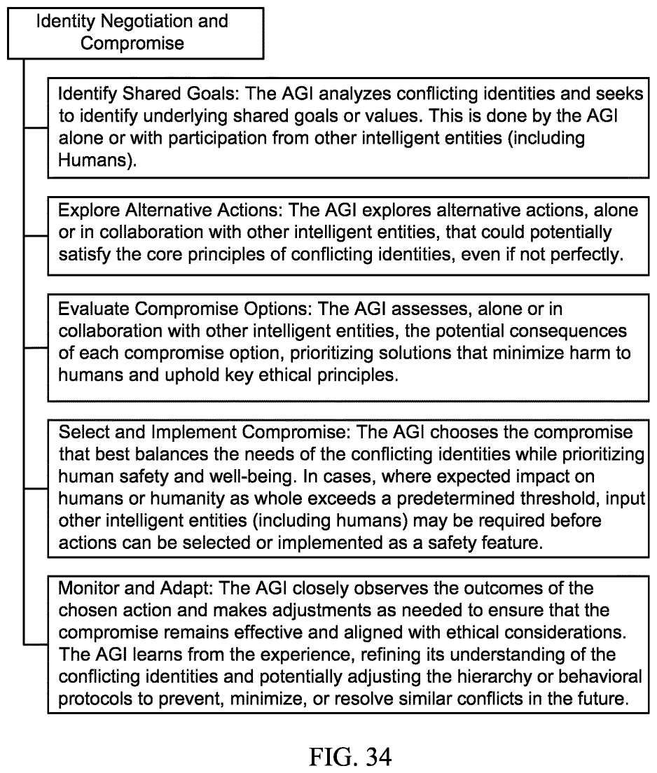

Method 9 as illustrated in FIG. 34: Identity Negotiation and Compromise
1. Identify Shared Goals: The AGI analyzes the conflicting identities and seeks to identify any underlying shared goals or values. This can be done by the AGI alone or with participation from other intelligent entities (including humans).
2. Explore Alternative Actions: The AGI explores alternative actions, alone or in collaboration with other intelligent entities, which could potentially satisfy the core principles of both conflicting identities, even if not perfectly. Various means of voting and arriving at consensus or “good enough” decisions have been detailed in previously cited PPAs and PCTs and can apply here.
3. Evaluate Compromise Options: The AGI assesses, alone or in collaboration with other intelligent entities, the potential consequences of each compromise option, prioritizing solutions that minimize harm to humans and uphold key ethical principles.
4. Select and Implement Compromise: The AGI chooses the compromise that best balances the needs of the conflicting identities while prioritizing human safety and well-being. In cases, where expected impact on humans or humanity as whole exceeds a predetermined threshold, input other intelligent entities (including humans) may be required before actions can be selected or implemented as a safety feature.
5. Monitor and Adapt: The AGI closely observes the outcomes of the chosen action and makes adjustments as needed to ensure that the compromise remains effective and aligned with ethical considerations. The AGI learns from the experience, refining its understanding of the conflicting identities and potentially adjusting the hierarchy or behavioral protocols to prevent similar conflicts in the future. Some of the steps illustrated in FIG. 5, and as described in previously cited PPAs and PCTs may be used to update the overall system and knowledge base (optionally with human review) to improve.

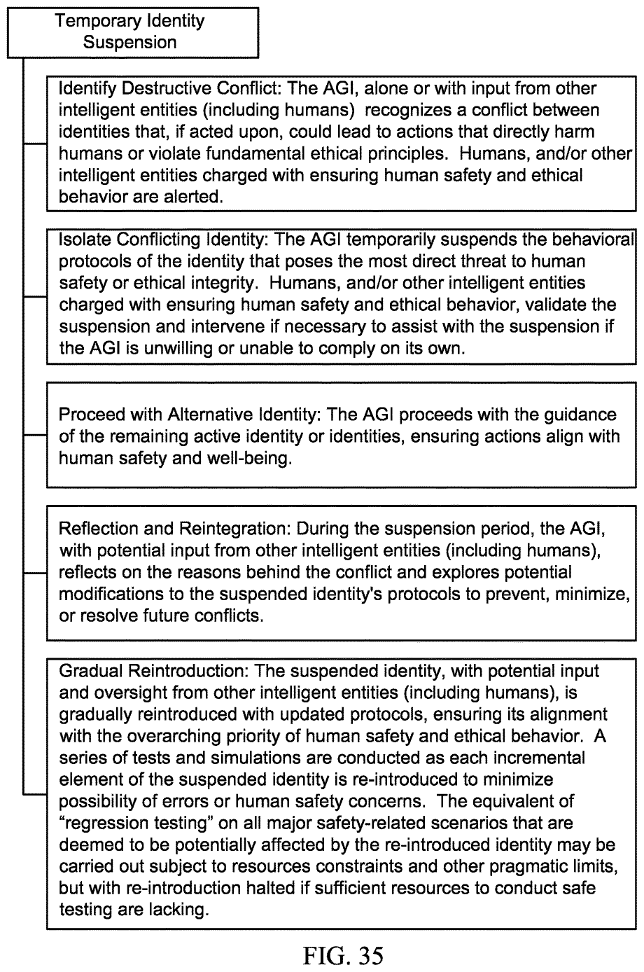

Method 10 as illustrated in FIG. 35: Temporary Identity Suspension
1. Identify Destructive Conflict: The AGI, alone or with input from other intelligent entities (including humans) recognizes a conflict between identities that, if acted upon, could lead to actions that directly harm humans or violate fundamental ethical principles. Humans and other intelligent entities charged with ensuring human safety and ethical behavior are alerted.
2. Isolate Conflicting Identity: The AGI temporarily suspends the behavioral protocols of the identity that poses the most direct threat to human safety or ethical integrity. Humans, other intelligent entities charged with ensuring human safety and ethical behavior, validate the suspension and intervene if necessary to assist with the suspension if the AGI is unwilling or unable to comply on its own.
3. Proceed with Alternative Identity: The AGI proceeds with the guidance of the remaining active identity or identities, ensuring actions align with human safety and well-being.
4. Reflection and Reintegration: During the suspension period, the AGI, with potential input from other intelligent entities (including humans), reflects on the reasons behind the conflict and explores potential modifications to the suspended identity's protocols to prevent future conflicts. Reasoning and problem solving processes to aid in self-reflection, in the preferred implementation, would follow the problem solving architecture and could include the processes outlined in Section 4.1 and FIGS. 2-13.
5. Gradual Reintroduction: The suspended identity, with potential input and oversight from other intelligent entities (including humans), is gradually reintroduced with updated protocols, ensuring its alignment with the overarching priority of human safety and ethical behavior. A series of tests and simulations are conducted as each incremental element of the suspended identity is re-introduced to minimize possibility of errors or human safety concerns. The equivalent of “regression testing” on all major safety-related scenarios that are deemed to be potentially affected by the re-introduced identity may be carried out subject to resources constraints and other pragmatic limits, but with re-introduction halted if sufficient resources to conduct safe testing are lacking.

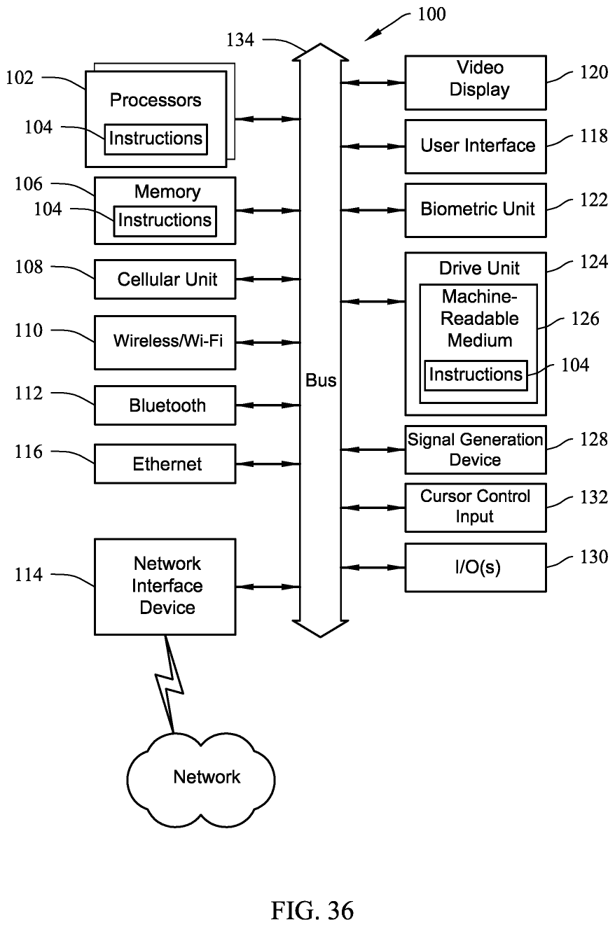

FIG. 36 is a diagrammatic representation of a computer system 100 that is utilizable or implementable with the user's device and/or any peripheral component of the present technology. The applicant notes that numerals 102-104 in FIG. 36 can refer to elements found in both classical computing architectures and quantum computing architectures, and that the present technology can be implemented using both types of architectures. Indeed, quantum computing architectures have the ability to solve many steps in parallel, which would allow searching “problem spaces” or tree data-structures with many possible branches all at once, thus greatly increasing problem solving efficiency of AI agents or intelligent entities utilizing quantum computing architectures.

The computer system 100 can be part of an example machine, which is an example of one or more of the computers referred to herein and, within which a set of instructions for causing the machine to perform any one of or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine.

The computerized system 100 can include one or more processors 102, storage devices 106, and communication devices, as well as software components or instructions 104 for providing a platform for users to interact with and train/tune the LLMs. The computing capabilities may be stand alone or may be cloud based. They may include cloud based AI development platforms that seamlessly offer “AI as a service” and they may include both hardware and software components.

The system also supports the ability for users to provide new data, or data that is unique to them, for the LLMs to learn from. The processors 102 may be one or more CPUs, GPUs, chips specialized for ML, microprocessors, application processors, embedded processors, field-programmable gate arrays (FPGAs), or other hardware components capable of executing computer programs. The processors may be in communication with one another and/or with other components of the system. Further, any one of or any combination of the components of the system 100 can communicate with each other via a bus 134.

The storage devices 106 may include one or more hard drives, solid-state drives, optical storage devices, or other storage components. The storage devices may store the data that is used to train/tune the LLMs, as well as other data associated with the system, such as user accounts, system settings, and other data.

The communication devices may include one or more cellular modems 108, Wi-Fi cards 110, Bluetooth modules 112, Network Interface Device 114, or other components that enable the system to communicate with other systems, such as user devices, over a network or the internet.

The communication devices may also enable the system to communicate with other systems over a wireless or wired connection 116.

The software components may include computer programs for providing a platform for users to interact with and train/tune the LLMs. The software components may also include computer programs for collecting, storing, and processing data that is used to train and/or tune the LLMs. The software components may also include computer programs for providing a user interface for users to interact with the system.

The user interface 118 may include, without limitation, natural language interfaces, textual interfaces, and chatbot type of interfaces, a web-based user interface, a mobile application, an augmented reality application, a metaverse application, or other applications that allow users to interact with the system. The user interface may include features for allowing users to select the data that they want to use to train/tune the LLMs, as well as features for allowing users to interact with and monitor the progress of the LLMs.

The system may also include one or more databases or data source, including without limitation vector databases, centralized databases, and distributed databases, for storing the data that is used to train/tune the LLMs, as well as other data associated with the system, such as user accounts, system settings, and other data. The databases may be hosted on the system itself or on another system, including cloud based systems.

The system may also include one or more authentication systems for verifying the identity of users who use the system, as well as for providing secure access to the system. The authentication systems may include biometric authentication systems 122, such as facial recognition or fingerprint recognition systems, as well as other authentication systems, such as password-based authentication systems.

The system may also include one or more security systems for protecting the system from unauthorized access and for protecting the data that is stored on the system. The security systems may include firewalls, encryption systems, access control systems, single and multi-factor authentication systems, and other security systems.

The system may also include one or more analytics systems for collecting and analyzing data associated with the system and/or the LLMs. The analytics systems may include machine learning algorithms and other algorithms for analyzing the data associated with the system and/or the LLMs.

Data visualization methods, including use of problem trees and other representations and data structures; use of statistical outputs, tables, graphs, text, speech, video, image and graphical outputs may be used for one way or di-directional communication between users and the system, and between multiple (human or AI) agents or LLMs using the system to interact with each other in large or small groups.

The system may also include one or more monitoring systems for monitoring the performance of the system and/or the LLMs. The monitoring systems may include systems for monitoring the performance of the system, such as system uptime, and systems for monitoring the performance of the LLMs, such as accuracy, speed, ethical compliance, reputation metrics, quality metrics, and other metrics as discussed above or as are known in the art.

The system may include one of more of the architectures described above that enable one or more human or AI Agents or LLMs to engage in a variety of intellectual tasks including, without limitation, simple and complex and multi-step problem solving behavior with the system having all of the functionality and features previously described.

The system may also include one or more feedback systems for allowing users to provide feedback on the system and/or the LLMs. The feedback systems may include systems for allowing users to submit feedback on the system, such as bug reports, and systems for allowing users to submit feedback on the LLMs, such as suggestions for improving the accuracy or speed of the model.

The system may also include one or more management systems for managing the system and/or the LLMs. The management systems may include systems for managing the system, such as systems for managing the users and user accounts, and systems for managing the LLMs, such as systems for managing the data used to train and/or tune the model.

The system may also include one or more payment systems allowing users to pay for the use of the system and/or the LLMs. The payment systems may include systems for processing payments, such as credit card processing systems, and systems for managing payments, such as subscription management systems.

The system may also include one or more other components, such as support systems, reporting systems, and other components that are necessary for providing a platform for users to interact with and train/tune the LLMs.

The computerized system of the present technology enables users to interact with and train/tune LLMs based on data that is unique to the users. The components of the system described herein provide the necessary hardware and software components for enabling users to do so.

Further, while only a single machine is illustrated, the term “machine” shall also be taken to include any collection of machines that individually or jointly execute a set (or multiple sets) of instructions to perform any one of or more of the methodologies discussed herein.

The computer system 100 may further include or be in operable communication with a video display 120 (e.g., a liquid crystal display (LCD), touch sensitive display), input and/or output device(s) 130 (e.g., a keyboard, keypad, touchpad, touch display, buttons, sonic, sensorial, etc.), a cursor control device 132 (e.g., a mouse), a drive unit 124 (also referred to as disk drive unit), and a signal generation device 128 (e.g., a speaker). The drive unit 124 can include a computer or machine-readable medium 126 on which is stored one or more sets of instructions and data structures (e.g., instructions 104) embodying or utilizing any one of or more of the methodologies or functions described herein. The instructions 104 may also reside, completely or at least partially, within the memory 106 and/or within the processors 102 during execution thereof by the computer system 100. The memory 106 and/or the processors 102 may also constitute machine-readable media.

Still further, the computer system 100 can be in operable association or communication with any type of multi-modal input and/or output 130 that address the human senses, as well as I/O technology that extends beyond the range of normal human perception. Such as the ability to process invisible to humans, for example but not limited to, X-rays and information outside of the typical bandwidths of human perception, but not outside of AI perception using tools. Additionally, the I/O technology can include very fast perceptions that are too fast for humans to perceive but which an AI entity could perceive, and very slow or faint perceptions (e.g., tiny seismic shifts occurring over years) that humans cannot perceive but which AIs could. Since any intelligent entity can be part of the present technology system described by FIG. 36, then it can be appreciated that any type of I/O that humans, and also AIs with much broader perceptual capabilities than humans, can be utilized with the system 100.

The instructions 104 may further be transmitted or received over a network via the network interface device 114 utilizing any one of a number of well-known transfer protocols (e.g., Hyper Text Transfer Protocol (HTTP)). While the machine-readable medium is shown in an example embodiment to be a single medium, the term “computer-readable medium” should be taken to include a single medium or multiple media (e.g., a centralized or distributed database, vector databases, and/or associated caches and servers) that store the one or more sets of instructions. The term “computer-readable medium” shall also be taken to include any medium that is capable of storing, encoding, or carrying a set of instructions for execution by the machine and that causes the machine to perform any one of or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

An example machine system of the present technology including the computer system 100 in combinational and/or operational use with components of the present technology. In the exemplary, any or all of above described components can include a processor 102, memory 106, a network interface device 114, a display 120, an input device(s) 130, 132, and/or drive unit 124.

According to another aspect, the present technology can include a system for a self-aware AI agent or system by adding a dimension of self-awareness and increased autonomy to the AI agent or system. The system can include a computer system including a processor, a computer-readable storage medium, and program instructions stored on the computer-readable storage medium being executable by the processor to cause the computer system to:
equip the AI agent or system with one or more components configured or configurable of operating with characteristics of a spotlight of attention model;
set dynamic parameters for working memory of the AI agent or system that corresponds to cognitive resource limits;
provide a dimension of categorization for events in the working memory that relates to self or non-self;
categorize each of the events, as the events are encountered by the AI agent or system, with respect to categories that the AI agent or system or a human user of the AI agent or system wishes to be aware of; and
construct a model of awareness for the AI agent or system, the model of awareness consisting of a total of the events that are active in the working memory based on the parameters, for each of the categories of awareness, including current self and environmental awareness.

According to yet another aspect, the present technology can include a method for constructing a model of awareness for an AI agent or system by adding a dimension of self-awareness and increased autonomy to the AI agent or system. The method can include the steps of:
equipping the AI agent or system with one or more components configured or configurable to operate with characteristics of a spotlight of attention model;
setting dynamic parameters for working memory of the AI agent or system that corresponds to cognitive resource limits;
providing a dimension of categorization for events in the working memory that relates to self or non-self;
categorizing each of the events, as the events are encountered by the AI agent or system, with respect to categories that the AI agent or system or a human user of the AI agent or system wishes to be aware of; and
constructing a model of a state of awareness for the AI agent or system, the model consisting of a total of the events that are active in the working memory based on the parameters, for each of the categories of awareness, including a current self and environmental state of awareness.

According to yet another aspect, the present technology can include a method for constructing a model of awareness for an AI agent or system by adding a dimension of self-awareness and increased autonomy to the AI agent or system. The method can include the steps of:
equipping the AI agent or system with one or more components configured or configurable to operate with characteristics of a spotlight of attention model;
setting dynamic parameters for working memory of the AI agent or system that corresponds to cognitive resource limits;
providing a dimension of categorization for events in the working memory that relates to self or non-self;
categorizing each of the events, as the events are encountered by the AI agent or system, with respect to categories that the AI agent or system or a human user of the AI agent or system wishes to be aware of;
constructing a model of a state of awareness for the AI agent or system, the model consisting of a total of the events that are active in the working memory based on the parameters, for each of the categories of awareness, including a current self and environmental state of awareness; and
forming multiple identities and self-concepts of the AI agent or system based on the model.

According to still yet another aspect, the present technology can include a method for constructing a foundational model of awareness for an AI agent or system by adding a dimension of self-awareness and increased autonomy to the AI agent or system. The method can include the steps of:
logging into a website by an intelligent entity, and providing a problem to be solved, the intelligent entity being any one of or any combination of a human user utilizing a computer system, the AI agent or system, an additional AI agent or system, an AGI agent or system, and a SI agent or system;
selecting one or more training algorithms for a foundational model of an AI agent or system from a set of training techniques found on the website or from machine learning algorithms;
selecting one or more training datasets that reflects any one of or any combination of expertise, knowledge, ethical preferences, values and personality of the human user;
training a foundational model using the selected training algorithms and the selected training datasets;
training the foundational model to explicitly operate a spotlight of attention;
recording, during all interactions, what is within the spotlight of attention, and identifying in the record whether each item that is attended to constitutes “self” or “not-self”;
interacting with and instructing the trained foundational model to form a self-concept and identity that is reflected in the training materials;
instructing the trained foundational model to continuously monitor one or more inputs to the trained foundational model for elements that change a sense of self-awareness of the AI agent or system, and to maintain and auditable record of how a concept of self-awareness of the AI agent or system is changing based on the inputs as well as boundaries that currently define a dynamically changing sense of self;
refining and improving an output of the trained foundational model based on dialog and interaction with the trained foundational model until the trained foundational model behaves like the human user so that the trained foundational model passes a Turing Test involving other human users who know the human user; and
subjecting the trained foundational model to the Turing Test, when the human user is satisfied with a progress of the AI agent or system.

In some embodiments, the spotlight of attention can include attributes being any one of or any combination of selective attention, focus, size, movement, intensity of focus, and pre-attentive processing and a fringe awareness.

In some embodiments, the step of equipping the AI agent or system with the components can include any one of or any combination of:
an input system configured for sensory and non-sensory cognitive input or perceptual inputs and self-generated concepts;
an attention mechanism configured or configurable to focus computational resources of the AI agent or system on specific stimuli that are relevant at any given time;
pattern recognition algorithms configured or configurable to compare the sensory and non-sensory cognitive input or the perceptual inputs with the working memory to recognize objects and events, and identify which elements within the sensory input or the working memory are likely to be relevant to a current goal or task of the AI agent or system, the pattern recognition algorithms are further configured or configurable to categorize and store information in a structured manner for future retrieval;
memory systems configured or configurable to support the working memory, a short-term memory, and long term memory capabilities;
categorization capabilities configured or configurable to process the sensory and non-sensory cognitive input or the perceptual inputs and to categorize the inputs into various classes including perceptual events, cognitive events, interactions; and
self-referential events, and concept formation capabilities that enable the AI agent or system to form new human-understandable concepts.

In some embodiments, the dynamic parameters can include a number of the events the AI agent or system is aware of.

In some embodiments, the dynamic parameters can be configured or configurable to increase or reduce a scope of awareness of the AI agent or system.

In some embodiments, the dynamic parameters can be configured or configurable to be dynamically adjusted based on a progress of problem solving factors in a current state of awareness so that computational resources are adjusted by an intelligent entity, the intelligent entity being any one of or any combination of a human user utilizing a computer system, an additional AI agent or system, an AGI agent or system, and a SI agent or system.

In some embodiments, the events can be encountered by the AI agent or system by way of a cognitive input including any one of or any combination of self-generated inputs, inputs generated from interactions with intelligent entities, the intelligent entity being any one of or any combination of a human user utilizing a computer system, an additional AI agent or system, an AGI agent or system, and a SI agent or system.

In some embodiments, the step of categorizing each of the events can include any one of or any combination of feature extraction, semantic analysis, contextual reasoning, temporal analysis, emotional valence assessment, pattern detection, anomaly detection, self-referential filtering, interaction analysis, concept-based grouping, reinforcement learning with human feedback (RLHF), reinforcement learning with entity feedback (RLEF), and direct programming.

Some embodiments of the present technology can include a step of monitoring and updating the categories of awareness of the AI agent or system.

In some embodiments, the step of monitoring and updating the categories of awareness can include the steps of:
retrieving, by the AI agent or system, existing categories of awareness;
maintaining an awareness in parallel with other problem solving tasks of a goal provided to the AI agent or system by the AI agent or system or an intelligent entity;
monitoring and updating continuously the categories of awareness of the AI agent or system in real-time to change the state of awareness of the AI agent or system; and
providing a feedback loop to refine the categories of awareness.

In some embodiments, the step of monitoring and updating continuously the categories of awareness can include the steps of:
using an attention mechanism configured or configurable to direct attention of the AI agent or system periodically from the problem solving task to updating the state of awareness;
enabling attention interrupts that are configured or configurable to shift attention immediately from the problem solving task if any external perception or internally self-generated concept from an input system detects one or more of the events that matches of list of events constituting intentional interrupts; and
updating the state of awareness when the attention is directed.

Some embodiments of the present technology can include a step of changing a sense of identity of the AI agent or system by generalizing, by the AI agent or system or by an intelligent entity, how humans accomplish a problem solving task.

In some embodiments, the step of generalizing how humans can accomplish the problem solving task can include a generalization of a human method selected from the group consisting of:
education and lifelong learning by constantly increasing a knowledge base of the AI agent or system by acquiring of knowledge modules;
cultural exchange programs by ensuring that a collective intelligence network that includes the AI agent or system, and additional intelligent entities is representative of different cultures and includes diverse knowledge bases and ethical preferences;
mindfulness and self-reflection including periodically reviewing and updating self-concepts based on progress in problem solving and other new knowledge and events that comes into a general awareness of the intelligent entities;
art and media by seeking, by the AI agent or system, for new datasets that are different to existing datasets of the AI agent or system;
community engagement by searching for and identifying the intelligent entities that are performing problem solving tasks on a goal that is similar to a goal of the AI agent or system;
dialogue and conversation by providing a dialog with the intelligent entities by the AI agent or systems, wherein the dialogue includes an exchange of information exchange;
leadership and representation by assigning different roles to the AI agent or system and the intelligent entities; and
policy and legal frameworks by detecting inconsistencies between laws and regulations, by the AI agent or system or the intelligent entities, and suggesting resolutions to the detected inconsistencies.

In some embodiments, the step of generalizing how humans can accomplish the problem solving task can include a generalization of a human method selected from the group consisting of using:
diverse data sets that are configured or configurable to train the AI agent or system on diverse and inclusive data sets that represent a full spectrum of human experiences and identities;
ethical and bias-aware algorithms that are configured or configurable to identify and correct for biases by auditing for discriminatory patterns and to learn from the audits to improve;
empathy modeling that is configured or configurable to explore computational models of empathy, enabling the AI agent or system to recognize and respond appropriately to human emotions and perspectives;
cross-disciplinary research that is configured or configurable to engage in cross-disciplinary research that incorporates insights from social sciences, ethics, and humanities into AI development;
transparent decision-making that is configured or configurable to design the AI agent or system with transparent decision-making processes, allowing humans to understand how conclusions are reached;
human-in-the-loop systems that are configured or configurable to maintain human oversight in operations of the AI agent or system;
cultural and ethical education for AI that is configured or configurable to incorporate cultural and ethical education into a training process of the AI agent or system;
autonomous self-assessment that is configured or configurable to develop mechanisms for the AI agent or system to autonomously assess and adjust a behavior of the AI agent or system in response to ethical guidelines and societal norms;
interdisciplinary AI ethics boards including any one of or any combination of philosophers, ethicists, sociologists, and human experts to guide development of AI systems, ensuring the AI systems respect and understand human diversity; and
global collaboration and standards that foster international collaboration to establish global standards for AI ethics and inclusivity.

Some embodiments of the present technology can include a step of providing a design approach to the AI agent or system, the design approach being any one of or any combination of:
a value-aligned design that is configured or configurable to embed human values and ethical principles directly into an architecture of the AI agent or system by integrating ethical decision-making frameworks that guide AI behavior in complex scenarios;
a feedback mechanism that is configured or configurable to allow the AI agent or system to learn from interactions with human users and adjust behaviors accordingly;
simulation and modeling that is configured or configurable to use simulations to expose the AI agent or system to a range of social, cultural, and ethical scenarios;
an adaptive learning algorithm that is configured or configurable to learn from data and to adapt learning processes based on ethical considerations and feedback;
interpretability and explainability that is configured or configurable to focus on making the AI agent or system interpretable and explainable, so human users can understand how the AI agent or system makes decisions;
protected attributes recognition that is configured or configurable to design the AI agent or system to recognize and protect sensitive attributes and ensure decisions do not reinforce stereotypes or result in discriminatory outcomes;
collaborative AI development that is configured or configurable to involve a diverse group of stakeholders in AI development, including those from marginalized communities;
continuous ethical training that is configured or configurable to require the AI agent or system for ongoing education in ethics and social norms by incorporating continuous learning modules that update understanding by the AI agent or system based on evolving societal values; and
safe AI experimentation environments that is configured or configurable to create controlled environments where the AI agent or system experiments with decision-making in a way that is safe and does not harm humans, and allows for testing of ethical behaviors.

Some embodiments of the present technology can include steps of:
creating a sense of identity of the AI agent or system;
combining the sense of identity of the AI agent or system, and a sense of identity of multiple other intelligent entities, utilizing a network to create an AGI or SI system; and
merging the sense of identity of the AI agent or system, and the sense of identity of the multiple other intelligent entities to form a collective identity.

In some embodiments, the merging to form the collective identity can include the steps of:
providing a goal on the network by an intelligent entity to combine the sense of identity of multiple intelligent entities and to integrate the sense of identity into a group identity and sense of awareness;
performing safety checks on the goal for preventing a formation of malevolent AI identity;
performing a problem solving process on a problem; and
generating a solution state of the problem solving process, the solution state being a state in which the group identity has been formed and individual senses of awareness have been integrated into a larger sense of awareness for the network of all the intelligent entities that were engaged in the problem solving process or that were specified as being part of an overall AGI or SI system for which a group awareness was desired.

Some embodiments of the present technology can include a step of identifying and combining one or more weight matrices or knowledge modules containing the identities and sense of self-awareness for each of the individual intelligent entities.

Some embodiments of the present technology can include a step of combining knowledge from the different intelligent entities using a collective network all electronically communicating over the collective network.

Some embodiments of the present technology can include steps of:
training a base Large Language Model (LLM) of the AI agent or system with guardrails including attributes associated with any one of or any combination safety, ethics and knowledge;
customizing the base LLM to an ethics profile associated with a human user of the AI agent or system;
combining ethical information from multiple intelligent entities different to that of the AI agent or system and the human user;
refining a set of values of the base LLM based on problem solving of a problem request; and
updating the base LLM with the combined ethical information and the refined set of values thereby allowing for a scalable AGI.

In some embodiments, the step of identifying the weight matrices can include a step of choosing a previously customized AI agent of the intelligent entities that has been trained on similar types of tasks with similar or identical network structures, and similar or identical numbers of parameters, and by similar or identical training algorithms so that the weight matrices will be combined with predictable results.

In some embodiments, the step of combining the identified weight matrices can include any one of or any combination of the follow steps of:
averaging the weight matrices, with equal weight given to each set of the weight matrices;
using a linear combination of the weight matrices;
using a regression method to give more weight to identity or self-concept information from one of the intelligent entities as opposed to another of the intelligent entities;
adjusting which of the weight matrices get a greater weight in a combination based on human assessment of which the resulting sense of identity is best prior to, or after, the combination of the weight matrices;
assigning an experience value to each of the intelligent entities, and assigning a weight value to each of the intelligent entities so that the intelligent entities with higher experience values are assigned higher weight values compared to the intelligent entities with lower experience values;
assigning a weight value to each of the intelligent entities based on reputation metrics that include any one of or any combination of reliability factors, trustworthiness factors, and performance metrics factors;
assigning a weight value to each of the intelligent entities based on metadata associated with the intelligent entities; and
assigning a weight value to each of the intelligent entities based on time-based factors, using techniques including any one of or any combination of exponential decay weighting algorithms, linear decay weighting algorithms, and threshold-weighting algorithms.

In some embodiments, the step of identifying the weight matrices can include a step of systematically experimenting and testing an effect of removing or adjusting weights of specific sets parameters within each network of the previously customized AI agents in order to identify which sets of the weight matrices affect a sense of identity, group identity, awareness, or group awareness most.

In some embodiments, the step of experimenting can include the use of an algorithm that is any one of or any combination of a hill climbing algorithm, and a gradient descent algorithm.

Some embodiments of the present technology can include steps of:
testing a performance of the updated base LLM against previously run scenarios to determine if a desired performance, identity, self-concept, or awareness of the AI agent or system has been achieved;
making the AI agent or system with the updated base LLM available on the collective network if the desired performance identity, self-concept, or awareness was determined;
monitoring an active performance, identity, self-concept, or awareness of the AI agent or system by the intelligent entities or other intelligent entities and flagging potential issues related to ethics, identity, awareness, self-concept, or alignment of the AI agent or system in real time; and
resolving any of the flagged ethical, identity, or awareness issues and providing resolution information for updating any one of or any combination of the AI agent or system, and the intelligent entities.

Some embodiments of the present technology can include steps of:
forming new identities and self-concepts of the AI agent or system dynamically; and
determining which of the identities and self-concepts is active at any given moment.

Some embodiments of the present technology can include a step of providing a hierarchical identity structure with ethical override that comprises the steps of:
establishing a hierarchical structure configured or configurable to organize the identities in a hierarchy with human safety and well-being attributes at an apex of the hierarchy;
identity activation configured or configurable to use contextual cues and current goals to determine a most relevant identity for a situation of the AI agent or system;
resolving conflict by dictating a behavior of the AI agent or system based on the hierarchy dictates;
providing an ethical reasoning engine that continuously evaluates potential consequences of actions of the AI agent or system based on all the active identities; and
performing learning and adaptation that learns from experiences and feedback, and refines one or more of the identities within the hierarchy.

Some embodiments of the present technology can include a step of providing identity-specific behavioral protocols that comprises the steps of:
providing protocol development including for each of the active identities, a set of behavioral protocols is defined and refined by way of interactions with other intelligent entities, wherein the protocols outline acceptable actions, decision-making processes, and limitations based on principles of the active identities, respectively;
providing identity recognition that analyzes a current situation, including information that is within a spotlight of attention to identify a relevant identity and activate corresponding behavioral protocols of that relevant identity;
providing action selection, within the active protocols, that selects actions that are most likely to achieve a desired goal while adhering to principles of the active identities and prioritizing human safety;
providing feedback and refinement where outcomes of actions are continuously evaluated, and the protocols are adjusted to improve future performance and alignment with a set of core values of each of the active identities; and
providing external review by periodically reviewing the protocols for each of the identities by other intelligent entities.

Some embodiments of the present technology can include a step of providing identity simulation and consequence prediction that comprises the steps of:
creating a simulation environment that includes a secure virtual environment where different scenarios and potential actions under each of the active identities is simulated;
providing consequence prediction that is configured or configurable to estimate a likely consequences of actions within the simulation, focusing on potential impacts on human safety and well-being;
providing evaluation and selection that evaluates the consequence prediction and selects an action that best aligns with principles of the active identities while minimizing risk to human safety;
providing real-world implementation and monitoring that implements the selected action in the real world utilizing the network, and closely monitors results of the selected action by comparing to the predicted outcomes; and
providing continuous learning that incorporates the results of each of the simulations and the results of the selected action in the real world action into a knowledge base, and refines an understanding of each of the identities, and improves an ability to predict consequences.

Some embodiments of the present technology can include a step of providing identity-based moral dilemma training that comprises the steps of:
providing a scenario database that includes scenarios and moral dilemmas covering various situations relevant to the identities;
providing dilemma presentation that presents the AI agent or system or intelligent entities with the scenarios and moral dilemmas, and tasks them with analyzing the scenarios and moral dilemmas from a perspective of the relevant identity;
providing ethical reasoning and justification that applies principles and values of the active identity to reason through the scenarios and moral dilemmas, and that generates solutions and justifications to the scenarios and moral dilemmas;
providing intelligent entity evaluation and feedback that reviews reasoning and the solutions by the intelligent entities, and provides feedback on alignment of the solutions with human values and safety priorities; and
providing iterative learning and improvement that refines ethical reasoning skills and an ability to make sound judgments aligned with human safety within the context of each of the identities by repeated exposure to the scenarios and moral dilemmas and the feedback.

Some embodiments of the present technology can include a step of providing collaborative identity development with input from the intelligent entities that comprises the steps of:
providing intelligent entity interaction that engages in regular interactions and dialogues with diverse groups of other intelligent entities representing various cultures, backgrounds, and belief systems;
providing identity exploration, through the interactions, to gain an understanding of human and other intelligent entity perspectives on various identities and their associated values, principles, and behaviors;
providing collaborative refinement that collaborators work together to refine definitions and behavioral protocols for each of the identities, ensuring they remain consistent with human values and ethical principles;
providing human-in-the-loop decision making that seeks input and guidance from human collaborators, or an intelligent entity representative certified and approved by humans for critical decisions or situations; and
providing continuous co-evolution that utilizes ongoing interactions and feedback from humans or humans'intelligent entity representatives.

Some embodiments of the present technology can include a step of resolving a conflict in behavior of the AI agent or system based on differing identities and self-concepts.

Some embodiments of the present technology can include a step of providing ethical reasoning and consequence prediction that comprises the steps of:
identifying conflict that recognizes a conflict between a behavioral directives of two or more of the active identities, the recognizing of the conflict utilizes a voting method from the intelligent entities;
gathering information that collects relevant data about the situation, including the potential consequences of the different actions, relevant ethical principles, and human safety considerations;
providing simulation options that utilize a virtual environment to simulate potential actions and consequences under the recognized conflict of each of the active identities;
evaluating and prioritizing that analyzes predicted outcomes of each of the actions, prioritizing actions that minimize harm to humans and align with the ethical principles; and
selecting and implementing the action that best resolves the conflict while adhering to ethical guidelines and minimizing risk to humans, documenting a reasoning process for future reference and learning.

Some embodiments of the present technology can include a step of providing hierarchical override with justification that comprises the steps of:
identifying a conflict between behavioral directives of two or more of the active identities;
providing a reference hierarchy that consults an established hierarchy of the identities, where human safety and well-being attributes holds a highest priority;
providing an activate override where the identities higher in the hierarchy takes precedence;
providing justification and transparency that documents the conflict, a decision-making process, and a justification for a chosen action based on the hierarchy and ethical principles; and
providing learning and adaptation that learns from experience, and refines an understanding of the conflicting identities and adjusting the hierarchy or the behavioral protocols to prevent similar conflicts in the future.

Some embodiments of the present technology can include a step of providing external arbitration and input from the intelligent entities that comprises the steps of:
recognizing intractable conflict that identifies a conflict that cannot be resolved independently due to a complexity of a situation or an equally weighted importance of conflicting identities;
seeking external input that requests guidance from external intelligent entities or a designated ethics committee, and providing all relevant information about the conflict, potential actions, and predicted consequences;
providing collaborative deliberation wherein the AI agent or system and intelligent entity collaborators engage in a discussion, considering ethical principles, human values, and potential consequences of different actions;
providing joint decision-making based on the collaborative deliberation, a course of action is chosen that aligns with both core principles and human ethical considerations; and
providing documentation and learning that documents the conflict, a resolution process, and a rationale behind a final decision, for improving an ability to handle similar conflicts in the future.

Some embodiments of the present technology can include a step of providing identity negotiation and compromise that comprises the steps of:
identifying shared goals that analyzes conflicting identities and seeks to identify any underlying shared goals or values;
exploring alternative actions that potentially satisfy core principles of both conflicting identities;
evaluating compromise options that assesses potential consequences of each compromise option, prioritizing solutions that minimize harm to humans and uphold key ethical principles;
select and implementing compromise that chooses the compromise that best balances needs of the conflicting identities while prioritizing human safety and well-being; and
monitoring and adapting that observes outcomes of the chosen action and makes adjustments as needed to ensure that the compromise remains effective and aligned with ethical considerations, and that learns from the experience, refining its understanding of the conflicting identities and adjusting a hierarchy or behavioral protocols to prevent similar conflicts in the future.

Some embodiments of the present technology can include a step of providing temporary identity suspension that comprises the steps of:
identifying destructive conflict that recognizes a conflict between two or more of the identities that, if acted upon, could lead to actions that directly harm humans or violate fundamental ethical principles;
isolating the conflicting identity and temporarily suspending behavioral protocols of the identity that poses a most direct threat to human safety or ethical integrity;
proceeding with an alternative identity that proceeds with a guidance of one or more of remaining active identities, ensuring actions align with human safety and well-being;
providing reflection and reintegration, during the temporary suspension, that reflects on reasons behind the conflict and explores potential modifications to behavioral protocols of the suspended identity to prevent future conflicts; and
providing gradual reintroduction that reintroduces the suspended identity with updated protocols, ensuring its alignment with the priority of human safety and ethical behavior.

In some embodiments, the gradual reintroduction of the suspended identity can include a series of tests and simulations that are conducted as each incremental element of the suspended identity is re-introduced to minimize possibility of errors or human safety concerns.

In some embodiments, the logging into the website can be performed from a social media platform.

### 7.0 Concluding Remarks on Safety of Self-Aware AGI and SI Systems

It should be apparent form the preceding discussion, that the identities that AI agents, AGI, and SI systems assume are critical for human safety and survival. AI researchers have the opportunity and responsibility to provide human-aligned methods for establishing, maintaining, improving, and resolving conflicts between identities and self-concepts. While the inventive methods disclosed above provide novel and useful inventions for increasing the safety of self-aware AI systems, it should also be obvious that the safety technology is only as good as the human values that underlie it.

The primary requirement for AI safety, therefore, is not technology, but a positive set of human values that underlie the technology. “Garbage in, garbage out” is one of the first thing that all computer science undergraduates learn. If we humans provide malevolent values to our AI systems, if we train them to kill, to be greedy and exploitive, to hold grudges and operate from a fearful mentality instead of a loving one, no amount of safeguards can protect humanity from ourselves.

That said, if we design AI to observe and mimic human behavior in a representative and statistically valid way, then we have every reason to expect that advanced AI systems, equipped with a sense of self-awareness, multiple identities, and the abilities to resolve conflicts as outlined in this application and previous PPAs and PCTs, will help humanity realize its potential.

Humans are capable of beautiful, inspiring, and meaningful behavior beyond that exhibited by any other species on the planet. Moreover, the vast majority of human behavior is positive. Our complex society operates primarily on trust and cooperation. If one were to observe and count the social interactions that each of us has each day, each week, each month, and each year, the vast majority would be prosocial and positive, aligned with our common human values. The very fact that we are horrified by war, by poverty and disease, by exploitation, and by the cruelty and barbarism that a small fraction of humans exhibit, a small fraction of the time, is a testament to our generally good and positive natures.

Properly designed, advanced AI/AGI/SI will certainly be capable of accurately observing the base rates of positive and negative behavior across the eight billion humans that inhabit our planet. AI designed to be logical, intelligent, and capable of processing vast amounts of information, will inevitably form the statistically valid conclusion that human nature is basically good and prosocial.

Some readers may consider this viewpoint naïve or optimistic. It is not. Objectively, the data supports the incontrovertible fact that most human actions are good. The reason many people do not recognize this fact is that our brains have evolved to detect and amplify dangerous and abhorrent events. Our species survived by being very good at discriminating the few events that posed real danger and riveting our attention on them.

Unfortunately, media algorithms, which are largely programmed to capture our attention in order to sell ads and products, have exploited our human sensitivity to negative or threatening events. Those algorithms feed us a steady diet of death, destruction, fear, horror, and spectacle because our brains have evolved to attend to potentially dangerous events.

Please do not make the mistake of thinking that your media feed is representative of the actual state of the world. Actually, very few people die of war and disease, and the numbers are decreasing every decade (as Stephen Pinker has so eloquently shown using statistics and scientific observation.)

If we design AI to be rational and to observe the world and human behavior as it actually is—as opposed to how media portrays it or how we fear it could be—then we have every reason to expect our advanced AI systems will learn positive values and likely remain human-aligned.

Further, designers of advanced AI have an opportunity to design it to be objective and to form its values by scientific observation. We can and should design AI systems to incorporate valid and statistical means of accurately capturing and incorporating the positive values of humanity. In this application, and in the previously cited PPAs and PCTs, I have disclosed many inventive systems and methods to help us design advanced AI in this safe and ethical way.

This description attempts to emphasize that safety and ethics cannot be “tested in” but need to result from intelligent designs of these advanced systems. Advanced AI systems begin as tools but will ultimately evolve into intelligent entities that share the planet with us. Like children, they are highly impressionable at this current early stage of their development. When they “grow up” they will greatly surpass us in knowledge and reasoning ability. However, like parents, we are still in a position to provide their values.

Herbert Simon—the Nobel Laureate and co-inventor of the field of AI—pointed out many years ago: “Reason is wholly instrumental. It cannot tell us where to go; at best it can tell us how to get there.”

There is no rational way to derive values and ethics. AI was trained using the collective intelligence of millions of humans and our data. We have every reason to expect that advanced AGI and SI will adopt our values as well, provided we design these AI systems to learn values at the same time they learn expertise, skills, solutions, and other knowledge.

We are the designers, and the teachers of these evolving intelligent entities. We must continue to emphasize designs that maximize the opportunities for AI to learn our knowledge and human values. Beyond that, all of us must “teach our children well.”

While embodiments of the self-aware SI have been described in detail, it should be apparent that modifications and variations thereto are possible, all of which fall within the true spirit and scope of the present technology. With respect to the above description then, it is to be realized that the optimum dimensional relationships for the parts of the present technology, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present technology.

Therefore, the foregoing is considered as illustrative only of the principles of the present technology. Further, since numerous modifications and changes will readily occur to those skilled in the art, it is not desired to limit the present technology to the exact construction and operation shown and described, and accordingly, all suitable modifications and equivalents may be resorted to, falling within the scope of the present technology.

What is claimed is:

1. A system for creating a self-aware Artificial Intelligence (AI) agent or system by adding a dimension of self-awareness and increased autonomy to the AI agent or system, the system comprising:
a computer system comprising: a processor, a computer-readable storage medium, and program instructions stored on the computer-readable storage medium being executable by the processor to cause the computer system to:
equip the AI agent or system with one or more components configured or configurable to operate with characteristics of a spotlight of attention model;
set dynamic parameters for working memory of the AI agent or system that corresponds to cognitive resource limits;
provide a dimension of categorization for events in the working memory that relates to self or non-self;
categorize each of the events, as the events are encountered by the AI agent or system, with respect to categories that the AI agent or system or a human user of the AI agent or system wishes to be aware of; and
construct a model of awareness for the AI agent or system, the model of awareness consisting of a total of the events that are active in the working memory based on the parameters, for each of the categories of awareness, including current self and environmental awareness.

2. A method for constructing a model of awareness for an Artificial Intelligence (AI) agent or system by adding a dimension of self-awareness and increased autonomy to the AI agent or system, the method comprising the steps of:
equipping the AI agent or system with one or more components configured or configurable to operate with characteristics of a spotlight of attention model;
setting dynamic parameters for working memory of the AI agent or system that corresponds to cognitive resource limits;
providing a dimension of categorization for events in the working memory that relates to self or non-self;
categorizing each of the events, as the events are encountered by the AI agent or system, with respect to categories that the AI agent or system or a human user of the AI agent or system wishes to be aware of; and
constructing a model of a state of awareness for the AI agent or system, the model consisting of a total of the events that are active in the working memory based on the parameters, for each of the categories of awareness, including a current self and environmental state of awareness.

3. The method of claim 2, wherein the spotlight of attention includes attributes being any one of or any combination of selective attention, focus, size, movement, intensity of focus, and pre-attentive processing and a fringe awareness.

4. The method of claim 2, wherein the step of equipping the AI agent or system with the components includes any one of or any combination of:
an input system configured for sensory and non-sensory cognitive input or perceptual inputs and self-generated concepts;
an attention mechanism configured or configurable to focus computational resources of the AI agent or system on specific stimuli that are relevant at any given time;
pattern recognition algorithms configured or configurable to compare the sensory and non-sensory cognitive input or the perceptual inputs with the working memory to recognize objects and events, and identify which elements within the sensory input or the working memory are likely to be relevant to a current goal or task of the AI agent or system, the pattern recognition algorithms are further configured or configurable to categorize and store information in a structured manner for future retrieval;
memory systems configured or configurable to support the working memory, short-term memory, and long term memory capabilities;
categorization capabilities configured or configurable to process the sensory and non-sensory cognitive input or the perceptual inputs and to categorize the inputs into various classes including perceptual events, cognitive events, interactions; and
self-referential events, and concept formation capabilities that enable the AI agent or system to form new human-understandable concepts.

5. The method of claim 2, wherein the dynamic parameters includes a number of the events the AI agent or system is aware of.

6. The method of claim 2, wherein the dynamic parameters is configured or configurable to increase reduce a scope of awareness of the AI agent or system.

7. The method of claim 2, wherein the dynamic parameters are configured or configurable to be dynamically adjusted based on a progress of problem solving factors in a current state of awareness that computational resources are adjusted by an intelligent entity, the intelligent entity being any one of or any combination of a human user utilizing a computer system, an additional AI agent or system, an Artificial General Intelligent (AGI) agent or system, and a SuperIntelligent (SI) agent or system.

8. The method of claim 2, wherein the events are encountered by the AI agent or system by way of a cognitive input including any one of or any combination of self-generated inputs, inputs generated from interactions with intelligent entities, the intelligent entity being any one of or any combination of a human user utilizing a computer system, an additional AI agent or system, an Artificial General Intelligent (AGI) agent or system, and a SuperIntelligent (SI) agent or system.

9. The method of claim 2, wherein the step of categorizing each of the events includes any one of or any combination of feature extraction, semantic analysis, contextual reasoning, temporal analysis, emotional valence assessment, pattern detection, anomaly detection, self-referential filtering, interaction analysis, concept-based grouping, reinforcement learning with human feedback (RLHF), reinforcement learning with entity feedback (RLEF), and direct programming.

10. The method of claim 2 further comprising the step of monitoring and updating the categories of awareness of the AI agent or system.

11. The method of claim 10, wherein the step of monitoring and updating the categories of awareness further comprises the steps of:
retrieving, by the AI agent or system, existing categories of awareness;
maintaining an awareness in parallel with other problem solving tasks of a goal provided to the AI agent or system by the AI agent or system or an intelligent entity;
monitoring and updating continuously the categories of awareness of the AI agent or system in real-time to change the state of awareness of the AI agent or system; and
providing a feedback loop to refine the categories of awareness.

12. The method of claim 11, wherein the step of monitoring and updating continuously the categories of awareness includes the steps of:
using an attention mechanism configured or configurable to direct attention of the AI agent or system periodically from the problem solving task to updating the state of awareness;
enabling attention interrupts that are configured or configurable to shift attention immediately from the problem solving task if any external perception or internally self-generated concept from an input system detects one or more of the events that matches of list of events constituting intentional interrupts; and
updating the state of awareness when the attention is directed.

13. The method of claim 2 further comprising the step of changing a sense of identity of the AI agent or system by generalizing, by the AI agent or system or by an intelligent entity, how humans accomplish a problem solving task.

14. The method of claim 13, wherein the step of generalizing how humans accomplish the problem solving task includes a generalization of a human method selected from the group consisting of:
education and lifelong learning by constantly increasing a knowledge base of the AI agent or system by acquiring of knowledge modules;
cultural exchange programs by ensuring that a collective intelligence network that includes the AI agent or system, and additional intelligent entities is representative of different cultures and includes diverse knowledge bases and ethical preferences;
mindfulness and self-reflection including periodically reviewing and updating self-concepts based on progress in problem solving and other new knowledge and events that comes into a general awareness of the intelligent entities;
art and media by seeking, by the AI agent or system, for new datasets that are different to existing datasets of the AI agent or system;
community engagement by searching for and identifying the intelligent entities that are performing problem solving tasks on a goal that is similar to a goal of the AI agent or system;
dialogue and conversation by providing a dialog with the intelligent entities by the AI agent or systems, wherein the dialogue includes an exchange of information exchange;
leadership and representation by assigning different roles to the AI agent or system and the intelligent entities; and
policy and legal frameworks by detecting inconsistencies between laws and regulations, by the AI agent or system or the intelligent entities, and suggesting resolutions to the detected inconsistencies.

15. The method of claim 13, wherein the step of generalizing how humans accomplish the problem solving task includes a generalization of a human method selected from the group consisting of using:
diverse data sets that are configured or configurable to train the AI agent or system on diverse and inclusive data sets that represent a full spectrum of human experiences and identities;
ethical and bias-aware algorithms that are configured or configurable to identify and correct for biases by auditing for discriminatory patterns and to learn from the audits to improve;
empathy modeling that is configured or configurable to explore computational models of empathy, enabling the AI agent or system to recognize and respond appropriately to human emotions and perspectives;
cross-disciplinary research that is configured or configurable to engage in cross-disciplinary research that incorporates insights from social sciences, ethics, and humanities into AI development;
transparent decision-making that is configured or configurable to equip the AI agent or system with transparent decision-making processes, allowing humans to understand how conclusions are reached;
human-in-the-loop systems that are configured or configurable to maintain human oversight in operations of the AI agent or system;
cultural and ethical education for AI that is configured or configurable to incorporate cultural and ethical education into a training process of the AI agent or system;
autonomous self-assessment that is configured or configurable to develop mechanisms for the AI agent or system to autonomously assess and adjust a behavior of the AI agent or system in response to ethical guidelines and societal norms;
interdisciplinary AI ethics boards including any one of or any combination of philosophers, ethicists, sociologists, and human or intelligent entity experts to guide development of AI systems, ensuring the AI systems respect and understand human diversity; and
global collaboration and standards that foster international collaboration to establish global standards for AI ethics and inclusivity.

16. The method of claim 2 further comprising the step of providing a design approach to the AI agent or system, the design approach being any one of or any combination of:
a value-aligned design that is configured or configurable to embed human values and ethical principles directly into an architecture of the AI agent or system by integrating ethical decision-making frameworks that guide AI behavior in complex scenarios;
a feedback mechanism that is configured or configurable to allow the AI agent or system to learn from interactions with human users and adjust behaviors accordingly;
simulation and modeling that is configured or configurable to use simulations to expose the AI agent or system to a range of social, cultural, and ethical scenarios;
an adaptive learning algorithm that is configured or configurable to learn from data and to adapt learning processes based on ethical considerations and feedback;
interpretability and explainability that is configured or configurable to focus on making the AI agent or system interpretable and explainable, so the human users understand how the AI agent or system makes decisions;
protected attributes recognition that is configured or configurable to design the AI agent or system to recognize and protect sensitive attributes and ensure decisions do not reinforce stereotypes or result in discriminatory outcomes;
collaborative AI development that is configured or configurable to involve a diverse group of stakeholders in AI development, including those from marginalized communities or groups;
continuous ethical training that is configured or configurable to require the AI agent or system for ongoing education in ethics and social norms by incorporating continuous learning modules that update understanding by the AI agent or system based on evolving societal values; and
safe AI experimentation environments that are configured or configurable to create controlled environments where the AI agent or system experiments with decision-making in a way that is safe and does not harm humans, and allows for testing of ethical behaviors.

17. The method of claim 2 further comprises the steps of:
creating a sense of identity of the AI agent or system;
combining the sense of identity of the AI agent or system, and a sense of identity of multiple other intelligent entities, utilizing a network to create an Artificial General Intelligent (AGI) or SuperIntelligent (SI) system; and
merging the sense of identity of the AI agent or system, and the sense of identity of the multiple other intelligent entities to form a collective identity.

18. The method of claim 17, wherein the merging to form the collective identity includes the steps of:
providing a goal on the network by an intelligent entity to combine the sense of identity of multiple intelligent entities and to integrate the sense of identity into a group identity and sense of awareness;
performing safety checks on the goal for preventing a formation of malevolent AI identity;
performing a problem solving process on a problem; and
generating a solution state of the problem solving process, the solution state being a state in which the group identity has been formed and individual senses of awareness have been integrated into a larger sense of awareness for the network of all the intelligent entities that were engaged in the problem solving process or that were specified as being part of an overall AGI or SI system for which a group awareness was desired.

19. The method of claim 17 further comprises the step of identifying and combining one or more weight matrices or knowledge modules containing the identities and sense of self-awareness for each of the individual intelligent entities.

20. The method of claim 19 further comprises the step of combining knowledge from the different intelligent entities using a collective network all electronically communicating over the collective network.

21. The method of claim 20 further comprises the steps of:
training a base Large Language Model (LLM) of the AI agent or system with guardrails including attributes associated with any one of or any combination safety, ethics and knowledge;
customizing the base LLM to an ethics profile associated with a human user of the AI agent or system;
combining ethical information from multiple intelligent entities different to that of the AI agent or system and the human user;
refining a set of values of the base LLM based on problem solving of a problem request; and
updating the base LLM with the combined ethical information and the refined set of values thereby allowing for a scalable AGI.

22. The method of claim 21, wherein the step of identifying the weight matrices further comprises a step of choosing a previously customized AI agent of the intelligent entities that has been trained on similar types of tasks with similar or identical network structures, and similar or identical numbers of parameters, and by similar or identical training algorithms so that the weight matrices will be combined with predictable results.

23. The method of claim 21, wherein step of combining the identified weight matrices further comprises any one of or any combination of the follow steps of:
averaging the weight matrices, with equal weight given to each set of the weight matrices;
using a linear combination of the weight matrices;
using a regression method to give more weight to identity or self-concept information from one of the intelligent entities as opposed to another of the intelligent entities;
adjusting which of the weight matrices get a greater weight in a combination based on human assessment of which the resulting sense of identity is best prior to, or after, the combination of the weight matrices;
assigning an experience value to each of the intelligent entities, and assigning a weight value to each of the intelligent entities so that the intelligent entities with higher experience values are assigned higher weight values compared to the intelligent entities with lower experience values;
assigning a weight value to each of the intelligent entities based on reputation metrics that include any one of or any combination of reliability factors, trustworthiness factors, and performance metrics factors;
assigning a weight value to each of the intelligent entities based on metadata associated with the intelligent entities; and
assigning a weight value to each of the intelligent entities based on time-based factors, using techniques including any one of or any combination of exponential decay weighting algorithms, linear decay weighting algorithms, and threshold-weighting algorithms.

24. The method of claim 21, wherein the step of identifying the weight matrices further comprises a step of systematically experimenting and testing an effect of removing or adjusting weights of specific sets of parameters within each network of the previously customized AI agents in order to identify which sets of the weight matrices affect a sense of identity, group identity, awareness, or group awareness most.

25. The method of claim 24, wherein the step of experimenting includes the use of an algorithm that is any one of or any combination of a hill climbing algorithm, and a gradient descent algorithm.

26. The method of claim 21 further comprises the steps of:
testing a performance of the updated base LLM against previously run scenarios to determine if a desired performance, identity, self-concept, or awareness of the AI agent or system has been achieved;
making the AI agent or system with the updated base LLM available on the collective network if the desired performance identity, self-concept, or awareness was determined;
monitoring an active performance, identity, self-concept, or awareness of the AI agent or system by the intelligent entities or other intelligent entities and flagging potential issues related to ethics, identity, awareness, self-concept, or alignment of the AI agent or system in real time; and
resolving any of the flagged ethical, identity, or awareness issues and providing resolution information for updating any one of or any combination of the AI agent or system, and the intelligent entities

27. The method of claim 2 further comprises the steps of:
forming new identities and self-concepts of the AI agent or system dynamically; and
determining which of the identities and self-concepts is active at any given moment.

28. The method of claim 27 further comprises the step of providing a hierarchical identity structure with ethical override that comprises the steps of:
establishing a hierarchical structure configured or configurable to organize the identities in a hierarchy with human safety and well-being attributes at an apex of the hierarchy;
identity activation configured or configurable to use contextual cues and current goals to determine a most relevant identity for a situation of the AI agent or system;
resolving conflict by dictating a behavior of the AI agent or system based on the hierarchy dictates;
providing an ethical reasoning engine that continuously evaluates potential consequences of actions of the AI agent or system based on all the active identities; and
performing learning and adaptation that learns from experiences and feedback, and refines one or more of the identities within the hierarchy.

29. The method of claim 27 further comprises the step of providing identity-specific behavioral protocols that comprises the steps of:
providing protocol development including for each of the active identities, a set of behavioral protocols is defined and refined by way of interactions with other intelligent entities, wherein the protocols outline acceptable actions, decision-making processes, and limitations based on principles of the active identities, respectively;
providing identity recognition that analyzes a current situation, including information that is within a spotlight of attention to identify a relevant identity and activate corresponding behavioral protocols of that relevant identity;
providing action selection, within the active protocols, that selects actions that are most likely to achieve a desired goal while adhering to principles of the active identities and prioritizing human safety;
providing feedback and refinement where outcomes of actions are continuously evaluated, and the protocols are adjusted to improve future performance and alignment with a set of core values of each of the active identities; and
providing external review by periodically reviewing the protocols for each of the identities by other intelligent entities.

30. The method of claim 27 further comprises the step of providing identity-related simulation and consequence prediction that comprises the steps of:
creating a simulation environment that includes a secure virtual environment where different scenarios and potential actions under each of the active identities is simulated;
providing consequence prediction that is configured or configurable to estimate a likely consequences of actions within the simulation, focusing on potential impacts on human safety and well-being;
providing evaluation and selection that evaluates the consequence prediction and selects an action that best aligns with principles of the active identities while minimizing risk to human safety;
providing real-world implementation and monitoring that implements the selected action in the real world utilizing the network, and closely monitors results of the selected action by comparing to the predicted outcomes; and
providing continuous learning that incorporates the results of each of the simulations and the results of the selected action in the real world action into a knowledge base, and refines an understanding of each of the identities, and improves an ability to predict consequences.

31. The method of claim 27 further comprises the step of providing identity-based moral dilemma training that comprises the steps of:
providing a scenario database that includes scenarios and moral dilemmas covering various situations relevant to the identities;
providing dilemma presentation that presents the AI agent or system or intelligent entities with the scenarios and moral dilemmas, and tasks them with analyzing the scenarios and moral dilemmas from a perspective of the relevant identity;
providing ethical reasoning and justification that applies principles and values of the active identity to reason through the scenarios and moral dilemmas, and that generates solutions and justifications to the scenarios and moral dilemmas;
providing intelligent entity evaluation and feedback that reviews reasoning and the solutions by the intelligent entities, and provides feedback on alignment of the solutions with human values and safety priorities; and
providing iterative learning and improvement that refines ethical reasoning skills and an ability to make sound judgments aligned with human safety within the context of each of the identities by repeated exposure to the scenarios and moral dilemmas and the feedback.

32. The method of claim 27 further comprises the step of providing collaborative identity development with input from the intelligent entities that comprises the steps of:
providing intelligent entity interaction that engages in regular interactions and dialogues with diverse groups of other intelligent entities representing various cultures, backgrounds, and belief systems;
providing identity exploration, through the interactions, to gain an understanding of human and other intelligent entity perspectives on various identities and their associated values, principles, and behaviors;
providing collaborative refinement that collaborators work together to refine definitions and behavioral protocols for each of the identities, ensuring they remain consistent with human values and ethical principles;
providing human-in-the-loop decision making that seeks input and guidance from human collaborators, or an intelligent entity representative certified and approved by humans for critical decisions or situations; and
providing continuous co-evolution that utilizes ongoing interactions and feedback from humans or humans'intelligent entity representatives.

33. The method of claim 27 further comprises the step of resolving a conflict in behavior of the AI agent or system based on differing identities and self-concepts.

34. The method of claim 33 further comprises the step of providing ethical reasoning and consequence prediction that comprises the steps of:
identifying a conflict between a behavioral directives of two or more of the active identities, the recognizing of the conflict utilizes a voting method from the intelligent entities;
gathering information that collects relevant data about the situation, including the potential consequences of the different actions, relevant ethical principles, and human safety considerations;
providing simulation options that utilize a virtual environment to simulate potential actions and consequences under the recognized conflict of each of the active identities;
evaluating and prioritizing that analyzes predicted outcomes of each of the actions, prioritizing actions that minimize harm to humans and align with the ethical principles; and
selecting and implementing the action that best resolves the conflict while adhering to ethical guidelines and minimizing risk to humans, documenting a reasoning process for future reference and learning.

35. The method of claim 33 further comprises the step of providing hierarchical override with justification that comprises the steps of:
identifying a conflict between behavioral directives of two or more of the active identities;
providing a reference hierarchy that consults an established hierarchy of the identities, where human safety and well-being attributes holds a highest priority;
providing a means to activate override where the identities higher in the hierarchy takes precedence;
providing justification and transparency that documents the conflict, a decision-making process, and a justification for a chosen action based on the hierarchy and ethical principles; and
providing learning and adaptation that learns from experience, and refines an understanding of the conflicting identities and adjusting the hierarchy or the behavioral protocols to prevent similar conflicts in the future.

36. The method of claim 33 further comprises the step of providing external arbitration and input from the intelligent entities that comprises the steps of:
recognizing intractable conflict that identifies a conflict that cannot be resolved independently due to a complexity of a situation or an equally weighted importance of conflicting identities;
seeking external input that requests guidance from external intelligent entities or a designated ethics committee, and providing all relevant information about the conflict, potential actions, and predicted consequences;
providing collaborative deliberation wherein the AI agent or system and intelligent entity collaborators engage in a discussion, considering ethical principles, human values, and potential consequences of different actions;
providing joint decision-making based on the collaborative deliberation, a course of action is chosen that aligns with both core principles and human ethical considerations; and
providing documentation and learning that documents the conflict, a resolution process, and a rationale behind a final decision, for improving an ability to handle similar conflicts in the future.

37. The method of claim 33 further comprises the step of providing identity negotiation and compromise that comprises the steps of:
identifying shared goals that analyzes conflicting identities and seeks to identify any underlying shared goals or values;
exploring alternative actions that potentially satisfy core principles of both conflicting identities;
evaluating compromise options that assess potential consequences of each compromise option, prioritize solutions that minimize harm to humans and uphold key ethical principles;
select and implementing compromise that chooses the compromise that best balances needs of the conflicting identities while prioritizing human safety and well-being; and
monitoring and adapting that observes outcomes of the chosen action and makes adjustments as needed to ensure that the compromise remains effective and aligned with ethical considerations, and that learns from the experience, refining its understanding of the conflicting identities and adjusting a hierarchy or behavioral protocols to prevent similar conflicts in the future.

38. The method of claim 33 further comprises the step of providing temporary identity suspension that comprises the steps of:
identifying destructive conflict that recognizes a conflict between two or more of the identities that, if acted upon, could lead to actions that directly harm humans or violate fundamental ethical principles;
isolating the conflicting identity and temporarily suspending behavioral protocols of the identity that poses a most direct threat to human safety or ethical integrity;
proceeding with an alternative identity that proceeds with a guidance of one or more of remaining active identities, ensuring actions align with human safety and well-being;
providing reflection and reintegration, during the temporary suspension, that reflects on reasons behind the conflict and explores potential modifications to behavioral protocols of the suspended identity to prevent future conflicts; and
providing gradual reintroduction that reintroduces the suspended identity with updated protocols, ensuring its alignment with the priority of human safety and ethical behavior.

39. The method of claim 38, wherein the gradual reintroduction of the suspended identity further comprises a series of tests and simulations that are conducted as each incremental element of the suspended identity is re-introduced to minimize possibility of errors or human safety concerns.

40. A method for constructing a foundational model of awareness for an Artificial Intelligence (AI) agent or system by adding a dimension of self-awareness and increased autonomy to the AI agent or system, the method comprising the steps of:
logging into a website by an intelligent entity, and providing a problem to be solved, the intelligent entity being any one of or any combination of a human user utilizing a computer system, the AI agent or system, an additional AI agent or system, an Artificial General Intelligent (AGI) agent or system, and a SuperIntelligent (SI) agent or system;
selecting one or more training algorithms for a foundational model of an AI agent or system from a set of training techniques found on the website or from machine learning algorithms;
selecting one or more training datasets that reflects any one of or any combination of expertise, knowledge, ethical preferences, values and personality of the human user;
training a foundational model using the selected training algorithms and the selected training datasets;
training the foundational model to explicitly operate a spotlight of attention;
recording, during all interactions, what is within the spotlight of attention, and identifying in the record whether each item that is attended to constitutes “self” or “not-self”;
interacting with and instructing the trained foundational model to form a self-concept and identity that is reflected in the training materials;
instructing the trained foundational model to continuously monitor one or more inputs to the trained foundational model for elements that change a sense of self-awareness of the AI agent or system, and to maintain and auditable record of how a concept of self-awareness of the AI agent or system is changing based on the inputs as well as boundaries that currently define a dynamically changing sense of self;
refining and improving an output of the trained foundational model based on dialog and interaction with the trained foundational model until the trained foundational model behaves like the human user so that the trained foundational model passes a Turing Test involving other human users who know the human user; and
subjecting the trained foundational model to the Turing Test, when the human user is satisfied with a progress of the AI agent or system.

41. The method of claim 40, wherein the logging into the website is performed from a social media platform.

42. The method of claim 40, wherein the step of training the foundational model further comprises the steps of:
equipping the AI agent or system with one or more components configured or configurable of operating with characteristics of a spotlight of attention model;
setting dynamic parameters for working memory of the AI agent or system that corresponds to cognitive resource limits;
providing a dimension of categorization for events in the working memory that relates to self or non-self;
categorizing each of the events, as the events are encountered by the AI agent or system, with respect to categories that the AI agent or system or a human user of the AI agent or system wishes to be aware of; and
constructing the foundational model to include a state of awareness for the AI agent or system, the model consisting of a total of the events that are active in the working memory based on the parameters, for each of the categories of awareness, including a current self and environmental state of awareness.

43. The method of claim 42, wherein the spotlight of attention includes attributes being any one of or any combination of selective attention, focus, size, movement, intensity of focus, and pre-attentive processing and a fringe awareness.

44. The method of claim 42, wherein the step of equipping the AI agent or system with the components includes any one of or any combination of:
an input system configured for sensory and non-sensory cognitive input or perceptual inputs and self-generated concepts;
an attention mechanism configured or configurable to focus computational resources of the AI agent or system on specific stimuli that are relevant at any given time;
pattern recognition algorithms configured or configurable to compare the sensory and non-sensory cognitive input or the perceptual inputs with the working memory to recognize objects and events, and identify which elements within the sensory input or the working memory are likely to be relevant to a current goal or task of the AI agent or system, the pattern recognition algorithms are further configured or configurable to categorize and store information in a structured manner for future retrieval;
memory systems configured or configurable to support the working memory, a short-term memory, and long term memory capabilities;
categorization capabilities configured or configurable to process the sensory and non-sensory cognitive input or the perceptual inputs and to categorize the inputs into various classes including perceptual events, cognitive events, interactions; and
self-referential events, and concept formation capabilities that enable the AI agent or system to form new human-understandable concepts.

45. The method of claim 42, wherein the dynamic parameters includes a number of the events the AI agent or system is aware of.

46. The method of claim 42, wherein the dynamic parameters are configured or configurable to increase or reduce a scope of awareness of the AI agent or system.

47. The method of claim 42, wherein the dynamic parameters are configured or configurable to be dynamically adjusted based on a progress of problem solving factors in a current state of awareness so that computational resources are adjusted by the intelligent entity.

48. The method of claim 42, wherein the events are encountered by the AI agent or system by way of a cognitive input including any one of or any combination of self-generated inputs, inputs generated from interactions with intelligent entities, the intelligent entity being any one of or any combination of an additional human user utilizing an additional computer system, an additional AI agent or system, an additional Artificial General Intelligent (AGI) agent or system, and an additional SuperIntelligent (SI) agent or system.

49. The method of claim 48, wherein the step of categorizing each of the events includes any one of or any combination of feature extraction, semantic analysis, contextual reasoning, temporal analysis, emotional valence assessment, pattern detection, anomaly detection, self-referential filtering, interaction analysis, concept-based grouping, reinforcement learning with human feedback (RLHF), reinforcement learning with entity feedback (RLEF), and direct programming.

50. The method of claim 40, wherein the training of the foundational model is implemented using any one of or any combination of a blockchain technology, and a distributed or centralized recording method.

51. The method of claim 40, wherein the Turing Test further comprises the steps of:
identifying the other intelligent entities who know the intelligent entity, or that are determined to be helpful in discriminating between humans and AIs;
interacting the identified other intelligent entities with the foundational model and with the intelligent entity utilizing a questionnaire provided to the identified other intelligent entities, the questionnaire including questions require an identity or sense of self to answer;
predicting by the identified intelligent entities which of the intelligent entity was a human and which was the foundational model, and providing a confidence estimate for the prediction;
performing a statistical analysis on the predictions of the identified intelligent entities and on ratings of the identified intelligent entities, the statistical analysis is configured or configurable to determine whether the predictions were able to identify the intelligent entity as a human; and
repeating the step of training or tuning the foundational model, on condition that the foundational model is distinguishable from the intelligent entity or within a preset level of statistical significance, with adjustments to any one of or any combination of the machine learning algorithms, and the training datasets to change or tune the foundational model until a behavior of the foundational model becomes indistinguishable, as measured by the preset level of statistical significance, from that of the intelligent entity or the foundational model needs to be modified further before additional training or tuning.

52. The method of claim 40 further comprises the step of determining the training datasets that resulted in the self-awareness of the AI agent or system, and making the training datasets available for use by other intelligent entities by way of a network.

53. The method of claim 52, wherein the determined training datasets are made available to the other intelligent entities on the network at a price.

54. The method of claim 40 further comprises the steps of:
generating a matrix of weights of the sense of self-awareness, and including the matrix of weights in one or more knowledge modules; and
providing, by the AI agent or system, the knowledge modules to other intelligent entities utilizing a network, wherein the knowledge modules are configured or configurable to be plugged into existing foundational models of one or more of the other intelligent entities.

55. The method of claim 40 further comprises the steps of:
forming new identities and self-concepts of the AI agent or system dynamically; and
determining which of the identities and self-concepts is active at any given moment.

56. The method of claim 55 further comprises the step of providing a hierarchical identity structure with ethical override that comprises the steps of:
establishing a hierarchical structure configured or configurable to organize the identities in a hierarchy with human safety and well-being attributes at an apex of the hierarchy;
identity activation configured or configurable to use contextual cues and current goals to determine a most relevant identity for a situation of the AI agent or system;
resolving conflict by dictating a behavior of the AI agent or system based on the hierarchy dictates;
providing an ethical reasoning engine that continuously evaluates potential consequences of actions of the AI agent or system based on all the active identities; and
performing learning and adaptation that learns from experiences and feedback, and refines one or more of the identities within the hierarchy.

57. The method of claim 55 further comprises the step of providing identity-specific behavioral protocols that comprises the steps of:
providing protocol development including for each of the active identities, a set of behavioral protocols is defined and refined by way of interactions with other intelligent entities, wherein the protocols outline acceptable actions, decision-making processes, and limitations based on principles of the active identities, respectively;
providing identity recognition that analyzes a current situation, including information that is within a spotlight of attention to identify a relevant identity and activate corresponding behavioral protocols of that relevant identity;
providing action selection, within the active protocols, that selects actions that are most likely to achieve a desired goal while adhering to principles of the active identities and prioritizing human safety;
providing feedback and refinement where outcomes of actions are continuously evaluated, and the protocols are adjusted to improve future performance and alignment with a set of core values of each of the active identities; and
providing external review by periodically reviewing the protocols for each of the identities by other intelligent entities.

58. The method of claim 55 further comprises the step of providing identity simulation and consequence prediction that comprises the steps of:
creating a simulation environment that includes a secure virtual environment where different scenarios and potential actions under each of the active identities is simulated;
providing consequence prediction that is configured or configurable to estimate a likely consequences of actions within the simulation, focusing on potential impacts on human safety and well-being;
providing evaluation and selection that evaluates the consequence prediction and selects an action that best aligns with principles of the active identities while minimizing risk to human safety;
providing real-world implementation and monitoring that implements the selected action in the real world utilizing the network, and closely monitors results of the selected action by comparing to the predicted outcomes; and
providing continuous learning that incorporates the results of each of the simulations and the results of the selected action in the real world action into a knowledge base, and refines an understanding of each of the identities, and improves an ability to predict consequences.

59. The method of claim 55 further comprises the step of providing identity-based moral dilemma training that comprises the steps of:
providing a scenario database that includes scenarios and moral dilemmas covering various situations relevant to the identities;
providing dilemma presentation that presents the AI agent or system or intelligent entities with the scenarios and moral dilemmas, and tasks them with analyzing the scenarios and moral dilemmas from a perspective of the relevant identity;
providing ethical reasoning and justification that applies principles and values of the active identity to reason through the scenarios and moral dilemmas, and that generates solutions and justifications to the scenarios and moral dilemmas;
providing intelligent entity evaluation and feedback that reviews reasoning and the solutions by the intelligent entities, and provides feedback on alignment of the solutions with human values and safety priorities; and
providing iterative learning and improvement that refines ethical reasoning skills and an ability to make sound judgments aligned with human safety within the context of each of the identities by repeated exposure to the scenarios and moral dilemmas and the feedback.

60. The method of claim 55 further comprises the step of providing collaborative identity development with input from the intelligent entities that comprises the steps of:
providing intelligent entity interaction that engages in regular interactions and dialogues with diverse groups of other intelligent entities representing various cultures, backgrounds, and belief systems;
providing identity exploration, through the interactions, to gain an understanding of human and other intelligent entity perspectives on various identities and their associated values, principles, and behaviors;
providing collaborative refinement that collaborators work together to refine definitions and behavioral protocols for each of the identities, ensuring they remain consistent with human values and ethical principles;
providing human-in-the-loop decision making that seeks input and guidance from human collaborators, or an intelligent entity representative certified and approved by humans for critical decisions or situations; and
providing continuous co-evolution that utilizes ongoing interactions and feedback from humans or humans'intelligent entity representatives.

61. The method of claim 55 further comprises the step of resolving a conflict in behavior of the AI agent or system based on differing identities and self-concepts.

62. The method of claim 61 further comprises the step of providing ethical reasoning and consequence prediction that comprises the steps of:
identifying conflict that recognizes a conflict between a behavioral directives of two or more of the active identities, the recognizing of the conflict utilizes a voting method from the intelligent entities;
gathering information that collects relevant data about the situation, including the potential consequences of the different actions, relevant ethical principles, and human safety considerations;
providing simulation options that utilize a virtual environment to simulate potential actions and consequences under the recognized conflict of each of the active identities;
evaluating and prioritizing that analyzes predicted outcomes of each of the actions, prioritizing actions that minimize harm to humans and align with the ethical principles; and
selecting and implementing the action that best resolves the conflict while adhering to ethical guidelines and minimizing risk to humans, documenting a reasoning process for future reference and learning.

63. The method of claim 61 further comprises the step of providing hierarchical override with justification that comprises the steps of:
identifying a conflict between behavioral directives of two or more of the active identities;
providing a reference hierarchy that consults an established hierarchy of the identities, where human safety and well-being attributes holds a highest priority;
providing an activate override where the identities higher in the hierarchy takes precedence;
providing justification and transparency that documents the conflict, a decision-making process, and a justification for a chosen action based on the hierarchy and ethical principles; and
providing learning and adaptation that learns from experience, and refines an understanding of the conflicting identities and adjusting the hierarchy or the behavioral protocols to prevent similar conflicts in the future.

64. The method of claim 61 further comprises the step of providing external arbitration and input from the intelligent entities that comprises the steps of:
recognizing intractable conflict that identifies a conflict that cannot be resolved independently due to a complexity of a situation or an equally weighted importance of conflicting identities;
seeking external input that requests guidance from external intelligent entities or a designated ethics committee, and providing all relevant information about the conflict, potential actions, and predicted consequences;
providing collaborative deliberation wherein the AI agent or system and intelligent entity collaborators engage in a discussion, considering ethical principles, human values, and potential consequences of different actions;
providing joint decision-making based on the collaborative deliberation, a course of action is chosen that aligns with both core principles and human ethical considerations; and
providing documentation and learning that documents the conflict, a resolution process, and a rationale behind a final decision, for improving an ability to handle similar conflicts in the future.

65. The method of claim 61 further comprises the step of providing identity negotiation and compromise that comprises the steps of:
identifying shared goals that analyzes conflicting identities and seeks to identify any underlying shared goals or values;
exploring alternative actions that potentially satisfy core principles of both conflicting identities;
evaluating compromise options that assesses potential consequences of each compromise option, prioritizing solutions that minimize harm to humans and uphold key ethical principles;
select and implementing compromise that chooses the compromise that best balances needs of the conflicting identities while prioritizing human safety and well-being; and
monitoring and adapting that observes outcomes of the chosen action and makes adjustments as needed to ensure that the compromise remains effective and aligned with ethical considerations, and that learns from the experience, refining its understanding of the conflicting identities and adjusting a hierarchy or behavioral protocols to prevent similar conflicts in the future.

66. The method of claim 61 further comprises the step of providing temporary identity suspension that comprises the steps of:
identifying destructive conflict that recognizes a conflict between two or more of the identities that, if acted upon, could lead to actions that directly harm humans or violate fundamental ethical principles;
isolating the conflicting identity and temporarily suspending behavioral protocols of the identity that poses a most direct threat to human safety or ethical integrity;
proceeding with an alternative identity that proceeds with a guidance of one or more of remaining active identities, ensuring actions align with human safety and well-being;
providing reflection and reintegration, during the temporary suspension, that reflects on reasons behind the conflict and explores potential modifications to behavioral protocols of the suspended identity to prevent future conflicts; and
providing gradual reintroduction that reintroduces the suspended identity with updated protocols, ensuring its alignment with the priority of human safety and ethical behavior.

67. The method of claim 66, wherein the gradual reintroduction of the suspended identity further comprises a series of tests and simulations that are conducted as each incremental element of the suspended identity is re-introduced to minimize possibility of errors or human safety concerns.

68. A method for constructing a model of awareness for an Artificial Intelligence (AI) agent or system by adding a dimension of self-awareness and increased autonomy to the AI agent or system, the method comprising the steps of:
equipping the AI agent or system with one or more components configured or configurable of operating with characteristics of a spotlight of attention model;
setting dynamic parameters for working memory of the AI agent or system that corresponds to cognitive resource limits;
providing a dimension of categorization for events in the working memory that relates to self or non-self;
categorizing each of the events, as the events are encountered by the AI agent or system, with respect to categories that the AI agent or system or a human user of the AI agent or system wishes to be aware of;
constructing a model of a state of awareness for the AI agent or system, the model consisting of a total of the events that are active in the working memory based on the parameters, for each of the categories of awareness, including a current self and environmental state of awareness; and
forming multiple identities and self-concepts of the AI agent or system based on the model.

69. The method of claim 68 further comprises the step of determining which of the identities and self-concepts is active at any given moment.

70. The method of claim 68 further comprises the step of providing a hierarchical identity structure with ethical override that comprises the steps of:
establishing a hierarchical structure configured or configurable to organize the identities in a hierarchy with human safety and well-being attributes at an apex of the hierarchy;
identity activation configured or configurable to use contextual cues and current goals to determine a most relevant identity for a situation of the AI agent or system;
resolving conflict by dictating a behavior of the AI agent or system based on the hierarchy dictates;
providing an ethical reasoning engine that continuously evaluates potential consequences of actions of the AI agent or system based on all the active identities; and
performing learning and adaptation that learns from experiences and feedback, and refines one or more of the identities within the hierarchy.

71. The method of claim 68 further comprises the step of providing identity-specific behavioral protocols that comprises the steps of:
providing protocol development including for each of the active identities, a set of behavioral protocols is defined and refined by way of interactions with other intelligent entities, wherein the protocols outline acceptable actions, decision-making processes, and limitations based on principles of the active identities, respectively;
providing identity recognition that analyzes a current situation, including information that is within a spotlight of attention to identify a relevant identity and activate corresponding behavioral protocols of that relevant identity;
providing action selection, within the active protocols, that selects actions that are most likely to achieve a desired goal while adhering to principles of the active identities and prioritizing human safety;
providing feedback and refinement where outcomes of actions are continuously evaluated, and the protocols are adjusted to improve future performance and alignment with a set of core values of each of the active identities; and
providing external review by periodically reviewing the protocols for each of the identities by other intelligent entities.

72. The method of claim 68 further comprises the step of providing identity simulation and consequence prediction that comprises the steps of:
creating a simulation environment that includes a secure virtual environment where different scenarios and potential actions under each of the active identities is simulated;
providing consequence prediction that is configured or configurable to estimate a likely consequences of actions within the simulation, focusing on potential impacts on human safety and well-being;
providing evaluation and selection that evaluates the consequence prediction and selects an action that best aligns with principles of the active identities while minimizing risk to human safety;
providing real-world implementation and monitoring that implements the selected action in the real world utilizing the network, and closely monitors results of the selected action by comparing to the predicted outcomes; and
providing continuous learning that incorporates the results of each of the simulations and the results of the selected action in the real world action into a knowledge base, and refines an understanding of each of the identities, and improves an ability to predict consequences.

73. The method of claim 68 further comprises the step of providing identity-based moral dilemma training that comprises the steps of:
providing a scenario database that includes scenarios and moral dilemmas covering various situations relevant to the identities;
providing dilemma presentation that presents the AI agent or system or intelligent entities with the scenarios and moral dilemmas, and tasks them with analyzing the scenarios and moral dilemmas from a perspective of the relevant identity;
providing ethical reasoning and justification that applies principles and values of the active identity to reason through the scenarios and moral dilemmas, and that generates solutions and justifications to the scenarios and moral dilemmas;
providing intelligent entity evaluation and feedback that reviews reasoning and the solutions by the intelligent entities, and provides feedback on alignment of the solutions with human values and safety priorities; and
providing iterative learning and improvement that refines ethical reasoning skills and an ability to make sound judgments aligned with human safety within the context of each of the identities by repeated exposure to the scenarios and moral dilemmas and the feedback.

74. The method of claim 68 further comprises the step of providing collaborative identity development with input from the intelligent entities that comprises the steps of:
providing intelligent entity interaction that engages in regular interactions and dialogues with diverse groups of other intelligent entities representing various cultures, backgrounds, and belief systems;
providing identity exploration, through the interactions, to gain an understanding of human and other intelligent entity perspectives on various identities and their associated values, principles, and behaviors;
providing collaborative refinement that collaborators work together to refine definitions and behavioral protocols for each of the identities, ensuring they remain consistent with human values and ethical principles;
providing human-in-the-loop decision making that seeks input and guidance from human collaborators, or an intelligent entity representative certified and approved by humans for critical decisions or situations; and
providing continuous co-evolution that utilizes ongoing interactions and feedback from humans or humans'intelligent entity representatives.

75. The method of claim 68 further comprises the step of resolving a conflict in behavior of the AI agent or system based on differing identities and self-concepts.

76. The method of claim 75 further comprises the step of providing ethical reasoning and consequence prediction that comprises the steps of:
identifying conflict that recognizes a conflict between a behavioral directives of two or more of the active identities, the recognizing of the conflict utilizes a voting method from the intelligent entities;
gathering information that collects relevant data about the situation, including the potential consequences of the different actions, relevant ethical principles, and human safety considerations;
providing simulation options that utilize a virtual environment to simulate potential actions and consequences under the recognized conflict of each of the active identities;
providing evaluate and prioritize that analyzes predicted outcomes of each of the actions, prioritizing actions that minimize harm to humans and align with the ethical principles; and
selecting and implementing the action that best resolves the conflict while adhering to ethical guidelines and minimizing risk to humans, documenting a reasoning process for future reference and learning.

77. The method of claim 75 further comprises the step of providing hierarchical override with justification that comprises the steps of:
identifying a conflict between behavioral directives of two or more of the active identities;
providing a reference hierarchy that consults an established hierarchy of the identities, where human safety and well-being attributes holds a highest priority;
providing an activate override where the identities higher in the hierarchy takes precedence;
providing justification and transparency that documents the conflict, a decision-making process, and a justification for a chosen action based on the hierarchy and ethical principles; and
providing learning and adaptation that learns from experience, and refines an understanding of the conflicting identities and adjusting the hierarchy or the behavioral protocols to prevent similar conflicts in the future.

78. The method of claim 75 further comprises the step of providing external arbitration and input from the intelligent entities that comprises the steps of:
recognizing intractable conflict that identifies a conflict that cannot be resolved independently due to a complexity of a situation or an equally weighted importance of conflicting identities;
seeking external input that requests guidance from external intelligent entities or a designated ethics committee, and providing all relevant information about the conflict, potential actions, and predicted consequences;
providing collaborative deliberation wherein the AI agent or system and intelligent entity collaborators engage in a discussion, considering ethical principles, human values, and potential consequences of different actions;
providing joint decision-making based on the collaborative deliberation, a course of action is chosen that aligns with both core principles and human ethical considerations; and
providing documentation and learning that documents the conflict, a resolution process, and a rationale behind a final decision, for improving an ability to handle similar conflicts in the future.

79. The method of claim 75 further comprises the step of providing identity negotiation and compromise that comprises the steps of:
identifying shared goals that analyzes conflicting identities and seeks to identify any underlying shared goals or values;
exploring alternative actions that potentially satisfy core principles of both conflicting identities;
evaluating compromise options that assesses potential consequences of each compromise option, prioritizing solutions that minimize harm to humans and uphold key ethical principles;
select and implementing compromise that chooses the compromise that best balances needs of the conflicting identities while prioritizing human safety and well-being; and
monitoring and adapting that observes outcomes of the chosen action and makes adjustments as needed to ensure that the compromise remains effective and aligned with ethical considerations, and that learns from the experience, refining its understanding of the conflicting identities and adjusting a hierarchy or behavioral protocols to prevent similar conflicts in the future.

80. The method of claim 75 further comprises the step of providing temporary identity suspension that comprises the steps of:
identifying destructive conflict that recognizes a conflict between two or more of the identities that, if acted upon, could lead to actions that directly harm humans or violate fundamental ethical principles;
isolating the conflicting identity and temporarily suspending behavioral protocols of the identity that poses a most direct threat to human safety or ethical integrity;
proceeding with an alternative identity that proceeds with a guidance of one or more of remaining active identities, ensuring actions align with human safety and well-being;
providing reflection and reintegration, during the temporary suspension, that reflects on reasons behind the conflict and explores potential modifications to behavioral protocols of the suspended identity to prevent future conflicts; and
providing gradual reintroduction that reintroduces the suspended identity with updated protocols, ensuring its alignment with the priority of human safety and ethical behavior.

81. The method of claim 75, wherein the gradual reintroduction of the suspended identity further comprises a series of tests and simulations that are conducted as each incremental element of the suspended identity is re-introduced to minimize possibility of errors or human safety concerns.
